(19) United States
(12) Patent Application Publication
(10) Pub. No.: US 2018/0357365 A1
(43) Pub. Date: Dec. 13, 2018

(54) PRODUCT AUTHENTICATION AND TRACKING

(71) Applicant: Phylagen, Inc., San Francisco, CA (US)

(72) Inventors: James F. Meadow, Oakland, CA (US); Jessica L. Green, Berkeley, CA (US); Adam Altrichter, Alameda, CA (US); Harrison F. Dillon, San Francisco, CA (US)

(21) Appl. No.: 15/765,485

(22) PCT Filed: Sep. 30, 2016
(86) PCT No.: PCT/US16/54881

§ 371 Date: Apr. 2, 2018

Related U.S. Application Data
(60) Provisional application No. 62/236,769, filed on Oct. 2, 2015.
(60) Provisional application No. 62/251,675, filed on Nov. 5, 2015.
(60) Provisional application No. 62/257,192, filed on Nov. 18, 2015.
(60) Provisional application No. 62/325,937, filed on Apr. 21, 2016.

(51) Int. Cl. G06F 19/22

(52) U.S. Cl. CPC G06F 19/22

(57) ABSTRACT

Methods for identifying the origin, source, transit, manufacturing or handling history of a person, item or material of interest by comparing microbiome profiles of the respective products. Methods for tracking objects and people.

### FIELD OF THE INVENTION

The present invention provides methods and materials for detecting the origin, source, and transit history of a product, i.e., where the product or its material components were sourced and/or manufactured and/or where such products or components were stored or shipped, as well as information about contact history, including who has handled them or was involved in the manufacturing process, by generating genetic profiles of the product and/or its components, which are used to determine origin, source, and/or transit history, often by comparison to reference genetic profiles. In one of many important embodiments, the present invention provides methods and materials for establishing genetic profiles for authentic products that can be compared to profiles of products with unknown provenance to determine the authenticity of the other products. In other important embodiments, the methods of the invention provide information about the origin of a product in commerce and the distribution network by which it arrived at its point of acquisition therefrom. The invention relates to the fields of biology, particularly microbiology and molecular biology, commodity exchange, commerce, and forensics.

### BACKGROUND OF THE INVENTION

Forensic scientists use a technique called “DNA fingerprinting” to identify individuals by characteristics of their DNA. A DNA profile is a small set of DNA variations that is very likely to be different in all unrelated individuals, thereby being as unique to individuals as are fingerprints. Although 99.9% of all human DNA sequences are the same in every person, enough of the DNA is different that it is possible to distinguish one individual from another. However, even DNA profiling is ineffective in distinguishing identical twins, or determining anything about what a person has been doing or where they have been.

Just like identical twins, counterfeit products are sometimes impossible to differentiate, even at the chemical or physical level. For example, knock-off or counterfeit pharmaceuticals are often chemically identical to the authentic product. Size, shape, dosage, color, smell, taste, and texture are all attributes that may be mimicked and incorporated into competing products without suitable means of detection. While this may pose a financial challenge to the owner of the authentic product, counterfeit products pose a greater threat to consumers who purchase the counterfeit products under the assumption of a known quality, safety, dosage, composition, allergen, etc.

Anti-counterfeit technologies have been developed in an effort to combat counterfeit products. These technologies include tamper-evident/tamper-resistant packaging, product authentication, holograms, track and trace systems, and RFID labeling. While these technologies are effective for some types of counterfeit products, counterfeiters are constantly developing creative workarounds to avoid detection. In addition, such technologies can only identify and trace products by being physically added to the product during the manufacturing process, which complicates the manufacturing process and adds expense.

Moreover, there remains a profound need for more efficient ways to get information about the origin and distribution networks of products in commerce. The global movement of products and the various and changing regulations regarding how product materials must be sourced, labor standards in the legal manufacture of products, and what products can be shipped or received from what countries, among a myriad of other related applications, create a compelling need for rapid and efficient methods to determine if a product is authentic or whether authentic or counterfeit products moved in a product distribution network of interest.

This present invention addresses and meets these needs and challenges.

### SUMMARY OF THE INVENTION

The present invention provides methods for determining information about the origin of a product, the conditions under which the product was manufactured, the places the product has been since manufacture, the items the product has come into contact with, the people involved in the manufacture and distribution of that product, and the environmental history of the product. The methods are readily automated with few physical steps required and the information that can be obtained using them has diverse applications. Generally in the methods of the invention, samples obtained from the product are processed to reveal information about the nucleic acid contained in them. The information derived about the origin, shipment, environmental history, and handling of the product is derived from this genetic information by processes that can be conducted serially and in parallel and in various combinations to reveal the information desired. In the most general of terms, the invention exploits the fact that selection of samples—in the sample from the product, its packaging, both—as well as the selection of references for use in the methods—can reveal information about the product and the distribution chain associated with the product, geographically or environmentally or via association with other products or human activity.

To assist the reader in comprehending the full scope of the invention, the discussion is generally organized to focus first on methods for identifying the nucleic acid sequences (e.g. metagenomic features and/or sets of microbial genes, strains, or taxa, as well as OTUs) optimally suited for the application of interest to the practitioner. Then, to introduce these applications, the discussion is focused on how the invention is useful in determining information about the origin of a product, particularly exemplified in the context of product authentication, which is determining if a product is genuine or counterfeit or otherwise properly labeled or mislabeled. With a basic understanding of this methodology, the reader is ready for the discussion of applications focused on determining information about the origin, transit history, and/or the environmental history for a product, starting first with how the packaging of a product can be sampled in accordance with the instant methods to determine information about the transit history, for example and without limitation, the route taken by the product and/or the environmental history of the product from point of manufacture to point of sale (or other acquisition for sampling, i.e., at port of entry or in goods seized by authorities due to suspected or proven illegal activities).

With these important tools understood, the reader is then positioned best to appreciate the power of the instant methodology to reveal information about product manufacture and distribution of any product in commerce by integration of the data obtained by analysis of the nucleic acid associated with the product with that associated with the packaging of the product.

In one readily grasped application, the methods of the invention enable one to answer the question of whether a product is genuine or counterfeit (or, more typically, more likely to be one than the other). Thus, in a first aspect, the present invention provides methods for product authentication. Depending on the product samples analyzed and the references employed to obtain the information desired for a determination of whether a product is or may be genuine or counterfeit, these methods are useful for obtaining information about the origin (where a product was made), source (from whom and/or where were the product or its components acquired), and transit history (where was the product shipped from, to and where was it stored, what it has come into contact with, who has handled it) of any material, but particularly articles of commerce and/or their components. The methods utilize a genetic profile, often a microbial genetic profile, sufficiently detailed to identify whether such product or component was made with or has come into contact with certain materials or at a certain location or shipped or stored at a certain location by comparison to known reference genetic profiles, often microbial genetic profiles.

More specifically, the present invention provides a method for identifying whether the origin, source, transit and/or environmental history of an item or material of interest is as expected, said method comprising generating a microbial profile of the item or material; generating a microbial profile of a similar item or material having a known origin, source, transit and/or environmental history; comparing the microbial profiles to determine if they are substantially similar or different; and concluding from the comparison that the item of interest has the expected origin, source, transit and/or environmental history only if the profiles generated are substantially similar.

In many applications, a reference database of microbial profiles and other product identifying nucleic acid information will be accessed, such that the step of “generating a microbial profile of a similar item or material having a known origin, source, transit and/or environmental history” will have been done prior to some or all of the other steps. The invention enables the creation of databases of microbial profiles and equivalent information (unique to the nucleic acids and thus microbes or other living, dormant or dead organisms associated with a product) that can be readily accessed via even wireless communications technology. A consumer or government inspector with suitable sampling equipment may practice the invention with a hand held and/or mobile device that can generate information about the product's origin and distribution chain in real time. Moreover, the reference signature (whether generated as part of the process or preexisting in the reference database) is not to be limited, since a reference may be from a “similar item or material” even if distinctly unrelated otherwise. The reference is always selected with regard to the question being answered. For example, if the question is whether a product was made in or shipped from China, the reference signature can be from dust samples from Chinese buildings completely unassociated with the actual facility in China in which the product was made or shipped (if it was).

In a first embodiment of this first aspect of the invention, the present invention provides methods and materials for detecting a counterfeit process or product through procuring and analyzing unique genetic profiles, and in some if not most instances, unique microbial profiles of a product. These unique profiles, which can be product profiles, test product profiles, or reference profiles, have features that differentiate them from other products, and so may be referred to as genetic signature of the product. In particular, the present invention provides methods and materials for establishing a microbial profile for an authentic product, which profile is subsequently compared to microbial profiles of products with unknown provenance to determine the authenticity of the other products or information about their place of origin and/or distribution network that placed them in commerce. More generally, the “authentic” product can be any item or material that will serve as a comparator or “reference” for another item or material. In accordance with the invention, a genetic, often a microbial (or microbiological), profile is established and a product profile (a “genetic signature”) is derived therefrom for use as a reference and then compared to one or more test materials or items of interest to answer a question about the origin, source, or transit profile of the test material or item.

Thus, in various embodiments, the invention may be practiced to demonstrate that products produced of the same materials, or by the same process, or by using the same materials and process but at a different location or environment (including, in some instances, a different location in time) by demonstrating they have different microbial profiles produced in accordance with the methods of the invention. Thus, the invention takes advantage of the microbiome, which is similar for products produced from the same materials, by the same process, and under the same conditions and environments at the same location when assessed using the methods of the present invention. The methods of the invention utilize microbial profiles uniquely suited to obtain the information about the product and/or its distribution chain. These profiles, called “product profiles”, are composed of features selected in accordance with the invention and so utilize most if not all of the most informative nucleic acid information (corresponding to the features) analyzed. Thus, even in those instances where a counterfeit product comprises identical materials, chemicals, and/or chemical and physical structures of an authentic product, the present invention can be used to generate distinguishable genetic and microbial profiles of the two products, the counterfeit and the real, because the counterfeit will differ from the genuine with respect to the microbiomes associated with its manufacture and/or distribution in commerce.

Thus, in one embodiment, a method is provided for generating a microbial profile of an authentic product, a product of a known source. The microbial profile is determined through a reproducible procedure involving the collection of one or more microbial samples from various predetermined surfaces (or spaces) of the product, such as by swabbing certain surfaces of a device or its components. In some instances, an internal surface (i.e. a surface that is inaccessible to a consumer) is sampled to generate the genetic (which may be a microbial) profile. The collected samples are analyzed to generate the profile, which in its broadest sense may be envisioned as a collection of DNA or RNA (nucleic acid) sequence information, which may be determined or inferred, e.g. via a hybridization pattern on a DNA or RNA chip, and any convenient information representation (typically computer generated and stored) can be selected for the particular application.

In the methods of the invention, the practitioner collects data in the form of nucleic acid sequence information from a sample, and such data might be and typically first is subjected to cleanup to ensure that irrelevant exposure to contaminating nucleic acids (from laboratory reagents during sample preparation, for example) does not skew results; then, the data is analysed, typically with computer assistance, to cluster related sequences into readily assessable and comparable representations of the data. After this clustering step is performed, and it may be repeated as many times as needed to get microbiome features (e.g. genes, strains, metagenomic features and/or operational taxonomic units (OTUs) of the desired specificity for a product, test, or reference profile of interest). Those features (e.g. OTUs) then serve as the product-specific genetic fingerprint or genetic signature of the product (the “product profile”), test product, or reference product or material of interest.

In one embodiment, a method is provided for determining the authenticity of a suspect product. This method includes a first step for procuring a genetic, or microbial profile of an authentic product, using methods of the invention to identify a subset of features to transform them into the “product profile” or “reference profile”, then procuring a genetic, which may be a microbial, profile of a suspect product (and clustering may be performed in the generation of that suspect product profile, a “test profile”), and then comparing the profiles of the two products, determining that the suspect product is not authentic if the profiles materially differ from one another.

Depending on the application, the practitioner can adjust the methodology to generate the desired amount of information with the minimal amount of sample manipulation and data analysis. For example, the microbial profile for an authentic product after applying the methods of the invention to generate the product profile of that authentic product (the “reference profile”) can contain at least 10 of the 20 most statistically characteristic authenticating OTUs or genetic sequences, and a product will be determined to be not authentic if it is missing at least 10 of those statistically characteristic authenticating OTUs. In another example, at least 5% of the total microbial DNA sequences in the microbial profile for an authentic product selected for use as the reference profile will be composed of any of the 20 most statistically characteristic authenticating OTUs. A suspect product will be deemed to be not authentic if the 20 authenticating OTUs make up less than 5% of the total microbial DNA sequences. In another example, these two tests can be combined so that at least 10 of the 20 authenticating OTUs must be present, and these must account for at least 5% of the suspect microbial fingerprint for the product to be determined to be authentic.

In one embodiment, a method of distinguishing a counterfeit from an authentic product is provided, wherein the method includes steps for 1) determining a genetic or microbial profile from an authentic product to then generate a reference profile; 2) determining a genetic or microbial profile from a corresponding product of unknown provenance; and 3) comparing the profile from the product of unknown provenance to the reference profile, wherein the profile of the product of unknown provenance is determined to be authentic if a minimum number of signature characteristics (“features”) match between its profile and the reference profile, and is determined to be counterfeit if a minimum number of such profile characteristics matches do not occur. In many instances, the profile characteristics will refer to one or more OTUs.

In one embodiment particularly useful in any industry in which goods or people with goods are moved, the invention provides a method of sorting an item of unknown provenance, such as boxes, envelopes, or luggage, wherein the method includes steps for 1) generating a genetic or microbial profile of an item; and 2) comparing the profile from the item to a reference profile or reference genetic signature of a product or material and generating a result of same or different; and 3) if the result is different, generating an order to remove or separate the item from its otherwise intended course. A “different” result can be generated when the test profile does not contain a minimum number of signature characteristics (e.g. OTUs) that match the reference signature (genetic or microbial profile of an authentic product or other item or material used as a reference). Thus, for purposes of such applications, “same” does not necessarily mean “identical”, but instead simply refers to the test profile containing a minimum number of signature characteristics that match the reference signature characteristics (genetic or microbial profile).

In one embodiment, a method for determining the origin of an item is provided, wherein the method includes steps for 1) determining a genetic or microbial profile from an item; and 2) comparing the profile of the item to a reference database of profiles of the same or a similar or different item from the same or different known locations or environments, wherein the item is determined to be from a location or environment if it contains a minimum number of profile characteristics that match a particular reference profile associated with that location or environment In this embodiment, the reference database of profiles can include data of any useful origin, including genetic or microbial profiles generated from other products, product components, raw materials, factories, humans of a certain demographic, environments (e.g. dust, soil, water, air), packaging, materials from designated locations or sources, and can include other information, e.g., OTU, metagenomic, and other nucleic acid sequence information or identifiers of any nature amenable to database storage and retrieval for comparison purposes.

In other aspects of the invention, the methods provided are used to provide information about a material or item to determine its suitability for use in one of any of a number of diverse applications, including, without limitation: whether a product should be sold, whether a product should be consumed or applied, whether a product may be stolen, whether a product may be counterfeit, whether a product may have been previously sold in another country, whether a product is refurbished, whether a product contains some components that are newly manufactured and some components that are refurbished and/or counterfeit, whether a product has been used, and the like. The applications are as diverse as the microbes in the environment (if microbial profiles only are employed) and the objects that human creativity can create. Moreover, the methods are amenable to integration with other information sources, from counterfeit seizure records of a brand owner to the use of non-microbial genetic profiles (if nucleic acid information of non-microbial origin is included in features such as genes and OTUs employed in methodology) and/or molecular profiles (non-genetic information about other molecules and macromolecules obtained from sampling included in analysis).

In other aspects of the invention, the genetic or microbial profile obtained for a counterfeit product, or component thereof, is used as a comparator to one or more suspect articles to determine if they are counterfeit or authentic. For example, and without limitation, the profile can be used at a port of entry to determine if products otherwise destined for importation should be held for law enforcement to investigate possible counterfeit origin. As another example, such profiles of counterfeit products can be used to determine the percentage of products in a given market geography or outlet type or in a particular supply chain that are of counterfeit origin, such information being useful for any of a diverse number of purposes, including, without limitation, calculation of damages in litigation.

In other embodiments a genetic, metagenomic or microbial profile of a counterfeit product is used to identify key components and locations of a counterfeit network. Profiles can be used to link goods to a specific counterfeiting factory by matching signatures of seized goods in distribution chain to goods or other markers such as dust at a suspect factory. In other embodiments, profiles of packaging are used to link packaging to a counterfeit distribution hub. For example, the number of factories supplying a counterfeit distribution hub can be identified by the number of unique profiles of counterfeit products identified in the distribution chain or at retail points of sale. The profiles can be used to identify the number of distribution hubs, for example and without limitation, by using the number of different signatures from a packaging layer that have identical product signatures as an indicator. Profiles can be used to identify different counterfeiting networks and their number, and to link one or more retail outlets to particular counterfeit supplier. For example, if counterfeit products are identified as entering the distribution chain at a particular distributor or to be present at only particular retail outlets or retail outlets in certain regions, the profiles may result in the identification of individuals or groups active in the counterfeiting activity or complicit with it.

Similarly, the profiles obtained in accordance with the invention can be used to determine the geographic or environmental origin of counterfeit goods, components thereof, or any other object such as personal effects, clothing, commodities, cash, weapons, etc., through “geolocation” (region, country, state/province, city) or “geoclassification” markers in the profiles, which could be, for example and without limitation, information regarding human or other DNA in a profile indicative of a particular area or environment. For example, human, plant (particularly pollen), or animal DNA can be used to identify a country of origin or transit of a counterfeit good. In brief, any nucleic acid in a profile that is geolocation or environment specific can be used to identify the origin and/or transit route of objects, materials and goods such as counterfeit goods. In this fashion, the methods of the invention can be used to determine geographic and environmental regions of distribution centers of objects, materials and goods such as counterfeit goods; to prove that suspect goods are counterfeit and, regardless, whether they were or were not made in a particular factory; to amass evidence that can be used to identify counterfeiters as well as the factories, geolocations and environments where their counterfeit goods are produced, the distribution networks along which they travel to reach the market, and the retail stores and markets where they appear, which in turn leads to their apprehension and cessation of their counterfeiting activities; as well as to prove the damages the authentic goods purveyors suffered from such counterfeiting activities.

More generally, then, the methods of the invention provide new tools for enhanced security, intelligence, and law enforcement in any number of useful ways. For example, the methods of the invention can be used to link objects, materials and contraband to a distribution network of any illegal commodity, drugs, weapons, currency, or other contraband, not just counterfeit goods. Genetic and microbial profiles associated with authentic and counterfeit products and their packaging as described herein can be used to identify tariff avoiders, as when a shipper misrepresents the country of origin of a shipping container to take illegal advantage of disparate tax rates based on country of origin. This illustrates the more general application of the methods of the invention to determine the location of origin of an object or goods, which has obvious advantages to law enforcement. Materials that can be profiled for such purposes include, without limitation, conflict minerals (such as the rare earth elements), products from embargoed countries, and products with undesirable sustainability profiles. Moreover, not just country of origin, but the “location history”—where an object has traveled since manufacture or isolation from nature—of an object can be deduced using the present methods.

In this fashion, the methods of the invention are useful not only in law enforcement but more generally in commerce for such dual purposes as ship and cargo tracking; supply chain source and quality tracking, i.e., to verify the supply chain, which might include, without limitation, identifying or verifying the source of raw materials; monitoring authorized supplier/subcontractor usage by outsourced manufacturers or distributors; verifying goods are made from components sourced from “conflict-free” or “slave-free” or “child labor free” supply chains; verifying that raw materials are coming from or not coming from a particular place; and verifying recycled components (by showing profiles do not match that of new products). For many industries, including without limitation, the food, cosmetics, and over-the-counter and prescription drug industries, the commercial and law enforcement uses of the methods of the invention will be similar in practice but different in application, in that the methods can be used to identify whether a biological drug product is a biosimilar, whether a pharmaceutical product is genuine or counterfeit, and if genuine, the country or region of origin, for purposes of stopping trafficking in grey goods in the pharmaceutical industry particularly but similar problems exist in other industries that are tractable in similar fashion with the present invention.

Given that one can view any counterfeit and real versions of the same or similar product as differing in some “quality”, those of skill in the art will appreciate, upon contemplation of this disclosure, that the present invention, most generally, offers methods and technology for assessing whether any two similar objects or materials are of the same quality, whether that be authentic versus counterfeit or any other distinguishing feature, aspect, or attribute that can be deduced or inferred from the nucleic acid that inevitably accompanies all objects in commerce and commercial use. For example, the methods of the invention can be used to determine the origin and relative quality of agricultural commodities such as corn, soybeans, wheat, and other products. These and other aspects and embodiments of the invention will be more fully apparent upon review and contemplation of the accompanying figures and their description and the detailed description of the invention below.

### BRIEF DESCRIPTION OF THE FIGURES

FIG. 1 is a schematic view of a visual microbial profile of a consumer product in accordance with a representative embodiment of the present invention.

FIG. 2 is a schematic view of a comparison of a visual microbial profile of an authentic consumer product and a visual microbial profile of a counterfeit consumer product in accordance with a representative embodiment of the present invention.

FIGS. 3A-3C are Venn diagrams representing similarities between microbiomes of authentic and counterfeit consumer products in accordance with representative embodiments of the present invention.

FIG. 4 shows a diagram for a software application of the present invention.

FIG. 5 shows graphical data in accordance with a representative embodiment of the present invention. This figure demonstrates that in some cases the majority of the microbial data associated with a product can be discarded, since in those cases the salient identifying data can be extracted from only 10% of the whole dataset. This allows for faster, lower-throughput sequencing methods to be utilized in the field. The figure depicts the stepwise rarefaction (random subsampling) from a complete dataset where each sample contains 1500 DNA sequences. The y-axis is a correlation value when comparing the pairwise similarity matrix from the complete dataset to the similarity matrix from the rarefied dataset. The correlation to with the complete dataset remains above 90% even after rarefying the dataset down to less than 10% of the original sequence depth.

FIGS. 6A and 6B show contamination in an example set of microbial profiles (each profile is a numbered “Group” along the y-axis) and the same 18 microbial profiles are shown in FIG. 6A and again in FIG. 6B. Each column is a single OTU, and the presence of a single thin vertical black line in a column in the matrix denotes the presence of a single OTU in a microbial profile. The absence of a thin vertical black line at any position in the matrix denotes that the particular OTU at that position was absent in the microbial profile. FIG. 6A shows all OTUs present for each of the groups prior to contamination detection. The last three microbial profiles in FIGS. 6A and 6B (Groups #16-18) were blank laboratory controls without DNA template added, and thus the presence of an OTU in each of these 3 samples reveals the presence of at least 1 contaminant DNA sequence. Note that the microbial profiles are arranged so that the total number of OTUs present is the highest for the top microbial profile (Group #1) and declines down the y-axis. FIG. 6B shows the same layout of microbial profiles and OTUs, but the OTUs that were not present in the blank laboratory control samples have been removed, leaving only the OTUs that did occur in the blank laboratory control samples. This illustrates that laboratory contamination might be present in any microbial profile in a given set of microbial profiles, and can have variable importance in the downstream analysis. For example, the microbial profile on the very top of each figure (Group #1) contains many OTUs that were not detected as contaminants, while Group #13 is primarily composed of contaminant OTUs. Those of skill in the art will appreciate, upon contemplation of this disclosure, that the removal of contaminant OTUs is a crucial step in some cases, including for the example microbial profiles shown in FIGS. 6A and 6B, while it may not be necessary to remove contamination from other microbial profiles if contamination is not present or present at a very low level.

FIG. 7(a) shows a hierarchical clustering dendrogram that clearly distinguishes among samples of the two cigarette brands (Marlboro® Red, Brand 2=American Spirit® Regular, p=0.0013, PERMONOVA on the pairwise Steinhaus similarity matrix). The x-axis (Microbiome Fingerprint Similarity) is a measure of the relatedness of each sample or group of samples. The more deeply diverged each sample is from another on the dendrogram, the greater the difference between their microbiome fingerprints. The heatmap on the right shows the presence/absence of 508 OTUs most indicative of either brand using bacterial 16S rRNA sequences. Each OTU is represented by a single thin vertical line. For example, an OTU that is present in a Marlboro sample is represented by a single thin gray vertical line, while an OTU that is absent in a Marlboro sample is represented by a single thin vertical white space. Note that approximately the leftmost ⅓ of the 508 OTUs are generally present in Marlboro samples but generally absent in American Spirit samples, while the rightmost ⅔ of the 508 OTUs are generally present in American Spirit samples, but generally absent in Marlboro samples. The total number of OTUs in the dataset (2352) was reduced to the most statistically indicative OTUs (508) using two predetermined cutoff thresholds: 1) OTUs in the reference profiles occurred in at least 2 of the 3 samples in one brand, while occurring in less than 2 of the 3 samples in the other brand; and 2) each OTU was represented by more than a single sequence in at least one of the product samples. The ability to distinguish between two goods of the same type, including counterfeit vs authentic and one brand vs a different brand is a representative embodiment of the present invention. FIG. 7(b) shows a hierarchical clustering dendrogram that clearly distinguishes among 12 packs of cigarettes purchased in different stores and manufactured in different factories on different dates (p=0.0013, PERMONOVA on the pairwise Steinhaus similarity matrix; see Example 4 for more details). The heatmap shows the presence/absence of 190 OTUs most indicative of each brand using bacterial 16S rRNA sequences. Manufacturing codes for the two brands are shown at the tips of the clustering dendrogram. The Marlboro manufacturing codes indicate that the first three purchased were manufactured in a first factory on the 78th day of 2015 (“R078 Y58B3”) and the second three purchased were manufactured in a second factory on the 244th day of 2015 (“V244 Y51B3”). Manufacturing codes on the American Spirits also indicated manufacturing in different lots (“229156 02:09” and “183156 00:54”). FIG. 7(c) shows a hierarchical clustering dendrogram that clearly distinguishes among samples of the two cigarette brands using fungal DNA signatures (p=0.001, PERMONOVA on the pairwise Steinhaus similarity matrix). The heatmap shows the presence/absence of 153 OTUs most indicative of each brand using fungal ITS sequences. The ability to distinguish between two goods of the same type, including counterfeit vs authentic and one brand vs a different brand is a representative embodiment of the present invention.

FIG. 8(a) shows a hierarchical clustering dendrogram that clearly distinguishes between ink from authentic and counterfeit Hewlett-Packard® printer cartridges (p=0.001, PERMONOVA on the pairwise Steinhaus similarity matrix). The heatmap shows the presence/absence of 54 OTUs most indicative of each group using bacterial 16S rRNA sequences. FIG. 8(b) shows a hierarchical clustering dendrogram that clearly distinguishes between revolving drums from authentic and counterfeit Hewlett-Packard® printer cartridges (samples of revolving drums) from both authentic and counterfeit printer cartridges (p=0.1, PERMONOVA on the pairwise Steinhaus similarity matrix). The heatmap shows the presence/absence of 43 OTUs most indicative of each group using bacterial 16S rRNA sequences. FIG. 8(c) shows a hierarchical clustering dendrogram that clearly distinguishes between interior packaging from authentic and counterfeit Hewlett-Packard® printer cartridges (samples of the consumer packaging from both authentic and counterfeit printer cartridges p=0.001, PERMONOVA on the pairwise Steinhaus similarity matrix). The heatmap shows the presence/absence of 118 OTUs most indicative of each group using bacterial 16S rRNA sequences. It is an object of the invention to provide methods of tracking and authentication methods that do not require changes to manufacturing processes, are applicable to all manufactured goods, and are extremely difficult or impossible for counterfeiters to copy.

FIG. 9(a) shows a hierarchical clustering dendrogram that clearly distinguishes between interior electronic components of authentic and counterfeit Apple® EarPods™ (p=0.1, PERMONOVA on the pairwise Steinhaus similarity matrix). The heatmap shows the presence/absence of 15 OTUs most indicative of each group using bacterial 16S rRNA sequences. FIG. 9(b) shows a hierarchical clustering dendrogram that clearly distinguishes between plastic packaging housing for authentic and counterfeit Apple® EarPods™ (p=0.001, PERMONOVA on the pairwise Steinhaus similarity matrix). The heatmap shows the presence/absence of 55 OTUs most indicative of each group using bacterial 16S rRNA sequences.

FIG. 10 shows a hierarchical clustering dendrogram that clearly distinguishes between circuit boards of authentic and counterfeit Sollatek® Voltshield™ surge protectors (p=0.001, PERMONOVA on the pairwise Steinhaus similarity matrix). The heatmap shows the presence/absence of 11 OTUs most indicative of each group using bacterial 16S rRNA sequences.

FIG. 11 shows a hierarchical cluster dendrogram that demonstrates authentication of Panadol® pills. All samples marked “A” were known to be authentic Panadol®, and all samples marked “B” were suspected to be counterfeit. The heatmap shows consistency in the presence/absence of the 35 most abundant OTUs across all samples and so demonstrates the test articles were genuine and not counterfeit.

FIG. 12 shows consistent signatures among replicates of authentic Claritin® and among replicates of packing cotton, and distinguishes between cotton and pills to demonstrate that we can distinguish between different parts of the same product.

FIG. 13 shows consistent signatures between replicates of authentic Toyota® gaskets. Each vertical bar chart shows the 10 most abundant bacterial OTU families found in each sample, and all 10 were consistently found in every replicate sample. Additionally, all of the top 16 most abundant bacterial families were found in all three replicates, and 29 out of the 30 most abundant bacterial families were found in at least ⅔ samples.

FIG. 14 shows shipping routes and results from Example 2. FIG. 14A shows the shipping routes used to send the 3 groups of 7 boxes through each carrier. FIG. 14B shows the 51 signature OTUs that were used to distinguish among shipping routes. The same 51 OTUs are shown for both origin and destination sample sets. Origin signatures were statistically indistinguishable prior to shipping (p=0.351), while destination signatures are statistically distinguishable by carrier (p=0.002). Ordination diagrams in FIG. 14C show that origin signatures were statistically indistinguishable prior to shipping, while samples were statistically clustered into three distinct groups, perfectly defined by carrier, after shipping. Each point in FIG. 14C is a single box's microbiome sample, and the distance between any two points represents the microbiome similarity between the two samples; similar samples are closer together, and dissimilar samples are farther apart.

FIG. 15 pictorially shows how a microbiome (more generally nucleic acid from the environment) gets associated with a product and its packaging. The “Production Fingerprint” entails microbes that adhere to products from the local geographic production environment, raw materials, chemicals used in production, local water supply, and employees. A given product leaves a production facility with the microbes from each of these sources, and continues to acquire microbes in transit and distribution. The “Distribution Fingerprint” entails microbes that adhere to the product packaging during transit, storage, and retail. Each of these component parts of the product microbiome can be used to follow items, both legal and illegal, through a manufacturing or supply chain. These clues can also be used to aggregate and organize networks when, for example, multiple unrelated counterfeit seizures reveal the same production or distribution fingerprints.

FIG. 16 pictorially shows a simplified counterfeiting network, in which samples from seizures (far right side) had a product genetic profile (circles) and distribution genetic profile (squares). As shown in the figure, with enough information and testing, multiple products can be aggregated to a single manufacturer (red circles and inferred red manufacturer), and multiple manufacturers can be aggregate into a single distribution network (gray boxes in the center) by combining the product genetic signature and the packaging genetic signature analyses and results as shown.

### DETAILED DESCRIPTION OF THE INVENTION

For the convenience of the reader, this detailed description of the invention is organized in sections as follows. 1. Definitions. 2. Generation of Molecular. Genetic, and Microbial Profiles. 3. Selection of Features for Product Profiles and Reference Profiles. 4. Data Analytics for Comparing Reference Profiles and Test Profiles. 5. Authentication. 6. Products in Distribution: the Analysis of Product Manufacturing and Distribution Networks. 7. Sampling Methods, Nucleic Acid Sequence Analysis, Generation of Profiles. These sections are followed by an Examples section illustrating various aspects and embodiments of the invention.

### Definitions

“Associated with” refers to a relationship between objects and/or information of the present invention if one can make a reasonable inference about either of the objects and/or information and reasonably conclude that both share or do not share a property of interest. A genetic signature obtained from a product or reference material or product may therefore be “associated with” a genetic signature obtained from another product or reference material.

“Authentic Product” is a product of known provenance, in most instances a product of a manufacturer that is sold under a brand name. More generally, an “authentic product” is any product, i.e., any item or material of which a product is composed, that can serve as a comparator or “reference” for another item or material of similar like in another product to determine if the two products share certain features of interest. Thus, a counterfeit product may be the “authentic product” in a test situation. For example, if the purpose of a test is to determine whether products taken from the chain of commerce are from the same counterfeit manufacturer, then a counterfeit product profile from a particular known counterfeit manufacturer may serve as the reference profile—in that test situation.

“Authentication” is a process in which some information about a product, such as its manufacturer or location of manufacture, or some aspect of the conditions of its manufacture, for example, and without limitation, is obtained or verified.

“Biomass Load” refers to the number or amount of microbes on or associated with a product. Total biomass load can be measured, for example, by measuring adenosine triphosphate (ATP) using kits standard in the art such as the Invitrogen® ATP Determination Kit (A22066). See Appl Environ Microbiol. 2008 August; 74(16): 5159-5167.

“Branded Product” refers to a genuine product labeled or marketed in a manner such that at least one authorized manufacturer, distributor, or retailer can be identified by its purchaser at the time of purchase.

“Confidence score” is a number that quantifies the likelihood that any two or more sets of observed data values were derived from the same representative population. A confidence score can be, but does not have to be, calculated from one or a combination of any number of matching criteria. In the current invention, as an example, a reference product profile might contain 10 statistically authenticating features. If all 10 statistically authenticating features are observed to occur in the microbial profile of a test sample, then the test sample would be determined to match the reference product profile with a high degree of confidence (i.e., a high confidence score). If only 5 out of the 10 statistically authenticating features are observed to occur in the microbial profile of the test sample, then the test sample might still be determined to match the reference product profile, but with a lower degree of confidence (i.e., a low, but sufficient confidence score).

“Consumer Packaging” refers to packaging intended to reach the consumer of the packaged product. Examples: blister packaging surrounding pharmaceutical unit dose forms (including prescription and over the counter (OTC) drugs and drugs for veterinary use); cigarette boxes; drink cans and bottles; and shoe boxes.

“Consumer Product” refers to any product in commerce. Non-limiting examples of consumer products include pharmaceutical products, electronic appliances, printer cartridges, electronic games, weapons, government issued currency, foodstuffs, clothing, transportation devices and spare parts, aircraft and aircraft parts, cigarettes, tobacco products, accessories, games or toys, toiletries/cosmetics, mobile phones and accessories, footwear, computers and accessories, shipping containers, raw materials packaged for shipment in commerce, perishable goods, textiles other than clothing, watches, herbicides, fertilizers, seeds, phonographic products, soft drinks, and alcoholic beverages, including but not limited to distilled spirits, wine, and beer.

“Correlation coefficient” is a number that quantifies the statistical relationships between two or more sets of observed data values. For example, if set A is comprised of 10 observed values (1, 2, 3, 4, 5, 6, 7, 8, 9, 10) and set B is comprised of the same matching 10 observed values (1, 2, 3, 4, 5, 6, 7, 8, 9, 10), then the correlation coefficient would be 100%, meaning that the two sets perfectly correlate and their statistical relationship is very strong. On the other hand, if set A was comprised of 10 random numbers (3, 10, 9, 8, 7, 1, 6, 4, 5, 2), and set B was comprised also of 10 random numbers (6, 2, 9, 10, 7, 3, 4, 1, 8, 5), the correlation coefficient would be much lower (31% in this example), meaning that the statistical relationship between sets A and B is poor. In the present invention, when two genetic profiles have a strong statistical relationship, the correlation coefficient between them is high; if the two genetic profiles have a poor statistical relationship, the correlation coefficient between them is low.

“Corresponding Product” is a product of similar or identical appearance to another, and is intended to be used or purchased for the same purpose. A corresponding product may be genuine or counterfeit; if counterfeit, then there generally is sufficient similarity between the “corresponding” genuine product to make a consumer more likely to purchase the counterfeit product in the mistaken belief that it is genuine or likely to cause others to believe it is genuine. For example, a corresponding product to an authentic 6 oz. (170 g) Colgate® whitening toothpaste tube is a 6 oz. (170 g) “Colgate®” whitening toothpaste tube of unknown provenance.

“Counterfeit Product” refers to a mislabeled product that misidentifies the manufacturer or seller of the product or is otherwise made using a manufacturer's or other seller's brand name to promote the sale of a product without the permission of the owner of the brand under which a corresponding product type is promoted. A “Suspect Counterfeit Product” may either be a counterfeit or genuine product, as the “suspect” distinction reflects its nature in that regard is reasonably questionable. Thus, a “Counterfeit Product” may be a product of known or unknown provenance that is labeled, marketed, or otherwise represented to be or to have some property that it is not or does not have. In a common example, a counterfeit product is labeled or sold with trademarks that are being used without the permission of the trademark owner. In another common example, the product is identified as having a property is does not have, i.e., originating from a particular country (or not), made in compliance with laws, and the like.

“Environment” means a place defined by its physical characteristics rather than by its geolocation. Examples of an “environment” can be a dusty warehouse, a manufacturing facility with a concentrated amount of human labor per square foot, a shipping container, or a high humidity below-ground gold mine, all of which have particular microbiomes.

“Facility” refers to any location from which a consumer product is manufactured, produced, derived, or distributed, and may include a warehouse, a manufacturing facility, a farm, a shipping facility, or a country.

“Facility Microbiome” refers to the type, composition, variation, location, and/or number of microbes and/or microbial genes present on one or more surface(s) of a location or facility from which a consumer product is derived.

“Factory” is a physical location, typically a building, where a manufactured product is made.

“Feature” is a component of a molecular or genetic profile that may be present or not in a reference or test profile that is associated with a molecule or nucleic acid sequence of known composition. An example of a feature of a genetic profile is an OTU, genome window etc. Features are typically computer code representations of nucleic acid sequences or aggregations of related sequences, but in some cases can sequence data itself. Features can also be used to create “Feature values”, which contain additional data besides the feature itself and can also be used to determine if two profiles are considered a match. For example, if a gene sequence appears 31 times as independent sequence reads from a sample, an abundance-related feature value would be 31. Another feature value could be that regardless of total abundance, the ratio of two features must be at least 3:1 between features A and B, and two samples match only if this feature value is met.

“Genetic Profile” means any characterization of nucleic acid in a sample, albeit typically the phrase is used to refer to nucleic acid that at least includes nucleic acid derived from a genome. For many purposes of this disclosure, genetic profile is functionally equivalent to microbial profile. In other instances the genetic profile includes nucleic acid sequences from non-microbial sources such as pollen, humans and livestock. Genetic profile is a generic term, encompassing metagenomic profile, microbial profiles, product profiles, test profiles, and reference profiles, each of which which can embody some selection or filtering of the nucleic acid in the profile of interest. Thus, a microbial profile selects for the microbial nucleic acid information in a sample, and a product or reference profile selects for those nucleic acid sequences, which may be generated and analyzed by PCR and amplicon sequencing or by metagenomic processing and analytical methods, that enable the practitioner to distinguish the product from other products of different origin or transit history (which can include reference to the distribution network). Pollen and nucleic acid sequence information from pollen can be included in genetic, molecular, product, reference, and test profiles of the invention.

“Genetic Signature” is a genetic profile of an object (which may be a product, product component, or raw material), environment, surface, person, or event that has one or more features (e.g. OTUs) that serve to identify such object (which may be a product, product component, or raw material), environment, surface, person, or event and distinguish it from other objects, environments, surfaces, persons, or events of interest to the practitioner. Genetic information can be obtained from dust, liquid media, air, soil, and other media found in the above locations.

“Genuine Product” refers to a product that is marketed with advertising and labeling that do not misidentify the manufacturer of the product or misuse any brand names associated with such advertising and labeling.

“Geoclassification” refers to the act of classifying or excluding a substance as being from a certain physical location (e.g. “the bananas are not from Honduras”, although this impliedly identifies a “geolocation” see below), as well as to the geographic characteristics assigned to an object (e.g. “the object was stored within 1 mile of an ocean” or “the object was stored at a location above 10,000 feet in elevation”). For example, geoclassification includes the ability to classify if a good originated near an ocean versus inland, independent of GPS location.

“Geographic location type” is a type of location determined through geoclassification.

“Geolocation” refers to the act of identifying a physical location, such as country, e.g., China or the United States. or a city, e.g. San Francisco or Shenzen. or a region, e.g., North America or Southeast Asia, and/or the identified location itself. In the context of the instant invention, geolocation typically refers to identifying where a product or product component or packaging or raw material contained in any of them originated, from the microbiome of the product, component, and/or packaging obtained in another geolocation.

“Illegal Product” refers to a product in a location where it is illegal to have or, if the product is being promoted for sale, sell such a product. Examples: grey market drugs and illegal drugs, including drugs seized in a police raid.

“Location” identifies where a physical object is, has been, or will be; a location may be physical, in that it indicates an object is or was or will be in a country, region, city, state, or other specific physical location, or it may be informational without providing a specific physical location, as in an environment (e.g. desert or rainforest), a criminal network, or a chain of commerce involving other products of similar time.

“Manufacturing History” refers to information concerning the origin of a product; information may be positive: the product was made at a particular location or factory; or negative: the product was not made at a particular location or factory.

“Manufactured Product” refers to a product made at a factory.

“Matching Signature Characteristics” refers to signature characteristics of a test and reference object sufficiently similar to be determined, for purposes and to the level of accuracy deemed beneficial, to be the same or of similar origin or transit history, depending on the application. These characteristics can be adjusted depending on the application. For example, characteristics for supply chain verification purposes can be different than characteristics required for the signatures to be introduced as legal evidence following an investigation.

“Metagenomics” is the study of metagenomes, which is all nucleic acid (typically DNA but can include DNA and RNA) material associated with an object, environment, person, or event, as typically assessed via sampling the object, environment, person, or event to obtain and sequence the nucleic acid material. The nucleic acid material is typically processed into a library suitable for high throughput sequencing but is not subjected to amplification that enriches specific markers from a genome such as a 16S marker. In accordance with the invention, metagenomic technology and analytical methods are applied to the analysis of samples of nucleic acid taken from the factory or environment from which a consumer product is derived as well as the product itself and optionally any packaging associated therewith, and which may or may not contain intact bacterial, viral, fungal, mammalian, and higher plant genomes. Metagenomic technology includes techniques for “Whole Genome Sequencing” (or “WGS”), which may be referred to as “Whole Metagenome Sequencing (or “WMS”); indeed, “metagenomics”, WGS, and WMS may be used interchangeably by those of skill in the art. “Metagenomic features” means the features in a product profile or other profile determined in part using metagenomics such as SNPs, CNV, protein families and genome windows. “Metagenomic profiles” means genetic profiles composed of metagenomic data (see Franzosa et al., Identifying personal microbiomes using metagenomic codes, Proceedings of the National Academy of Sciences, 112(22), E2930-E2938; see also Nayfach et al., An integrated metagenomics pipeline for strain profiling reveals novel patterns of transmission and global biogeography of bacteria, doi: http://dx.doi.org/10.1101/031757, each of which is incorporated herein by reference).

“Microbial Profile” is a subset of “Genetic Profile” but more specifically describes the profile of microbial features, which may correspond to one or more specifically enumerated microbes or microbial genes. Thus, a genetic profile is functionally equivalent to a microbial profile if only microbial nucleic acid is used to generate the genetic profile. A metagenomic profile can also be a microbial profile if only microbial nucleic acid is used to generate the metagenomic profile. The microbial profile may also be referred to as a “Microbiome Profile” or “Microbiome Fingerprint”, given that the microbiome of an object, a surface, or even a space can provide a molecular “fingerprint” or identifier that characterizes the specific object, surface, or space from which the microbiome is derived in sufficient detail to distinguish it, render it unique, from other objects (surfaces, spaces) of interest. Samples can be in the form of dust, liquid, air, grime, films, or any matter that is in or on an object or a space. However, unlike a real human fingerprint, or human DNA fingerprint, microbiome fingerprints or microbial profiles generated in accordance with the methods of this invention can also contain information about where an object came from, what raw materials were used to make it, what environmental conditions it has been subjected to, as well as other useful information. Thus, products produced of the same materials, by the same process, and under the same conditions, but at different locations can comprise microbiomes with different molecular fingerprints or profiles. Conversely, products produced of the same materials, by the same process, and under the same conditions at the same location can comprise microbiomes with the same or similar molecular fingerprints. Thus, even in instances where a counterfeit product comprises the identical materials, chemicals, and/or chemical or physical structure of the authentic product, the microbial profiles of the microbiomes of the two products are distinguishable. The “microbiome profile” or “microbial profile”, as used interchangeably herein, thus can refer to a set of data or a representation of a data set (often stored on a computer for computer-assisted manipulation and comparison) that characterizes the microbial composition of a microbiome for a material or item, such as a consumer product or component thereof. The microbial profile may, but does not have to, include information about all of the microbes and microbial genes present, their relative abundance, and their variation but in many instances will include only some subset of such information that sufficiently distinguishes the test object from other comparator objects that the practitioner desires to identify as different from the test object, if they are actually different. As noted, the microbiome/microbial profile is typically a set of nucleic acid sequences from chromosomal DNA isolated or amplified from microbial DNA in the samples, but can also include RNA sequences from microbes, or fragments of sequences or DNA or RNA microbial profile may contain all or only a portion of the information content of the microbiome of a product, depending on the application for which the profile was generated. One microbial profile (or genetic profile) is “different” from another when it does not contain a minimum number of signature characteristics (features, e.g. OTUs) that match the reference signature (the reference profile derived from a genetic profile or microbial profile, or other comparator information, i.e., as in a database).

“Microbiome” is a representation of the identity and relative abundance of microbes and microbial genes on an object or within a specific environment. A microbiome can be represented as a “microbial profile”. “Microbiome” refers to the microorganisms, microbial genes, or potential (to refer to the fact that the presence of the nucleic acid indicates an increased potential for the microbe or activity to be present, but does not actually demonstrate that the activity, such as that of an RNA or protein derived from the DNA, exists) biochemical activities (e.g. antibiotic resistance, metabolic pathway, and the like) present in or on the surface (including exterior and interior surfaces of any component) of a consumer product or a facility or environment (interior or exterior) from which the consumer product is derived or an environment through which a person, object or product has travelled. “Microbiome” refers to the collective set of microbes (including prokaryotic and eukaryotic microorganisms, and viruses), microbial genes, and/or biochemical activities present in these locations or on these surfaces (or, in the case of biomass like tobacco in cigarettes, in the product component of interest) or in those environments, in terms of both identity and relative abundance.

“Molecular Profile” of an object or environment includes not only genetic information, e.g., nucleic acid sequences (DNA and RNA and fragments thereof), but also other information, including but not limited to the identity, gross abundance and relative abundance of metabolites such as fatty acids, lipids, specific proteins, simple and complex carbohydrates, and many types of water soluble and water insoluble small molecules that may be in a sample. Pollen and materials may be included in an analysis (see, e.g., U.S. Pat. No. 8,852,892, incorporated herein by reference).

“Microorganisms” (also referred to herein as “microbes”) are microscopic living, dead and dormant organisms that may be single celled or multicellular. Microbes are very diverse and include all types and forms of bacteria, viruses, fungi, microalgae and cyanobacteria, and archaea, as well as most types of protozoa. Microbes are present in all environments on earth, including natural and human-made products and environments. The identity and relative abundance of microbes and microbial genes on an object or within a specific environment is known as a “microbiome” and any reliable and reproducible characterization of such a microbiome is termed a “microbial profile” of an item or material for purposes of the present invention. If nucleic acids are sequenced from a sample and methods are used to sequence all nucleic acids, such as metagenomics, other non-microbial sequence may be obtained, such as that from human cells that have shed from a person's body while in contact with the sample area, pollen grains, and other sources of non-microbial nucleic acids. Including non-microbial genetic sequence with microbial sequences creates a genetic profile, a subset of which is the microbial profile.

“Mislabeled Product” refers to a product labeled for use in commerce or promoted for sale under advertising or with labeling that misidentifies the product in some manner. Examples: counterfeit products; products sold under labeling that misidentifies the place of manufacture (i.e., to avoid tariffs or taxes, for example, or to conceal that the product was made in an embargoed country or location known for human rights abuses or environmental crimes).

“Operational Taxonomic Unit” (OTU) refers to a nucleic acid sequence that is targeted for identification in a sample, that represents a single unit of microbial diversity, but can contain an unlimited number of variants, identified from a sample, of a sequence that have a predetermined level of similarity between each other. It is a sequence or grouping of sequences of a nucleic acid that may be in a sample that will be used to infer information regarding, and so characterize, the microbiome (if a microbial profile is being generated or analyzed) of a consumer product, location, or other object, material or environment in accordance with the invention. An OTU can be derived from a single sequence read, or from an unlimited number of identical copies of a sequence read, or from an unlimited number of sequence reads that are all at least 97% (or some other percentage) identical to one another. Thus, those of skill in the art will recognize that OTU, as used herein, can be defined as in phylogeny, where an OTU is the operational definition in DNA sequence of a species or group of species (see “Defining Operational Taxonomic Units Using DNA Barcode Data”, Philos Trans R Soc Lond B Biol Sci 360 (1462): 1935-43 (October 2005)). An OTU can be a commonly used microbial diversity unit (see the article “Surprisingly Extensive Mixed Phylogenetic and Ecological Signals Among Bacterial Operational Taxonomic Units”, Nucleic Acids Research, March 2013, 1-14 doi:10.1093/nar/gkt241). An OTU suitable for use in the invention can also be a nucleic acid sequence that in essence defines the taxonomic level of sampling selected by the user, which, depending on application, may be an OTU that can uniquely identify individual types of microbes, or may alternatively be an OTU that identifies only collective populations, phylogenetic groups, genera, or species of microbes. An OTU may be a nucleic acid sequence used for species distinction in microbiology, where, typically using rRNA and a percent similarity threshold, scientists use OTUs for classifying microbes. In some embodiments, an OTU is a group of sequences identified from a sample that have at least 96%, at least 97%, or at least 98% nucleotide identity to each other. All organisms containing a sequence from the group are considered the same species for purposes of the analysis. In many embodiments, the genetic or microbial profile of a product, the “product-specific fingerprint” will be composed of one or more, and typically dozens to hundreds, of OTUs. An “OTU” is a nucleic acid sequence that represents a single unit of microbial diversity that is present in a given gene or genomic region (or other segment of nucleic acid derived from an organism of any type) or nucleic acid product derived therefrom (e.g., by PCR/amplicon sequencing or metagenomic sequencing) that shares a high degree of identity (e.g. 95% to identify a genus, 97% to identify a species, and 99% to identify a strain) in several (to many) organisms of interest. The sequence may be sufficient to identify a particular species of microbe or a genus of them, like “primate”, as but two non-limiting examples. OTUs are used and known in the art as a biological classification level, and are especially useful where the species concept is poorly defined or highly variable across multiple organisms. In many instances involving use of microbial nucleic acid, the OTU is a 16S rRNA gene sequence. Those of skill in the art will appreciate that all strains of a given microbial species could be >96.4% similar to a reference 16S rRNA gene sequence, while all strains of another species might be >99.1% similar to one another. In other words, each species is likely to have its own unique similarity cutoff, and the methods of the invention can accommodate such level of detail. In practice, however, there is typically not enough comprehensive background information for genetic similarity cutoffs unique to each bacterial (or other) species of interest, so the practitioner may, in accordance with the invention, apply a blanket, e.g. 97%, similarity cutoff to all bacteria in a dataset. This generalizes to the species level and allows efficient comparison. The OTU is therefore a tool used for classification of large numbers of organisms, typically microbes, and is not intended to enable conclusions that all organisms classified within the same OTU at a particular identity cutoff share particular biological functions. As an example, SEQ ID NOs: 1-4 are >97% identical, and therefore could be used to create a single OTU.

“Origin” refers to the location of a physical object when it is first identifiable as such. An origin is known when some information about the location is known. For example, the origin of a diamond (cut or uncut) may be known by determining the physical location from where it was mined or by determining it wasn't from a specific physical location (this diamond did not come from Africa, for example).

“Package” is the act of placing a product in packaging or the product of such action.

“Packaging” is any material placed in contact with a product and/or so as to encase a product in whole or in part for the purpose of facilitating its movement in commerce that is not necessary for consumer use or consumption of the product.

“Packaging Specific Genetic Signature” is a genetic signature intended to identify transit history or particular packaging or packaging type distinct from any product contained therein; operationally defined as a genetic signature generated from packaging.

“Place of Manufacture” is the location of the origin of a manufactured product. Such location may be a physical location, e.g. a factory in a specific city, state, country, or region, or an informational location, e.g. in the course of performance of criminal activities. A place of manufacture is known when the physical location of its manufacture is known or some information about the identity of its manufacturer or manufacturing is known. An example of positive information includes information such as “the product was manufactured in the United States”, and an example of negative information includes “the product was not manufactured in Mexico”.

“Point in a Transit History” refers to a physical location, environmental context or location, or temporal context in the actual path or intended path of transit of a product from its place of manufacture to a location in distribution up to an including a location of retail sale at which a product or its packaging remains long enough to collect nucleic acid sufficient for generating a genetic signature. A point in a transit history “of interest” means that an inquiry is being made as to whether a product shares at least one point of a transit history with another transit history. For example, if authorities seize counterfeit products at a warehouse in New York City and seizes counterfeit products of the same type in Salt Lake City in Utah, and the authorities want to know whether the products in Utah came through that warehouse, then New York City and that specific warehouse would be points in a transit history of interest.

“Product” refers to any physical object created by human intervention for use in commerce. Products include products, items and materials actually in commerce, i.e., consumer goods in distribution or at retail outlets, as well as products in use by consumers (for example, a “passport” doesn't cease to be a product simply because it has been issued to an individual). Materials such as raw wool prior to processing into fabric are products.

“Product Component” (or simply “Component”) is any part of a product that is used in its assembly or manufacture that is itself a product (as opposed to raw material).

“Product Microbiome” as used herein, refers to the type, composition, location and/or number of microbes or microbial genes present on one or more surfaces (or in one or more spaces) of a consumer product. Characterization of the type, composition and/or number (i.e., relative abundance) of microbes or microbial genes may be inferred from analysis of the nucleic acids present on the consumer product, as determined by taking samples of one or more surfaces of the product, to generate the microbial profile for a product. A microbiome can be characterized in accordance with the methods of the invention without any specific knowledge of the specific genera, species, and/or genes present in the facility or area in a facility to be assessed. For example, a microbiome can be characterized solely with reference to the type of genomic DNA or other nucleic acid sampled from the consumer product.

“Product Profile” is a set of information about a product. “Genetic Profiles” are product profiles consisting of information about the product obtained from nucleic acids associated with the product or its packaging. If a product profile includes features other than nucleic acid sequence information, it may be referred to as a “molecular profile”, e.g. a “product molecular profile” or a “reference molecular profile.” Typically, however, the profiles will be “genetic”, which as used herein simply indicates that nucleic acid sequence information is contained in the profile. When the genetic profile is focused exclusively or largely on the microbial nucleic acid associated with a product, it is termed a “microbial profile”. The present invention provides a variety of useful methods in connection with establishing microbial “product profiles” of authentic and counterfeit products. A “product profile” includes one or more “genetic signatures” generated as described herein. As illustrated in the Examples below, the methods of the invention allow one to generate and cluster operational taxonomic units (OTUs) in a manner that provides the genetic fingerprints also referred to as genetic signatures of the samples used to characterize a product. i.e., those OTUs form the genetic signatures that are the product profile of the product. The methods of the invention generally involve the generation and comparison of “product profiles” and “reference profiles”. Such profiles can be any set of characteristic molecular features, including but not limited to, genetic sequences, genes, species, OTUs, chemical signatures, cell counts, combinations or ratios of certain species or OTUs and biomass quantities. In many embodiments, the profiles will be genetic signatures composed of OTUs. In any embodiment, the profiles include one or more features that represent a molecular state of a particular object. A reference profile can result from characterization of a representative product or set of products, raw materials, manufacturing or distribution facilities, transit vehicles, transit locations, packaging materials, packaging facilities, surrounding environments, geographic locations, employees, and/or transit personnel. In the case of determining authentic vs. counterfeit products, a reference profile may be referred to as an authentic reference profile.

“Product Specific Genetic Signature” refers to a genetic signature intended to identify a particular product or product type; operationally defined as a genetic signature generated from a product.

“Product Testing” when used in reference to the invention generally refers to one or more of the authentication of an object, the determination of the provenance of an object's origin, or the determination of information about the transit history of an object.

“Profile Characteristic” is any feature of a molecular, genetic, or other profile that may be compared with another profile.

“Raw Material Product” refers to a product made from raw materials. The physical place of manufacturing of a raw material is the location where it is first packaged for movement in commerce. Examples: crops become raw material products when harvested and placed into packaging (containers) for movement from field to point of sale; coal becomes a product when loaded into a railroad car. Bulk cotton shipped to an apparel manufacturer is a raw material product.

“Raw Materials” refer to any product of nature that is not packaged for use in commerce. Examples: crops in a field; minerals in the ground; and trees in a forest.

“Reference Genetic Signature” refers to a genetic signature used as a reference.

“Signature Characteristic” refers to the features of a genetic signature, e.g. an OTU, kilobase window, protein family.

“Sequence Read” refers to the detection or identification of a sequence of nucleic acid by any means (although the phrase originated from the techniques used to identify the order of nucleotides in a polynucleotide) in a sample. The abundance of a particular type of nucleic acid in a sample can be inferred from the number of sequence reads characteristic of that nucleic acid in the sample.

“Statistically characteristic authenticating feature” means any feature within a genetic profile that consistently occurs in genetic profiles of representative samples from the same type of product, and thus can be included as a feature within a product profile used to authenticate or otherwise infer information about a test sample. For example, if 10 identical shoes were produced under the same conditions in the same facility, they would be expected to share a significant subset of their detected genetic features. Those features that are shared at a sufficiently consistent rate (for example, features that occur in at least 90% of the replicate samples) would be considered statistically characteristic authenticating features, since they would also be expected to occur at a similarly high rate (which might or might not be 90%) in test samples that originated from the same source. The present invention provides methods for setting predetermined cutoff criteria to determine whether an individual feature can be considered a statistically characteristic authenticating feature. A statistically characteristic authenticating feature can be any feature derived from a product profile, including, but not limited to, an OTU, a species, a gene, a metabolic function, or a segment of DNA. For example, an OTU that is identified as a statistically characteristic authenticating feature would be termed a statistically characteristic authenticating OTU, and would be one any number of types of statistically characteristic authenticating features.

“Test Profile” refers to a molecular profile of a test sample. In many instances, the test profile will be a genetic or microbial profile. i.e., some limited amount of nucleic acid sequence analysis will be performed on a test sample to generate the test profile (DNA sequencing, hybridization to a DNA chip or probe, and the like). In other instances, however, clustering or other processing of the nucleic acid sequence information obtained from the sample will be performed to generate the test profile. Thus, a test profile can be generated using the feature identification and selection methodology described herein for the generation of product and reference profiles. Those of skill will appreciate, however, that generation of the test profile may occur simultaneously with the comparing step in which the test profile is compared to a reference profile, i.e., if the reference profile is a set of OTUs and/or sequence read percentages/numbers, then the test sample can be directly analyzed by any of a variety of techniques and the information generated (the sequence read information) analyzed real time with reference profile information stored in a database and accessed and manipulated via computer programs designed for such purposes in accordance with the invention.

“Transit History” refers to information concerning movement of a product, material or person (e.g., from a product's place of manufacture to any other location prior to its sale or otherwise prior to arriving at its intended destination when manufactured).

“Transit Packaging” refers to packaging intended only for use in commerce that is either never seen by the consumer or otherwise intended to be removed prior to displaying the product contained therein for retail sale. Examples: box containers and the tapes and adhesives holding them together; plastic, paper, or cellophane or other shipping wrap (pallet wrapping); freight cars; shipping containers.

### Generation of Molecular, Genetic, and Microbial Profiles.

The molecular profile for a product can be generated using any information available about the chemicals and macromolecules associated with a product as an inherent result of its manufacture and/or distribution in commerce. One of the most important components of most molecular profiles is the component relating to the nucleic acid associated with the product. In fact, in most near term commercial embodiments of the invention, the product profiles and reference profiles employed will rely solely on nucleic acid information (and so are “genetic, metagenomic, or microbial profiles”) and in many instances will rely solely on the nucleic acid information derived from the microbial DNA and/or RNA associated with (or not, as the case may be) a particular product, product component, or raw material. The key information components in genetic profiles, metagenomic profiles and microbial profiles are genetic features.

One type of genetic feature used in some embodiments of the invention to generate genetic and microbial profiles is an operational taxonomic unit, or OTU. OTUs for use in the methods of the invention are obtained by grouping identical or sufficiently similar DNA sequences (e.g. any sequences that are at least 97% identical to one another, or to a known reference DNA sequence) into a cluster. This cluster that includes similar DNA sequences then represents one cohesive OTU. The abundance of the OTU is generally determined by the number of sequences that were clustered together to create the OTU. For example, if 100 sequences in a dataset were within a group that were all at least 97% identical to one another, then the resulting OTU has an abundance of 100. The abundance of an OTU can in some instances be transformed in a variety of ways to more accurately reflect the original biological abundance of the organism from which the DNA sequence was derived. For example, a log transformation of the abundance may yield a more appropriate comparison to other OTUs. In other cases, abundance information will be replaced with simple presence or absence status (occurrence) of an OTU. In other words, an OTU is present in a sample if at least one single DNA sequence from the OTU was detected in the sample.

Those of skill in the art will appreciate upon contemplation of this disclosure that, in accordance with the invention, nucleic acid sequence information is analyzed to generate and cluster operational taxonomic units (OTUs). While various methods can be used, the Open-reference OTU picking method in QIIME (see http://qiime.org/scripts/pick_open_reference_otus.html at filing date), using default parameters, is suitable for many applications. In one embodiment of the inventive technology, use of the GreenGenes 16S (or similar) database as a reference for sequences and taxonomy via the RDP taxonomy assignment classifier (Wang, Q, G. M. Garrity, J. M. Tiedje, and J. R. Cole. 2007. Naïve Bayesian Classifier for Rapid Assignment of rRNA Sequences into the New Bacterial Taxonomy. Appl Environ Microbiol. 73(16):5261-7. https://rdp.cme.msu.edu/) provides a convenient source of bacterial names for each sequence (nomenclature in certain figures herein are derived from this source). This process results in a dataset, which can be conveniently provided as an OTU table for analysis, in which each row is a sample or genetic profile (a dataset can include any number of samples, and, in some embodiments of commercial practice, running 100-200 or even thousands of samples will be routine), and each column is an OTU (1 k-100 k depending on product and size of dataset), with the cells reflecting the abundance of each OTU in each sample.

If assigning taxonomic information to the newly created OTU is desired, a single representative sequence from the cluster, which can be a consensus sequence representing all sequences in the cluster, is compared to a database of DNA sequences from known organisms with known taxonomic information. The OTU is then assigned taxonomic information relating to the most similar reference organism in the database, which might include all Linnaean taxonomic levels down to the species level (phylum, order, class, family, genus, species).

The OTU can be compared to other OTUs that were clustered from the same dataset, or to OTUs from a separate dataset or reference database. This OTU creation process is repeated until all DNA sequences in a dataset have been assigned to an OTU cluster. The resulting OTU dataset (or OTU table) is comprised of one or more samples (microbial profiles) that each has abundance or occurrence information for one or more OTUs. A typical microbial profile will have dozens to thousands of OTUs present, but in some cases might only have a single OTU dominating the entire sample, in which case the microbial profile will only have a single present OTU.

To prepare the dataset that becomes the genetic or microbial profiles, any variety of data preparation and curation can be done to improve efficiency, utility, and statistical resolution of the dataset. This can include removal of uninformative OTUs or OTUs that did not occur in the samples being tested (which reduces computation time), removal of apparent contaminant OTUs, transformation of abundance data (e.g. to logged abundances or occurrence data). These processes are exemplified in the examples below.

Also, one can equalize sampling effort, if necessary or helpful. Sequence datasets may not be evenly distributed. One profile might have 100,000 reads and another 10,000 reads. Accordingly, in accordance with some embodiments of the invention, an analysis is performed to determine if rarefaction (equalization) will influence results. If such an analysis is performed, then one can rarefy; otherwise, one can keep the whole dataset intact. Generally, to rarefy, one randomly resamples a subset of the DNA sequences present in a microbial profile to achieve equal sampling depth. For example, if the number of DNA sequences in all profiles being tested ranges from 10,000 to 100.000, then each microbial profile would be randomly subsampled down to 10,000 sequences per profile.

Given the possibility of inherent low DNA concentration in some consumer goods and environments such as on surfaces in or on buildings, in some applications laboratory contamination must be monitored and corrected during data processing and analysis. The present invention provides a variety of methods for dealing with this contamination. In one embodiment, this is achieved by comparison to laboratory ‘blank’ samples (used as contamination controls). Blank samples contain laboratory contaminants from reagents and test tubes, and this comparison can be used to 1) determine the extent of contamination in a given sample; 2) determine which contaminant OTUs or sequences are influential in results; and 3) remove confirmed contaminant OTUs or sequences from a microbiome sample prior to downstream analysis.

In accordance with the methods of the invention, the dataset can be “scrubbed” or “cleaned” to remove OTUs or other features likely present only due to exposure to microbes irrelevant to authentication or other purposes and as such can detract from the quality of a genetic or microbial profile. In many embodiments, this cleanup step will be performed to eliminate OTUs or other features specific to a laboratory or to humans performing the laboratory steps of the authentication process. In some embodiments, however, product-specific OTU or other feature removal (“cleanup”) is performed. Such cleanup steps can be conveniently performed in R (https://cran.r-project.org/ at date of filing; R Core Team, R: A Language and Environment for Statistical Computing. R Foundation for Statistical Computing).

In some applications, the reference profile will be carried out on multiple sets of reference samples simultaneously, including reference sets of the same product manufactured in different facilities, with different raw materials, or with different manufacturing methods. In these applications, the reference sets are assessed for variability across reference groups to better capture the reference genetic profile across these variable conditions. In these applications, the preparation of a reference genetic signature in accordance with the invention can be viewed as one component of an analysis. In many embodiments, this analysis is a 4-part process that can be applied as a reproducible routine—a method of the invention—that can be run on any group of samples from any product (used in its broadest sense and so inclusive of any reference material) of any source: prepare reference dataset; cluster samples using the entire dataset without feature selection, including a statistical test to determine whether emergent clusters are statistically distinct; identify most statistically powerful “product-specific” and “condition-specific” OTUs with a feature selection algorithm, including, optionally, one or more custom made algorithms (resulting in a reference genetic signature); and rerun the clustering algorithm using the product-specific reference genetic signature subset.

The first step in clustering and statistical testing is to generate similarity values for all pairwise combinations of samples, using any of a wide variety of standard ways to do this. Suitable ways include those that emphasize the most abundant species, and some that emphasize the rarest. Others focus on evolutionary relatedness among OTUs. In brief, the practitioner has a wide variety of choices at this step, based on the structure of the dataset and the application of interest.

One illustrative example of a function to do this in R is ‘vegdist’, see Jari Oksanen, F. Guillaume Blanchet, Michael Friendly, Roeland Kindt, Pierre Legendre, Dan McGlinn, Peter R. Minchin, R. B. O'Hara, Gavin L. Simpson, Peter Solymos, M. Henry H. Stevens, Eduard Szoecs and Helene Wagner (2016). vegan: Community Ecology Package. R package version 2.4-0 http://www.insider.org/packages/cran/vegan/docs/vegdist. If one focuses on the OTUs that occur in both groups, and not their abundance, one can use a Steinhaus (aka Jaccard) metric to count the OTUs that occurred in two samples. The result is a triangular matrix with all possible pairwise comparisons. Next, one performs the clustering step.

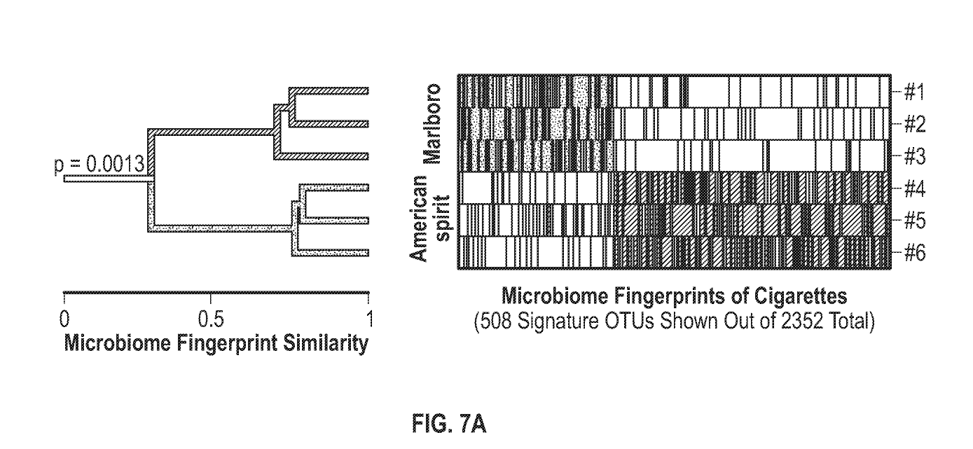

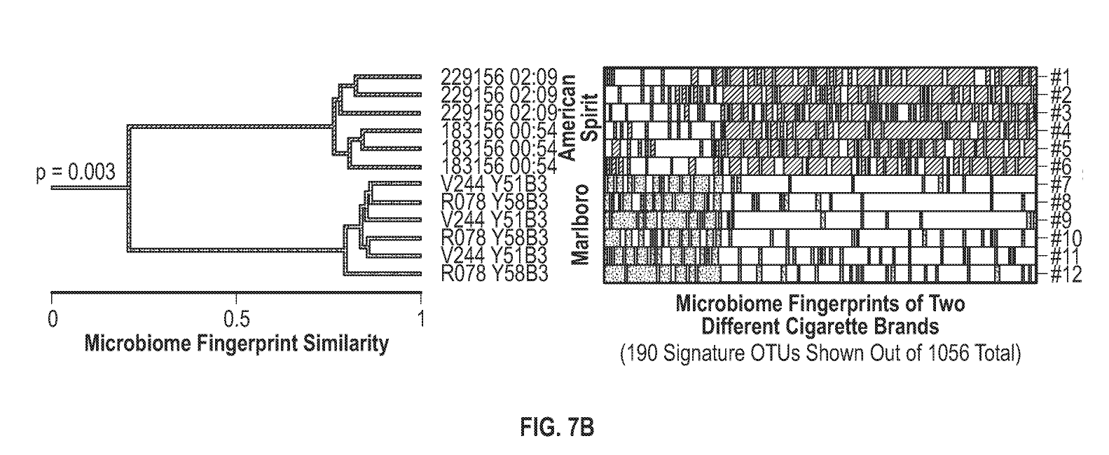

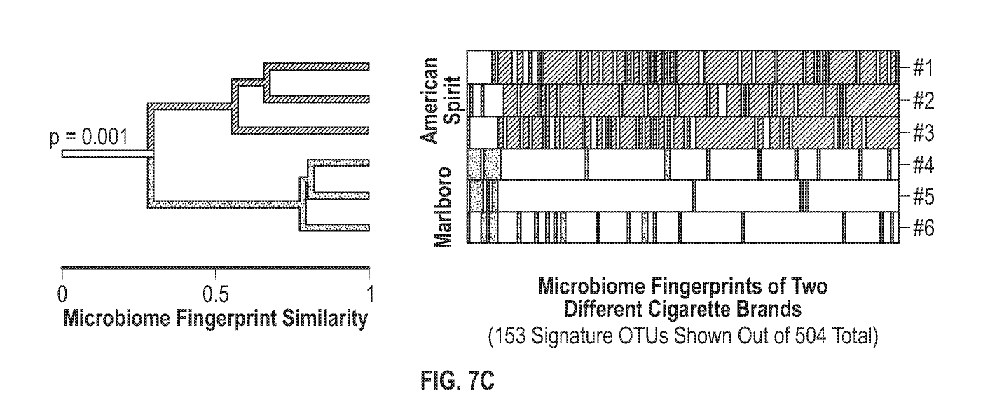

To cluster, one runs a hierarchical agglomerative clustering algorithm (e.g. with Ward's 1963 criteria, for example and without limitation) on the pairwise matrix. One illustrative example of the product of such efforts is exemplified herein (see Example 1 below) with a variety of products, including cigarettes. With reference to FIG. 7a, the dendrogram on the left side shows a significant result, e.g. all of the Marlboro profiles cluster together on one branch and all of the American Spirit profiles on another branch. The dendrogram can then be read like a family tree, or an evolutionary tree. In the figure, the closer together 2 profiles (tree tips) are to one another on the tree (tracing the shortest branching path from one tip to another), the more they have in common. The x-axis in the tree in FIG. 7a translates to the similarity measure used (as discussed above): this is an average similarity used to get all tips and branches to align on the right-hand side of the dendrogram.

Next, in the case of establishing reference profiles that can distinguish between two or more types of products, one tests for a significant difference between the two groups, using Permutational Multivariate Analysis of Variance (PERMANOVA) or other equivalent methodology. If the two groups are significantly different, one expects a p-value below about 0.01. For high-quality samples, like the tobacco from the cigarettes used in the examples below, the feature selection methodology detailed below provides the needed analysis the first time it is applied: there is no need for the additional fingerprinting steps of the methods of the invention. For other products, especially those with lower biomass or more complex provenance, multiple fingerprinting algorithm-based methods of the invention are required.

The preceding discussion of OTUs to generate genetic and microbial profiles is applicable in whole or in part to all aspects of this invention, the manifold applications of which are discussed in the following sections.

Shotgun metagenomics data can be used to identify several types of features used in some embodiments of the invention to generate genetic and in some cases microbial profiles. The “shotgun” approach refers to the capturing of all nucleic acid sequences in a sample, random shearing DNA, sequencing many short sequences, and not requiring a cloning step.

These feature types include, but are not limited to, organisms, genes, proteins, protein families, metabolic pathways, genome windows, and strain-level variants with single-nucleotide polymorphisms (SNP) and gene copy number variations (CNV). Subsequent paragraphs will illustrate examples of approaches to identify these feature types. Prior to feature identification, in some embodiments of the approach reads can be concatenated, trimmed, filtered, binned, or otherwise assembled to produce reads, contigs, or scaffolds of varying lengths to improve the overall accuracy of the feature identification and classification employed in the approach (see Qin, J., Li, R., Raes, J., Arumugam, M., Burgdorf, K. S., Manichanh, C., Wang, J. (2010). A human gut microbial gene catalogue established by metagenomic sequencing. Nature, 464(7285), 59-65. http://doi.org/10.1038/nature08821; Human, T., Project, M., Huttenhower, C., Gevers, D., Knight, R., Abubucker, S., White, O. (2012). Structure, function and diversity of the healthy human microbiome. Nature, 486(7402), 207-214. http://doi.org/10.1038/nature/1234; Minot, S., Bryson, A., Chehoud, C., Wu, G. D., Lewis, J. D., & Bushman, F. D. (2013). Rapid evolution of the human gut virome. Proceedings of the National Academy of Sciences. http://doi.org/10.1073/pnas.1300833110) for examples of these). Each of these feature types can be used individually or in combination in the subsequent feature selection and/or classification methodologies for product testing in some embodiments of the approach.

The identification of organisms in a shotgun metagenomics sample can be created by the use of marker gene analysis in one embodiment of the invention. While various methods can be used, marker gene analysis involves comparing metagenomic reads to a database of taxonomically informative genes (marker genes) and using sequence or phylogenetic similarity to taxonomically annotate each metagenomic read with a homolog in the marker gene database. The output from such a method for a given sample would include the presence and abundance of organisms identified to specific taxonomic groups, which might include all Linnaean taxonomic levels down to the strain level (phylum, order, class, family, genus, species, strain). Such an organism, is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

Test profiles are not typically generated by feature selection of their genetic profile prior to classification. Instead, in order to classify a test sample all the features in the genetic profile are mapped against the previously selected features in a reference profile. For example, if a shoe of unknown authenticity is sampled and a genetic profile obtained, that test profile that is mapped against a reference profile of authentic shoes to determine if the shoe is counterfeit. An exception to this is when a particular test profile is used to create a reference profile of the test sample. Then future test profiles can be mapped against this new reference profile to determine if they are from the same source. For example, a reference profile for counterfeit shoes from a particular source could be created through feature selection of test profiles of counterfeit shoes originating form that source. Future test samples could be mapped against this new counterfeit reference profile to determine if they are also from the same counterfeiter.

The identification of genes in a shotgun metagenomics sample can be created by the use of gene prediction approaches in one embodiment of the invention. Gene prediction identifies regions of metagenomic reads that contain partial or complete coding sequences. While various methods can be used, de novo gene prediction can be used to identify genes that are similar to known genes existing in databases, but also identify novel genes. Gene prediction models can be trained by evaluating various properties of genes (e.g., length, codon usage, GC bias) and used to assess whether a metagenomic read contains a gene. The output from such a method for a given sample includes the presence and abundance of genes identified, which can include annotation of the identified genes based on a reference database of known gene sequences. Such a gene, is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

The identification of proteins (via identification of open reading frames and sequence homology to known proteins) in a shotgun metagenomics sample can be created by the use of protein translation and mapping in one embodiment of the invention. While various methods can be used, metagenomic reads can be translated into all six possible protein coding frames and comparing each to a reference database of protein sequences by sequence alignment. The alignments can identify those metagenomic sequences that encode translated peptides that exhibit similarity to proteins in the reference database. The output from such a method for a given sample includes the presence and abundance of proteins identified, which can include annotation of the identified proteins based on a reference database of known protein sequences. Such a protein, is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

The identification of protein families (via identification of open reading frames and sequence homology to known proteins) in a shotgun metagenomics sample can be created by the use of protein classification methods in one embodiment of the invention. A protein family is a group of evolutionarily related protein sequences, or subsequences in the case of protein domain families. While various methods can be used, proteins identified from metagenomic reads can be used in the classification of a protein sequence into a protein family by comparing the metagenomic protein to either a database of protein sequences, each of which is assigned to a protein family, or use of a probabilistic model that describes the diversity and characteristics of proteins in a family. The output from such a method for a given sample includes the presence and abundance of protein families, which can include the annotation of identified protein families based on a reference database of known protein families. Such a protein family, is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

The identification of metabolic pathways or modules in a shotgun metagenomics sample can be created by mapping proteins or genes to a database of metabolic pathways or modules in one embodiment of the invention. The output from such a method for a given sample includes the presence and abundance of metabolic pathways or modules, which can include annotation of the identified metabolic pathways or modules based on a reference database of known pathways or modules. Such a metabolic pathway, is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

The identification of strain-level variants in a shotgun metagenomics sample can be created by the use of SNV detection and CNV in one embodiment of the invention. While various methods can be used, methods as described by Nayfach et al. (2016; http://dx.doi.org/10.1101/031757) provide an example for determining strain-level variation in a metagenomic dataset. In this procedure reads from a metagenomic sample can be aligned against a database of marker genes and assigned to species groups, as described above. CNV is determined by then generating a database of all the non-redundant genes contained in the sequenced genomes of an identified species. Metagenomic reads can be mapped to this non-redundant gene database, normalized by the coverage of single-copy genes present, and used to infer gene copy number and gene presence/absence. SNPs within the core genome of a species are determined by generating a database of representative genomes for each species identified. Representative genomes are selected in order to maximize sequence identity to all other genomes within the species. The core genome of each species can be identified in the representative genome where there is high metagenomic read coverage across multiple metagenomic samples. The abundance of SNPs can then be identified and enumerated along the core genome. The output of such a method for a given sample includes the presence and abundance of CNVs and SNPs, which can include annotation of the identified genes based on a reference database of known genes. Such a strain level variant is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

The identification of genome windows in a shotgun metagenomics sample can be created by the use of genome partitioning approaches in one embodiment of the approach. Metagenomic reads can be mapped to a database of reference genomes or marker genes to identify species present. The genomes of detected species can be divided into non-overlapping windows of length of, for example, 0.1, 0.25, 0.5, 0.75, 1, 2, 4, 5, or 10 kilobases, starting from the 5′ end of each scaffold within the genome. The abundance of gene windows can be determined by mapping metagenomic reads to the each of the gene window sequences. The output of such a method for a given sample includes the presence and abundance values for the gene windows. Such a genome window is a feature of a metagenomic profile, and in subsequent steps of the invention described in the following section, such features will be analyzed in combination with any other features used or identified in the metagenomic analysis, in order to select features or signatures that will form the key components of the reference or product profile for use in further analysis.

Methods of metagenomic feature selection are known in the art (see for example, Sharpton, T. J. (2014). An introduction to the analysis of shotgun metagenomic data, 5 (June), 1-14. http://doi.org/10.3389/fpls.2014.00209 (general methods of metagenomic analysis); Segata, N., Segata, N., Waldron, L., Ballarini, A., Narasimhan, V., Jousson, O., & Huttenhower, C. (2012). Metagenomic microbial community profiling using unique clade-specific marker genes Metagenomic microbial community profiling using unique clade-specific marker genes. Nature Methods, (June), 1-7. http://doi.org/10.1038/nmeth.2066 (Marker gene analysis); Franzosa, E. A., Huang, K., Meadow, J. F., Gevers, D., Lemon, K. P., Bohannan, B. J. M., & Huttenhower, C. (2015). Identifying personal microbiomes using metagenomic codes. Proceedings of the National Academy of Sciences, 112(22), E2930-E2938. http://doi.org/10.1073/pnas.1423854112 (Genome windows); Stephen Nayfach, Beltran Rodriguez-Mueller, Nandita Garud, Katherine S Pollard. An integrated metagenomics pipeline for strain profiling reveals novel patterns of transmission and global biogeography of bacteria. bioRxiv 031757; doi: http://dx.doi.org/10.1101/031757 (SNPs, CNVs); Zhao, Y., Tang, H., and Ye, Y. (2012). RAPSearch2: a fast and memory-efficient protein similarity search tool for next-generation sequencing data. Bioinformatics 28, 125-126. doi: 10.1093/bioinformatics/btr595 (Protein identification); Kanehisa, M., Goto, S., Sato, Y., Kawashima, M., Furumichi, M., and Tanabe, M. (2014). Data, information, knowledge and principle: back to metabolism in KEGG. Nucleic Acids Res. 42. D199-D205. doi: 10.1093/nar/gkt1076 (Metabolic pathway mapping); Kelley, D. R., Liu, B., Delcher, A. L., Pop, M., and Salzberg, S. L (2012). Gene prediction with glimmer for metagenomic sequences augmented by classification and clustering. Nucleic Acids Res. 40:e9. doi: 10.1093/nar/gkr1067 (Gene Prediction)).

### Selection of Features for Product Profiles and Reference Profiles

To perform feature selection, a process in which one is essentially trimming away uninformative or less informative features such as certain OTUs, protein families, and genome windows and focusing only on those with a statistical affinity for one group or another (or others), one can use any of a variety of means. From ecology, one can use methodologies that include, but are not limited to: indicator analysis, constrained ordination, random forest, and false-discovery rate analysis.

A feature selection described in the present invention uses a custom version of indicator analysis (Dufrene and Legendre, 1997), such that an authenticating OTU is ranked and selected based on these example criteria: occurs in at least a predetermined subset or fraction of profiles in a group (but the predetermined subset or fraction can be adjusted down or up depending on the dataset), occurs in less than another predetermined subset or fraction of profiles in the opposing group (as per previous parenthetical), and more than another predetermined subset or fraction (as per previous parenthetical) total relative abundance was in the target group of profiles. The method used by Dufrene and Legendre (1997) was designed and optimized for relatively small ecological datasets, and is especially useful for identifying biological entities that statistically correspond most strongly to a particular habitat or environment type. The present invention extends the existing method to efficiently apply to large nucleotide sequence feature datasets, and adds a testing component that cumulatively assesses the authenticity of an unknown profile by comparing to a set of authenticating features. While this description is simplified for purposes of illustration and rapid comprehension, the artisan of skill will, upon contemplation of this disclosure, understand these examples, and the data and results presented, and be able to adjust parameters as needed based on prior knowledge regarding sample types and the like. This process provides a smaller dataset of only high-affinity OTUs.

In the present invention, a reference genetic signature is created (see Equation 1, below) by analytically selecting the most statistically characteristic authenticating features, which can include OTUs, genes, protein families, presence and abundance of CNVs and SNPs, functions, or any other information derived from a nucleotide sequence, from a set (e.g. 10 replicate known authentic products is a reasonably sized set in many instances of consumer products) using a predetermined set of cutoff thresholds to generate a reference genetic signature (e.g. an authentic product reference genetic signature that can be compared with product profiles of products of unknown provenance to identify counterfeit products). As a non-limiting example, the statistically characteristic authenticating OTUs might meet two predetermined cutoff thresholds: 1) the OTU occurs in at least 50% out of the authentic products (or other reference material); and 2) the OTU is represented by at least 5 DNA sequences isolated from each of the authentic products (samples of other reference material) in which it occurs. For example, all OTUs meeting these predetermined cutoff thresholds can make up the authentic reference genetic signature for an authentic product. More generally, however, whatever the reference material and whatever the application, the selection of features for use as a reference genetic signature (or as information stored in a database, e.g. as sequence identification information associated with a feature) is an important aspect of the invention. Although the non-limiting example of feature selection above is described for selecting OTUs as features, the feature selection process can be applied to any type of feature derived from nucleotide sequence data. The following equation (Equation 1) exemplifies the feature selection process that can be applied to any type of feature derived from nucleic sequence data.

EQUATION 1

∀SPᵢₖ:(Nᵢⱼₖ≥ThNᵢⱼₖ)&

(N̅iₖ≥ThN̅ᵢₖ)&

(Pᵢₖ≥ThPᵢₖ)→

(SPᵢₖ∈Au) (1)

where
SPᵢₖ=feature i present within group k
Nᵢⱼₖ=abundance of feature i in sample j within group k

$$\begin{matrix}{\overline{N}}_{ik} = mean abundance of feature i across \\ j samples within group k \\ = \frac{{\sum }_{j} {N}_{ijk}}{j}\end{matrix}$$

$$\begin{matrix}{l}_{ijk} = occurence of feature i in sample j within group k \\ = \{ \begin{matrix}1 & if {N}_{ijk} \geq 1 \\ 0 & if {N}_{ijk} = 0\end{matrix}\end{matrix}$$

$$\begin{matrix}{P}_{ik} = sum of occurences of feature i within group k \\ = {\sum }_{j} {I}_{ijk}\end{matrix}$$

ThNᵢⱼₖ=predefined threshold for Nᵢⱼₖ
ThN̅ᵢₖ=predefined threshold for N̅ᵢₖ
ThPᵢₖ=predefined threshold Pᵢₖ
Au=authenticating set of features

With reference to equation 1, each feature (Spᵢₖ) in each sample within the reference sample set (a group of known reference products, k) is passed through three predetermined criteria (ThNᵢⱼₖ, ThN̅ᵢₖ, ThPᵢₖ) to determine whether k is sufficiently representative to be included in the final authenticating set of features (Au), which is used to test suspect products.

An authentic product or other reference profile might for example include between 10 and 1000 OTUs. The number will vary among products (including other reference materials associated with a product) according to factors such as how much microbial biomass is on the product being tested, the microbial load of raw materials used in the process of manufacturing the products, the level of human contact with products during the manufacturing or packaging or distribution process, the built environment microbiome of the manufacturing facility or facility surroundings, and the amount of exposure the product has to microbiomes during transit from a manufacturing facility to the point at which the product is tested.

In other embodiments, the predetermined cutoff thresholds can be 1) the OTU occurs in at least 30%, 40%, 60%, 70%, 80% or 90% of authentic products; and 2) the OTU is represented by at least 10, 20, 50, 100, 500, or 5000 DNA sequences isolated from each of the authentic products in which it occurs. In some embodiments, the predetermined cutoff threshold will be the presence of a single diagnostic OTU. In some embodiments, the predetermined cutoff threshold will be based on a metric that encompasses the cumulative genetic profile of a sample, such as the total number of OTUs occurring in a sample, or the diversity of OTUs occurring in a sample, or the relative abundance of a particular diagnostic OTU compared to all other OTUs in a sample. In some embodiments, the predetermined cutoff threshold will be based on the total amount of DNA or DNA sequences in the profile of a sample.

Those of skill in the art must contemplate this disclosure not only with respect to how to generate a reference genetic signature suitable for use in various applications of this inventive technology but also in how one compares the OTUs of a reference profile (and/or other information, e.g., as may be contained in a database) with those of a test sample to determine the information of interest. Moreover, given the incredibly diverse applications to which this technology may be applied, the artisan of skill will appreciate upon reflection how these inventive methods make selection of the optimal features for a given application efficient.

Interestingly, for other products, the same pattern applies, but for products susceptible for reuse and/or rebranding, one can optionally screen for human-specific OTUs that may only be present in a manufactured product, like a printer cartridge, for example and without limitation, if it had been repackaged, refurbished or refitted for reuse. In those instances, one would select OTUs commonly associated with humans to identify the counterfeit or recycled product and distinguish from the real or new product. Such OTUs include those that identify skin-associated bacteria like Staphylococcus, Corynebacterium, Propionibacterium, and Streptococcus and certain species thereof.

In similar theme, for products like cigarettes or other biomass based products, as the original plant matter will often have been grown in different regions and/or under different conditions, the present invention provides methods whereby any two or more different brands (including authentic and counterfeit versions of a product) are distinguished based on OTUs identifying the different phyllosphere bacteria (bacteria living on the leaf surface), including, for example and without limitation, Acinetobacter, Methylobacterium, Bacillus, and Pseudomonas and species thereof.

In other embodiments, the reference signature might be generated through a step-wise search for feature sets that identifies a signature to be used in product testing. For example, Franzosa et al. (2015) uses a greedy algorithm for determining minimal hitting sets that can be adapted to generate a unique signature for a product among a group of products. This method proceeds by 1) creating a list of confidently detected features, F, for the specified product, i. Rank each feature in descending order by the difference between each feature's abundance in product i and its next highest abundance in the group. Create an empty code set, S, and a set containing all other products in the group, J. 2) Remove the highest ranked feature (f) from F. Remove products from J for whom f was not confidently detected. If at least one product was removed from J, add f to S. 3) Repeat the previous step, stopping when either F becomes empty (no features remain) or J becomes empty. If J is empty, then S is a unique code for product i; else, product i has no unique code. 4) Optionally, after J is empty but before F is empty, continue adding features to S, stopping when S reaches a desired minimum size, d, or when F is empty. This procedure adds robustness to noise and, effectively, error correction to avoid false positives. 5) Optionally, after adding f to S, delete remaining features in F with similar presence/absence profiles to f. When using the d option above, this also helps to diversify the features added to an already unique code.

As described above, feature selection can, in some cases, be considered a separate step in the analytical process. In other cases, feature selection may be inherently built into an iterative machine learning tool. Therefore in some embodiments, the reference signature might be generated through the use of iterative machine learning methods. While various methods can be used, a procedure where features are scored based on their utility in product testing after iteratively training and testing a model on a subset of the data to find the optimal set and weighting of features. As a nonexclusive example, using the variable importance measure from Random Forests (Breiman 2001) provides a means for scoring and selecting features to be used in product testing.

### Data Analytics for Comparing Reference Profiles and Test Profiles

Once a reference genetic signature for a given product is established, then that profile can be used to evaluate the source, transit history, production methodology, or authenticity of a given suspect product. For example, the reference genetic signature can be used to establish information about a given product, including but not limited to, whether a suspect product is counterfeit, whether a product was produced in an unauthorized facility, whether the product traveled through an unauthorized supply chain route, or whether a product was produced using unauthorized methodology. All of these cases involve comparing reference signatures to the profiles derived from suspect products. In these or any other application, the practitioner uses a set of predetermined cutoff criteria to determine whether the suspect product matches the reference genetic signature sufficiently to be considered authentic. The predetermined cutoff criteria result from the feature selection process, and may include, but are not limited to the following: the presence of a critical number of authenticating features in the test sample; a minimum abundance for each individual feature in the test sample; and a minimum cumulative abundance of all authenticating features present in the test sample.

Test profiles for use in the invention can be generated in a variety of ways, including methods described above, that enable the comparison of the test profile to the reference profile. While genetic profiles from reference product samples will often undergo feature selection to derive reference profiles, genetic profiles from test samples will rarely require feature selection, but will rather be compared to reference profiles without feature selection. However, in cases where known counterfeit products are to be used as a reference to identify suspected counterfeit products from the same source, these samples will undergo feature selection to derive their reference profiles.

Equations 2 and 3 below provide an illustrative framework for comparing a reference genetic signature to a test profile to determine unknown information, including, but not limited to, its authenticity, provenance, and manufacturing methodology. Although the matching process described in equations 2-4 are exemplified using OTUs, the same process described here can be applied to any type of feature derived from nucleotide sequence data.

EQUATIONS 2 and 3

∀Spᵢₓ:(Nᵢₓ≥ThNᵢₓ)→Spᵢₓ∈xtrim (2)

(p≥Thp)&

(q≥Thq)→

(X=authentic) (3)

where
x=unknown sample
Spᵢₓ=feature i present within unknown sample x
Nᵢₓ=abundance of feature i in unknown sample x
ThNᵢₓ=predetermined threshold for Nᵢₓ
xtrim=subset of x that contains set of features with abundances above ThNᵢₓ
Au=final authenticating set of features resulting from Eq. 1
AuTrim=features present in xtrim and Au
p=proportion of features in Au that are present in AuTrim
Thp=predetermined threshold for p
Nᵢₓₜᵣᵢₘ=abundance of feature i in xtrim

$$\begin{matrix}q = fraction of cumulative abundance \\ of all features present in x that are authenticating \\ = \frac{{\sum }_{i} {N}_{ixtrim}}{{\sum }_{i} {N}_{ix}}\end{matrix}$$

Thq=predetermined threshold for q

For equation 2, Au, derived from Equation 1, is used to test suspect product x. In equation 2, Au is trimmed to only those Spᵢₓ whose abundance in x is equal to or greater than ThNᵢₓ. This results in xtrim, which is the subset of x that contains features with sufficient abundance. Equation 3 is the authenticating test for x, where two metrics, p and q, are tested against their predetermined thresholds. If x passes these two tests, the unknown product is deemed authentic.

As a non-limiting example, the practitioner can determine that the suspect product (x) is authentic (the test profile x is determined to be matching the reference genetic signature) if the following predetermined matching criteria are satisfied: 1) each of these statistically authenticating features occurring in the test profile x must be represented by at least 5 sequence reads to be considered present in the test profile x; 2) Thp=at least 50% of the statistically characteristic authenticating features within Au are present within AuTrim; and 3) Thq=fraction of cumulative abundance of all features present in x that are authenticating exceeds 5%. Given these predetermined cutoffs, the test sample x is deemed to be matching the reference genetic signature (e.g. product is authentic, product is from known geolocation of expected origin, etc.) if all of these criteria are satisfied.

In other embodiments, the predetermined matching criteria can be 1) each authenticating feature must occur at least 1, 5, 10, 50, or 100 times in the test profile; 2) at least 10%, 30%, 40%, 60%, 70%, 80% or 90% of the statistically characteristic authenticating OTUs occur in the test profile; and 3) the cumulative relative abundance of all matching authenticating OTUs exceeds 1%, 10%, 25%, 50%, or 75% of the test profile. In some embodiments, only one of the criteria must be satisfied for the test profile to be deemed matching, or alternatively a more complex set of predetermined matching criteria must be satisfied.

The predetermined cutoff criteria will, in some cases, be set based on prior knowledge of either the reference set, or the test product, or both. As a non-limiting example, if the authenticity of a test product is being evaluated, and the product will only be determined to be authentic if it was produced using known authorized methods in the same manufacturing facility as the reference samples, a relatively strict set of predetermined cutoff criteria might be used. In this case, 1) at least 80% of the statistically characteristic features must also occur in the test profile; and 2) the cumulative abundance of all matching authenticating features must exceed 50% of the test profile. In another non-limiting example, if the test profile will be deemed authentic if it was produced in the same region of the world, using authorized methods that vary among facilities, a less strict set of predetermined cutoff criteria might be used. In this case, 1) at least 10% of the statistically characteristic features must also occur in the test profile; and 2) the cumulative abundance of all matching authenticating features must exceed 1% of the test profile.

In some applications, the analysis will be carried out on a replicate set of test samples, rather than a single test sample. In these cases, the set of test profiles will be deemed matching if at least 50% of the replicate test profiles satisfy predetermined matching criteria. If less than 50% of the replicate test profiles satisfy both example predetermined cutoff criteria, the set of suspect goods is deemed to be not authentic.

In some applications, the analysis will be carried out on multiple sets of test samples being matched to multiple sets of reference profiles. In these cases, any of a variety of machine learning classification tools can be employed, including, but not limited to, support vector machines, random forest classifiers, and K-nearest neighbors classifiers. Those of skill in the art will appreciate, upon contemplation of this disclosure, that a wide variety of machine learning classification tools apply to the present invention, and, depending on the classification tool employed, may or may not require pre-selected features using the methods described above. As a non-limiting example, if a reference product is produced in multiple different facilities, each facility can be represented by a set of reference genetic signatures. Multiple groups of test samples can be tested simultaneously using a machine learning classification tool to determine the authenticity, provenance, transit history, or raw materials used for each individual test sample. In this example, the multiple sets of reference genetic signatures can be employed as the “training set” to develop a classification model, while the test products comprise the “test set” that is being classified according to the features present or not present in the reference genetic signatures.

### Authentication

In one embodiment, the invention provides a method for determining the authenticity of a suspect product, which may include a determination that a product is genuine—made or authorized for manufacture by a particular entity—or counterfeit. This method includes (or presupposes the existence of) generating a reference genetic profile of an authentic product, a profile of a suspect product, and then comparing the profiles of the two products, determining that the suspect product is not authentic if the profiles materially differ from one another.

A suitable reference profile for (the genetic signature of) an authentic product can be obtained by analytically selecting the most statistically characteristic authenticating OTUs from a set of replicate known authentic products using a predetermined set of cutoff thresholds to generate an authentic reference profile, which can be viewed as a genetic signature of the product. As a nonlimiting example, the statistically characteristic authenticating OTUs might meet two predetermined cutoff thresholds: 1) the OTU occurs in at least 50% out of the authentic products; and 2) the OTU is represented by at least 5 DNA sequences isolated from each of the authentic products in which it occurs. In this example, all OTUs meeting these predetermined cutoff thresholds make up the authentic reference profile for a product. The authentic reference profile might include between 10 and 1000 OTUs but the number will vary among products according to factors such as how much microbial biomass is on the product being tested, the microbial load of raw materials used in the process of manufacturing the products, the level of human contact with products during the manufacturing or packaging process, the built environment microbiome of the manufacturing facility, and the amount of exposure the product has to microbiomes during transit from a manufacturing facility to the point at which the product is tested.

In other embodiments, the predetermined cutoff thresholds can be 1) the OTU occurs in at least 30%, 40%, 60%, 70%, 80% or 90% of authentic products; and 2) the OTU is represented by at least 10, 20, 50, 100, 500, or 5000 DNA sequences isolated from each of the authentic products in which it occurs. In some embodiments, the predetermined cutoff threshold will be the presence of a single diagnostic OTU. In some embodiments, the predetermined cutoff threshold will be based on a metric that encompasses the cumulative molecular profile of a sample, such as the total number of OTUs occurring in a sample, or the diversity of OTUs occurring in a sample, or the relative abundance of a particular diagnostic OTU compared to all other OTUs in a sample.

When a “suspect” product is tested (more generally, when a product is tested in accordance with the methods of the invention), the OTUs from the suspect product are compared against an “authentic” reference profile (the quotations indicate that reference profile might be from a counterfeit product, as when the method is being practiced to determine if a product originates from a known counterfeiting operation). As a non-limiting example, the suspect product may be deemed authentic (matching) if the following predetermined matching criteria are satisfied: 1) at least 50% of the statistically characteristic authenticating OTUs occur in the suspect product profile; and 2) the cumulative relative abundance of all matching authenticating OTUs exceeds 5% of the suspect product profile. If either of these criteria is unsatisfied, the suspect product is deemed to be not authentic.

In other embodiments, the predetermined matching criteria can be 1) at least 30%, 40%, 60%, 70%, 80% or 90% of the statistically characteristic authenticating OTUs occur in the suspect product profile; and 2) the cumulative relative abundance of all matching authenticating OTUs exceeds 1%, 10%, 25%, 50%, or 75% of the suspect product profile. In some embodiments, only one of the criteria must be satisfied for the product to be deemed authentic, or alternatively a more complex set of predetermined matching criteria must be satisfied for the product to be deemed authentic.

In some cases the authentication test will be carried out on a replicate set of suspect products, rather than a single suspect product. In these cases, the set of suspect products will be deemed authentic if at least 50% of the replicate suspect products satisfy predetermined matching criteria. If less than 50% of the replicate test profiles satisfy both example predetermined cutoff criteria, the set of suspect goods is deemed to be not authentic.

As indicated by the illustrative examples above, in one important aspect and various embodiments, the present invention provides methods and materials for detecting a counterfeit product through procuring and comparing genetic or microbial profiles. In particular, the present invention provides methods and materials for establishing a reference genetic signature for an authentic product, which profile is subsequently compared to genetic profiles of products with unknown provenance to determine the authenticity of the products with unknown provenance.

In a more complex embodiment, a genetic or microbial profile is generated from a product and compared to that of a suspect product. In generating these profiles in this and other methods of the invention, the invention provides methods to avoid interference from nucleic acids isolated from microbes unassociated with the manufacturing process. As discussed in Section 2, the features in the product profile used as a reference signature are selected by clustering techniques and feature selection steps that may be repeated as many times as necessary to obtain the desired signature specificity.

The present invention provides data analysis methodology and data analytics that can generate and analyze (typically compare) microbial profiles of products, determine the authenticity of products, and so to determine or detect counterfeit products. In some embodiments, a genetic or microbiome signature or profile is determined from an authentic product or from a facility from which an authentic product is produced. The microbiome profile provides a reference signature against which can be compared microbiome profiles of products of unknown provenance. In some instances, a product is considered authentic if a minimum number of signature characteristics of the product of unknown provenance match the reference signature. This same type of matching may be used to sort items or products of unknown provenance from authentic products. Further, this same type of matching or comparison may be used to determine the origin of a consumer product or item.

In some instances, a microbiome profile for an authentic product is established through the collection of samples from multiple units, so as to compensate for inherent variability in the manufacturing process. In some instances, microbiome profiles are updated when a change is made to the facility, the raw materials used, the staff working in the facility, or to the product produced in the facility. In some instances, microbiome profiles are updated in response to changes in seasons or after a weather event that may affect the microbiome of the facility. In some instances, microbiome profiles are updated at a regular interval, as part of an established procedure.

In some instances, microbiome profiles are obtained from different products to determine relative quality or other characteristics between the two or more products that are otherwise considered identical. For example, agricultural products such as barley are typically classified using metrics such as minimum and maximum protein level, moisture levels, test weight, foreign material tolerances, and percentage or kernels that have sprouted. Blight-damaged kernels are kernels and pieces of barley kernels that are covered at least one-third or more with fungus or mold. Barley containing more than 4 percent of blight-damaged kernels is designated “blighted.” However, separate lots of barley that each meet the specifications can still possess significantly different quality levels. For example, fungus may be present on two lots kernels in orders of magnitude different levels yet neither lot contains kernels that are covered at least one-third or more with fungus or mold. Alternatively, the two lots may contain similar gross levels of microbial load, but fungal OTUs on one lot of kernels may be of fungal types that are considered far less damaging than fungal OTUs on the other lot. This application of the instant invention can be used for many types of products that appear to be of identical quality without use of the methods of the invention.

In at least one embodiment of the present invention, microbiome samples are collected and initially analyzed to determine a microbiome profile of an authentic consumer product. In some instances, multiple microbiome samples are collected and analyzed over a period of time to allow for variations in facility and manufacturing conditions. The microbiome profile establishes a “fingerprint” for the authentic consumer product. Microbiome samples are subsequently collected and analyzed to determine a microbiome profile of a product having an unknown provenance. The microbiome profile of the authentic consumer product is then compared with the microbiome profile of the unauthenticated product to determine authenticity.

In some instances, the collection and/or analysis of the microbiome samples is achieved via a high-throughput screening system. In some instances, the data processing software of the high-throughput screening system is configured to identify correlations between the microbiome profile of the authentic consumer product or test article and the microbiome profile of the unauthenticated product, reference article or reference geolocation. This data may thus be used to guide individuals to detect counterfeit consumer products, determine geolocation of origin, and other applications in accordance with the present invention.

In some instances, a microbiome profile of an authentic product is compared to a microbiome profile of the facility from with authentic product is derived, and a microbiome profile of a facility suspected of producing counterfeit consumer products. In some instances, the microbiome profile of the authentic product and the microbiome of the facility of the authentic product will comprise similar OTUs that are not found in the microbiome of the suspected counterfeit facility. Similarly, in some embodiments a microbiome profile of a counterfeit product is compared to microbiome profiles of one or more suspected counterfeit facilities to determine the source of the counterfeit product. Further, in some embodiments microbiome profiles of two or more counterfeit products are compared to determine a common source of the counterfeit products.

In some instances, a database of microbiome profiles for known counterfeit products is provided as a resource against which the microbiome of an unknown or new counterfeit product may be compared to determine a source of the new counterfeit product. In some instances, a database of microbiome profiles for known authentic products is provided as a resource against which the microbiome of an unknown authentic product may be compared to determine the facility from which the unknown authentic product was produced.

Under conditions where a counterfeit microbiome profile is observed by an automated sequencing device or other sensor, an instruction or alert may be sent to an interested party, such as the owner of the authentic product.

Given that one can view any counterfeit and real versions of the same or similar product as differing in some “quality”, those of skill in the art will appreciate, upon contemplation of this disclosure, that the present invention, most generally, offers methods and technology for assessing whether any two similar objects or materials are of the same quality, whether that be authentic versus counterfeit or any other distinguishing feature, aspect, or attribute that can be deduced or inferred from the nucleic acid that inevitably accompanies all objects in commerce and commercial use. For example, the methods of the invention can be used to determine the origin and relative quality of agricultural commodities such as corn, soybeans, wheat, and other products.

All of the above methods and systems are useful in other methods of the invention that go beyond product authentication and provide information that aids in tracking the movement of objects, materials and products in commerce.

### Products in Distribution: The Analysis of Product Manufacturing and Distribution Networks

This disclosure including the examples below illustrates how the methods of the invention enable the practitioner to identify the origin, source, transit history, manufacturing history, or handling history of a person, item, or material of interest, such as a good (which may be a natural product) or product (such as an article of manufacture as opposed to a natural product, but product can include, for example, packaged natural products), by generating a genetic profile of the person, item or material and comparing that to some other genetic profile.

As discussed in Section 3, if the other genetic profile is a suspect product profile and the first genetic profile is an authentic product reference profile, then the test may reveal whether the suspect product is genuine or counterfeit. However, by including other profiles, for example, those of a genetic profile of a similar or different person, item or material having a known origin, source, transit history, manufacturing history, or handling history, the invention enables much additional information to be obtained. The methodology generally involves comparing the profiles to determine if they are substantially similar or different; and concluding from the comparison that the person or material or item of interest has a matching origin, source, transit history, manufacturing history or handling history only if the profiles generated are substantially similar at a predetermined level of similarity between all or a subset of the genetic profiles.

This methodology, broadly stated, has many and widely diverse applications. To the extent the discussion in this section, is focused on how to use the method to disrupt criminal or other illicit (i.e., tortious rather than criminal) activity, it is for illustrative purposes only. However, use of genetic profiling as provided by this invention to identify, detect, disrupt, and collect damages, fines, or taxes due for trafficking in goods or products that may be mislabeled will be a significant advance in these important efforts.

Thus, the methods of the invention can be applied to determine if goods or products otherwise destined for importation, shipment, or sale are of possible counterfeit origin, i.e., to authenticate counterfeit vs. genuine goods. To begin to appreciate the diverse benefits of the invention in disrupting illegal or illicit activities involving large networks, one might being by appreciating that, once the practitioner has a genetic profile that identifies a counterfeit product, that profile can be used as the “authentic” product in the methods of the invention to identify products that are counterfeit in a wide variety of settings, including, for example, at a port of entry, where the invention enables rapid analysis of large numbers of products to ensure that authentic products reach their intended customers with minimal delay and that counterfeit products do not.

Moreover, once in the marketplace, the methods of the invention can be used to determine market share of a counterfeit product, for example. So, the invention can be practiced to determine the percentage of goods or products in a given market geography or outlet type or a supply chain that are of counterfeit or other specific origin.

Those of skill in the art on contemplation of this disclosure will, however, realize that the invention can provide much more information about not only counterfeiting networks but any type of network for moving a good or product (or person) in commerce. For example, the invention can be practiced to identify key components and locations of a counterfeiting network (or criminal or illicit enterprise), including but not limited to linking goods to a specific counterfeit factory, warehouse, distribution center, or other location. In general, this is done by matching signatures of seized goods in a distribution chain to goods seized at a factory (or other location). Once the genetic profile of a counterfeit product is known, it can be used to identify other counterfeit products of similar manufacture.

The power of the invention does not stop there, however. As discussed elsewhere in this disclosure, the genetic profile of a good or product can vary depending on how the samples used to generate the profile are collected. For any product that is packaged at a factory (or first location) and then packaged or re-packaged at another (i.e., for loading into a carton, crate, or other larger package of the same or different products, or for loading onto a truck, freight car, ship, or airplane or other mode of conveyance), the genetic profile of the packaging can be used to identify a counterfeit distribution hub by showing that products of different origin (due to having different genetic profiles from one another due to being produced at different factories, for example) have packaging with matching genetic profiles.

Thus, in some embodiments, the invention involves the generation of a genetic profile or signature in which packaging is used to link packaging to a counterfeit distribution hub; or to identify how many different factories may be supplying a counterfeit distribution hub; or to identify how many different distribution hubs may be supplying counterfeit products to a market. In some embodiments, a genetic profile of a good or product, optionally including a profile of any packaging associated with such good or product, is used to identify how many different counterfeiting networks may be generating counterfeit products or to link one or more retail outlets to particular counterfeit supplier or to link one or more individuals or groups to counterfeiting activity.

Thus, the artisan, using the present invention, can establish a genetic profile for a counterfeit (or other illicit) product and then use that profile to identify other counterfeit goods. If the genetic profile of the counterfeit (or other illicit) good or product from a specific factory, then it can be used to identify product from that factory at any point in the distribution network, up to an including the retail market. If the genetic profile is from the packaging of the product, then that packaging genetic profile can be used to identify other goods and products (even those of a different type entirely) moving in that same illegal or illicit distribution chain (from original production sources, i.e., raw minerals and factory output, through final retail sale and use). In this manner, comparison of profiles from known counterfeit (or other illicit) goods or products of given origin or location in a supply chain with those of suspect goods or products can be used for a variety of useful purposes, including but not limited to showing that goods or products purchased or otherwise acquired. i.e., for inspection at a port of entry or via seizure by police or judicial action, are counterfeit (or otherwise illicit) or were distributed in a distribution chain used to distribute other illicit or illegal goods or products. For example, if a factory is proven to produce counterfeit goods, then goods or products in distribution including retail sale can be identified as having been produced at that factory or distributed in the same distribution chain as products from that factory. In converse fashion, profiles of counterfeit goods obtained as described herein can be used to identify the factories that produced them and key locations in their distribution chain.

Thus, the number of different factories producing counterfeit goods can be identified by the number of unique profiles identified at retail. The number of different distribution hubs can be identified by the number of different profiles from one or more packaging layers for all products with identical product signatures. The number of different networks can be identified by the distribution hubs and factories identified. Retail outlets complicit with counterfeiters can be identified by linking goods in those outlets to counterfeiters and their distribution networks.

In these methods, the genetic profile may be used to determine (or be based on) geographic origin of goods. e.g., the region, country, state/province, city or other region from which or good or product originated. The genetic profile will contain in such embodiments geolocation or geoclassification markers in the profiles (e.g. ethnicity of human fingerprint, geolocation-specific from environment, or markers specific to the outdoor environment). Such profiles can be used to determine the geographic region of distribution centers and thus aid in the identification of locations where illicit or illegal goods might be seized. Thus, the methods of the invention can be used to determine where a good or product or component thereof has traveled since manufacture or isolation from nature. More generally, the methods of the invention can be used to link goods or products to a specific factory, counterfeit network, or criminal enterprise by matching signature of seized goods or products in a distribution chain to goods or products at a suspect factory. Thus, in various embodiments, genetic profiles generated in accordance with the invention are used to determine the geographic origin of counterfeit goods or components thereof. In some embodiments, the profiles include geolocation marker selected of the group consisting of a sequence of human, plant, microbial, or animal-derived nucleic acid.

The methods of the invention can be used in diverse ways to calculate damages from an illegal or illicit activity. For example, the methods can be used to accumulate evidence for calculating damages, i.e., by showing the production from a counterfeiting factory or distribution center in terms of percentage of the market generally or in some specific area. Of course, the methods of the invention can also be used to show that suspect goods were or were not produced in an authorized factory (or a counterfeiting factory). Thus, the invention can be practiced to link goods and products to a distribution network of an illegal good or product.

The artisan will appreciate, therefore, that the invention has application in the fields of security, intelligence and law enforcement. The invention can be practiced to link goods and products, including contraband, to a distribution network, which may be a criminal enterprise. Contraband includes, without limitation, a drug, weapon, or currency used in or obtained via a criminal enterprise. The methods can be practiced to identify tariff avoiders, where a shipper is misrepresenting the country of origin, e.g. on a shipping container or label, as goods and products can be taxed differently depending on country of origin. The methods can be practiced to determine the location of origin of an object, i.e., a good or product, including contraband. Thus, the methods can be practiced to detect, prosecute, or recover damages from criminal activity involving tariff avoidance; misrepresentation regarding a component or other feature of a good or product; and misrepresentation regarding a country of origin of a good, product, or shipping container.

In various embodiments, the methods may be used to determine geographic regions of distribution centers of counterfeit goods; or to prove that suspect goods or products are counterfeit; to prove whether goods or products were made in a particular factory; to identify counterfeiters; to identify factories where counterfeit goods or products are produced; to identify distribution networks for counterfeit goods or products; to identify retail stores and markets where counterfeit goods or products are marketed; to apprehend counterfeiters; to stop or retard counterfeiting activities; or to prove damages an authentic goods purveyor has suffered from counterfeiting activities. In some embodiments, the invention will be practiced to determine if a good or product is or is made from or with a conflict mineral or a rare earth element or is a good or product from an embargoed country or is a product with undesirable sustainability profile.

The methods of the invention can be practiced to determine where a good or product or component thereof involved in criminal or other illicit activity has traveled since manufacture or isolation from nature or other acquisition by criminal activity. The methods of the invention can be practiced to determine the location history of an object (where was it made and packaged and stored during distribution, for example), which in turn can be used to identify other products in commerce (whether at the factor in production or in transit to retail or at retail sale locations) that have the same genetic profile and so are linked for evidentiary purposes to the genetic profile of a known counterfeit or illicit product.

While the invention can be used generally to deduce information re shipping and cargo tracking of illegal or illicit products, it has application to supply chain source and quality tracking for commercial as well as law enforcement purposes. The methods of the invention have application in supply chain verification, in identifying the source of raw materials, and in monitoring authorized supplier usage by outsourced manufacturers or distributors. The methods can be practiced to verify a good or product is conflict-free or slave-free or has any other attribute that can be ascertained or reasonably inferred from comparison of genetic profiles and signatures collected and analyzed in accordance with this invention.

The methods of the invention can generally be used to verify raw materials, goods, products or product components, and packaging are coming from the same place or from particular sources. Thus, the methods can be used to identify recycled components not made at the same factory as the original parts. The methods can be used to identify a biosimilar drug product marketed under the brand name. The methods can be used to identify grey market goods. The methods can be used for quality verification (within food grades for example). In all of these diverse methods, a genetic profile judged sufficiently unique to a first product having a desired property is generated and used as a comparator to profiles obtained from other products (or parts or goods or raw materials) to determine if those other products share or don't share the desired property.

In this fashion, the methods of the invention are useful not only in law enforcement but more generally in commerce for such dual purposes as ship and cargo tracking; supply chain source and quality tracking, i.e., to verify the supply chain, which might include, without limitation, identifying or verifying the source of raw materials; monitoring authorized supplier usage by outsourced manufacturer or distributors; verifying goods are made from components sourced from “conflict-free” or “slave-free” or “child labor free” supply chains; verifying that raw materials are coming from or not coming from a particular place; and verifying recycled components (by showing profiles don't match that of new products). For many industries, including without limitation, the food, cosmetics, and over-the-counter and prescription drug industries, the commercial and law enforcement uses of the methods of the invention will be similar in practice but different in application, in that the methods can be used to identify whether a biological drug product is a biosimilar, whether a pharmaceutical product is genuine or counterfeit, and if genuine, the country of origin, for purposes of stopping trafficking in grey goods in the pharmaceutical industry particularly but similar problems exist in other industries that are tractable in similar fashion with the present invention.

In some embodiments of the present invention, systems and methods for identifying and tracking the travels of a person or an object, such as a shipping container, truck, crate, box, package, personal effect, aircraft or maritime vessel are provided. For example, in one embodiment the present invention provides forensic capabilities to identify what locations an object has visited through rapidly analyzing the DNA of microbes isolated from the surface of the object. In one embodiment, a unique molecular fingerprint associated with one or more microbiomes of a person or object is used to determine from where the person or object originated and who or what has come into contact with it along the way.

In one embodiment, a microbiome surveillance platform is provided which 1) does not require transportation providers to voluntarily participate, 2) cannot be easily falsified, and 3) is readily scalable to encompass all types and sizes of objects or modes of transportation. In some instances, the microbiome surveillance platform comprises a plurality of operably connected, self-contained, stand-alone products that work together to provide a surveillance system. In some instance, the microbiome surveillance platform comprises a single self-contained, stand-alone product that may be used independent of any other equipment.

In one instance, a surveillance platform is provided based on the selection of a set of microorganisms and microbial genes associated with objects or transportation vessels. In one embodiment, the microorganisms and microbial genes are a subset selected from set of microorganisms that have been cataloged in one or more existing microbiome databases. In some embodiments, the one or more existing microbiome databases provide universal geographic coverage for a sample collected from any microbiome. As such, some embodiments of the invention provide one or more microbiome databases that contain at least one subset of any organism and gene collected as part of a microbiome sample.

In some instances, microbiome databases are organized in such a way as to optimize detection and tracing based upon the type of microbiome sample collected. For example, in one embodiment microbiome databases are arranged based upon the media of the microbiome sample. In one embodiment the microbiome databases are arranged based upon the region, geographic location, or environment from which a microbiome sample may be collected. In some instances, a microbiome database focuses on one or more rare indicators, which may include a combination of taxonomic, single nucleotide polymorphism (SNP), phylogenetic, functional, and/or strain level variations, or any type of genetic variability. In one embodiment, the one or more rare indicators are specific to a region, geographic location or environment.

In some embodiments, the microbiome databases are used to construct a code or “fingerprint” that correlates these and other indications and variations to specific geographic locations, environments, and/or media. These fingerprints may them be used to map the origin and route of a transportation vessel and/or cargo transported therein.

### Sampling Methods, DNA Sequence Analysis, and Generation of Profiles

Microbiome Sampling—Types of Samples; Sampling Methods. Various sampling methods may be used to collect target molecules. In some instances, a sampling method is selected based upon the specific characteristics of consumer product or facility from which the target molecules are being collected. For example, sampling via a cotton or nylon swab may be effective for consumer products comprising solid surfaces. In some instances, such as foodstuffs, beverages and some pharmaceutical products, a small portion or fragment of the product may be collected and directly analyzed. Further, in some instances a consumer product may be manufactured to include a device or surface specifically designed to capture a microbial sample. For these instances, the sample collection device or surface may be either removed from the product or directly sampled for subsequent analysis. In some instances, a sampling method is selected based upon desired data or analysis parameters. In some instances, tracking a known OTU on a product or other desired surface may necessitate a specific sampling method.

In accordance with the invention, a characterization of the microbiome of a consumer product will be determined from samples obtained from the product and/or packaging associated with the product. Suitable sources of samples include surface swabbings, small samples or fragments of the products themselves, air samples obtained from within airtight packaging, and samples of packaging or other materials related to the product.

In accordance with the invention, a characterization of the microbiome of a facility in which a consumer product is produced, or multiple facilities in which components of a product are manufactured or processed will be determined from samples obtained from the facility. Suitable sources of samples include raw materials and partially finished materials, air, dust, surface materials, and water, as well as samples from humans and machinery in the facility.

Facility and product samples are collected for the analysis of nucleic acids (DNA and/or RNA), and optionally other metabolites such as carbohydrates, lipids and small molecules, and so are collected and processed in a manner conducive to minimizing degradation of the molecules intended for analysis.

Product authentication in accordance with the invention includes a diverse number of embodiments, given the wide variety of products for which authentication methods would be of value to consumers, retailers, and manufacturers. In many of these embodiments, sampling is done from an interior surface of a packaged product or from the product itself (such as wine, skin lotion, cosmetic substances etc.).

For example, in various embodiments of authenticating cigarettes in accordance with the methods of the invention, the outer packaging is discarded (or carefully removed and only the inside surface of the packaging is sampled for testing), and only inner surfaces of the remaining packaging are tested (if tested at all). This is because the outer packaging would be expected to contain DNA of the clerks shelving the product, for example. Those of skill in the art will appreciate upon contemplation of this disclosure that, regardless of the product to be authenticated or analyzed for any purpose, sampling will typically take place from some portion of the product less exposed or not exposed to post-manufacturing microbial exposure. For cigarettes, such locations include, for example, the inside surface of any plastic overwrap, the outer and inner surfaces of any container(s) or wrappers (typically more than one, i.e., the box of cartons, the carton, the individual packs of cigarettes in the carton the paper sleeve in the carton, the paper wrap of the cigarette, and similar sample locations in other products), and the tobacco itself. In the illustrative Example below, the samples were prepared from the tobacco itself, i.e., a cigarette was extracted from a pack (all operations in sterile hood taking care to avoid microbial exposure) using clean, sterilized forceps, tobacco was removed from the tip to expose tobacco from the interior of the cigarette and profiled as described. Another example is a pharmaceutical pill sealed inside a blister pack, which will have no exposure to other microbiomes once the consumer packaging around the pill is sealed, even though the transit packaging used to transport the pills to a point of sale will be exposed to microbiomes during transit as it goes through different environments and locations.

Samples may be obtained by any means that does not materially alter or destroy the target molecules contained therein. Target molecules may comprise any biological material of interest, including, but not limited to microbes, viruses, DNA, RNA, proteins, spores, bacteria, pathogens, shedded human cells, human or animal hair, pollen, microbial VOCs, or any chemical product of microbial metabolism.

Surfaces can be sampled to derive a microbiome profile of a consumer product, or a facility from which a consumer product is provided, including retail stores and anywhere upstream in the distribution network (ships, shipping containers, trucks, holding facilities, cold storage units, warehouses etc.). Surface samples may be obtained from any surface having a surface area of sufficient size from which to collect the sample. For example, in some instances a surface sample area may range from 1-100 cm². Suitable surfaces for sample collection may include any solid or semi-solid surface that is accessible for sampling. For example, suitable surfaces include vertical surfaces, horizontal surfaces, textured surfaces, smooth surfaces, wetted surfaces, dry surfaces, interior surfaces, exterior surfaces, and so forth.

Determination and selection of surface sample area is largely driven by the consumer product. For example, in some instances a surface sample area is limited to an interior surface of a consumer product, and as such is limited by the size of the consumer product (see discussion in sampling above). In some instances, suitable sample surfaces may be limited by proximity of sensitive surfaces, such as sensitive electronic components or circuitry.

Surface sampling is often done by swabbing a selected surface with a sterile cotton or nylon swab. In some instances, the sampling is done with a dry swab. In other instances, the sampling is done with a swab that has been wetted with a sterile, stabilizing buffer solution. Buffer solution is generally selected based upon the biological needs or other characteristics of the target molecules. The buffer can also help dislodge microbes from the selected surface and attract the microbes onto the swab bristles or the wipe fibers. The buffer further acts to stabilize the microbial activity, if any, of the target molecules. In some instances, a sterile cotton or nylon wipe is used in place of a swab.

Material picked up from the selected surface can be rinsed from the swab or wipe with sterile solution. In some instances, the sterile solution comprises a buffer solution used during collection of the surface sample. Surface samples are immediately stored in sterile containers, frozen, and transported to a freezer facility until laboratory processing. As such, the microbes are preserved from degradation. Alternatively, the samples can be places in a stabilization solution such as RNAlater®, an aqueous, nontoxic tissue storage reagent that permeates cells and tissues to stabilize and protect cellular RNA. Stabilizing solutions minimize the need to immediately process samples or to freeze for later processing.

Air sampling can also be performed by pulling air from an environment (such as a manufacturing facility, shipping container, shipping box, etc.) over a filter such that microbes and other airborne particles become trapped on the filter. The microbes and other associated material are then rinsed from the filter and analyzed.

Since consumer goods, both authentic and counterfeit, can in some instances harbor very low microbial biomass, DNA extraction methods specifically designed to recover very small amounts (<10 ng of DNA, <5 ng of DNA, <1 ng of DNA, <100 pg of DNA, <10 pg of DNA) may be employed. Such methods have been utilized, for example, in scientific studies of ancient DNA from archeological dental calculus samples (see Pathogens and host immunity in the ancient human oral cavity, Nature Genetics, 2014 and associated supplemental methods). Low-biomass DNA extraction methods focus attention on, for example: limiting the contamination potential from the sampling environment; limiting the contamination potential from the laboratory processing environment; and utilizing DNA- and RNA-free reagents, buffers, water, and laboratory supplies.

Accordingly, while there are products, such as sterile medical equipment, that do not (if properly manufactured) have a microbiome, the present invention is nonetheless applicable to such products, i.e., to determine if they were manufactured under sterile conditions successfully or to determine if they are counterfeit by profiling the non-sterile packaging surfaces that necessarily contain them.

Thus, high biomass load can be indicative of unclean manufacturing processes, which in turn highly correlate with counterfeit goods in those industries, i.e., consumer electronics, where clean room manufacturing is the norm. In one important aspect, the invention provides a simple authentication method for such products that involves any means for distinguishing between high and low biomass loads Thus, in one embodiment, the product profile is a simple indicator of the biomass load of a product. In accordance with some embodiments of the invention, a product is authenticated—or declared counterfeit—based solely on a measure of biomass load. In most instances where this approach provides the most informative results, the authentic product has a lower biomass load than the counterfeit product. However, the converse may be true for authenticating high biomass products, like cheese, tobacco in cigarettes, wine, and agricultural products. These embodiments are typically practiced with goods where the authentic products are made under sterile or at least highly clean conditions, in contrast to the counterfeit product. Total biomass load can be measured, for example, by measuring adenosine triphosphate (ATP) using kits standard in the art such as the Invitrogen® ATP Determination Kit (A22066). See Appl Environ Microbiol. 2008 August; 74(16): 5159-5167.

More typically, however, the biomass load, and therefore the nucleic acid load in the sample will be low. For such samples, nucleic acids are extracted (e.g. (MoBio Soil kit; see Meadow, J. F., Altrichter, A. E., Bateman, A. C., Stenson, J., Brown, G. Z., & Green, J. L. (2015). Humans differ in their personal microbial cloud, (1), 1-22; this methodology was used for the other examples filed herewith at even date) and subjected to various sequencing methodologies that may or may not include fragmentation, cloning and amplification (such methods may also be used as indicators for biomass load. e.g. in real-time quantitative PCR). For air and other gases, sampling may be done, for example and without limitation, using a vacuum pump or syringe to pull the air or other gas through a filter to which microbes adhere or become otherwise entrapped. Water/liquid samples can also be obtained via suction through a filter.

Microbiome Sampling—Frequency of Sampling. In accordance with the invention, the microbiome of a product and/or facility is characterized at a point in time that may be tracked to the specific product and facility. For example, in some instances the microbiome of a product is sampled in connection with the production of a batch or shipment of a product. In some instances the microbiome of a product and/or a facility is sampled in connection with a seasonal change. In some instances the microbiome of a facility is sampled in connection with a change of production of a first product for a second product. In some instances the microbiome of a product and/or facility is sampled in connection with shift or crew change. In some instances the sampling is of a product taken from shelves in a retail store, or farther upstream in the distribution chain, as well as from sorting facilities of shippers.

Microbiome Sampling—Nucleic Acid Analysis. A microbiome profile may be obtained by any known method in the art. In some embodiments, product or facility microbiome samples are analyzed via one or procedures selected from the group consisting of RFLP analysis, PCR analysis, STR analysis, Illumina sequencing, and AmpFLP analysis. One having skill in the art will appreciate that the microbiome profile may be determined by other suitable analytical techniques.

Generally, microbial DNA is extracted from the collected microbiome samples and sequenced through various steps of cellular and genetic digestion via the use of detergents, buffers, mechanical disruption, and restriction enzymes. In some instances genetic markers may be used to identify and/or quantify a specific type of organism within the sample quickly and accurately. In other instances, a high-throughput screening method is utilized to extract and analyze DNA from the collected samples. In other instances, a high-throughput system is utilized to further perform nucleic acid sequencing of the extracted microbial DNA.

The examples below extensively illustrate how PCR/amplicon sequencing can be used to generate OTUs and select features for reference, product, and test profiles. As discussed, however, metagenomics technology can also be used to generate genetic profiles and select features to create reference, product, and test profiles for the myriad and diverse applications of this inventive technology.

Metagenomics involves whole genome sequencing, and each whole genomic sample derived from a consumer product microbiome can be, in one illustrative method, sheared into fragments of approximately 500-600 base pairs using the E210 system (Covaris, Inc. Woburn, Mass.). Fragment products can then be amplified through Ligation Mediated-PCR (LM-PCR), performed using the HiFi DNA Polymerase (Kapa Biosystems. Inc., Cat. No. KM2602). Purification can be performed with Agencourt AMPure XP beads after enzymatic reactions. Following the final XP bead purification, quantification and size distribution of the LM-PCR product can be determined using the Agilent Bioanalyzer 7500 chip.

Libraries are pooled in equimolar amounts to achieve a final concentration of 10 nM. The library templates are prepared for sequencing using Illumina's cBot cluster generation system with TruSeq PE Cluster Generation kits. Briefly, this library is denatured with sodium hydroxide and diluted to 7 pM in hybridization buffer to achieve a load density of 756K clusters/mm². The library pool is loaded in a single lane of a HiSeq 2500 flow cell, which is spiked with 1% phiX control library for run quality control. The sample then undergoes bridge amplification to form clonal clusters, followed by hybridization with the sequencing primer. Sequencing runs are performed in paired-end mode on the HiSeq 2500 platform. Assisted by the TruSeq SBS kits, sequencing-by-synthesis reactions are extended for 101 cycles from each end, with an additional 7 cycles for the index read. After sequencing, .bcl files are processed through analysis software (CASAVA, Illumina), which demultiplexes pooled samples and generates sequence reads and base-call confidence values (qualities). Resulting reads are mapped against the Antibiotic Resistance DataBase (ARDB). Reads that are closer than 80% identity cutoff with an E-Value less than 0.0001 are used to infer antibiotic-resistance potential. Gene functions that are more than 1% abundant, against the Kyoto Encyclopedia of Genes and Genomes (KEGG), are used to assemble metabolic pathways.

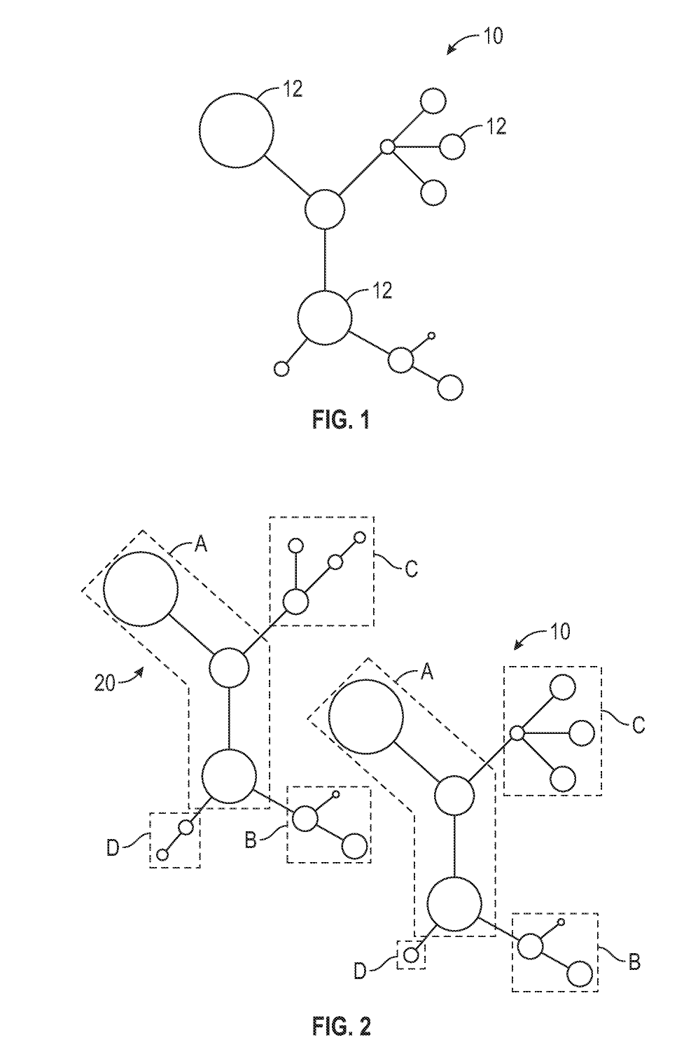

Product Profiling—Computer Analytics. With reference to FIG. 1, a schematic representation is provided which demonstrates a non-limiting visualized microbiome profile 10 of a consumer product, or a facility in which a consumer produced is derived, in accordance with a representative embodiment of the present invention. In some embodiments, microbiome profile 10 is procured through a process of collecting microbe samples from various surfaces of a consumer product or consumer product facility. For example, in one embodiment various predetermined surfaces of a consumer product are swabbed to collect microbes present on the predetermined surfaces. The collected microbes are then processed via one or more biochemical sequencing processes to characterize the microbiome of the consumer product. In some instances, the microbiome of the consumer product is characterized in a simple, visual profile, as shown in FIG. 1. In some instances, the visual microbiome profile is configured to appear uncomplicated and visually appealing, such that a non-scientist may easily derive meaning from the visual display. In other instances, the visual microbiome file comprises information that requires scientific understanding and explanation.

In some embodiments, the visual microbiome profile 10 comprises a series of interconnected nodes 12, wherein each node represents one or more operational taxonomic units (OTUs) of the product's microbiome. In some instances, the scope or sensitivity of visual microbiome profile 10 may be adjusted to increase or decrease the number of OTUs that are displayed. Thus, the amount and complexity of the displayed information may be adjusted as desired.

Referring now to FIG. 2, a comparison of an authentic product microbiome profile 10 is compared to a counterfeit product microbiome profile 20. As can be seen, parts A and B of the two profiles are identical, while parts C and D are different. In this embodiment, parts C and D indicate that the microbiome profiles are dissimilar, thereby revealing the unauthentic origins of the counterfeit product 20.

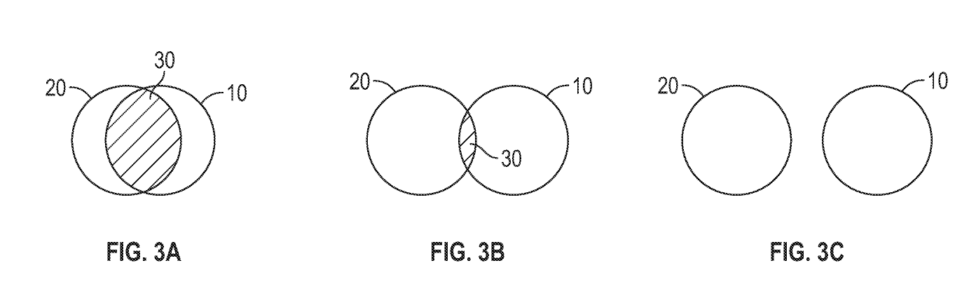

Referring now to FIGS. 3A-3C, various Venn diagrams are provided which show comparisons between a first product's microbiome 10 and a second product's microbiome 20. In some instances, the authenticity of an unknown product may be determined by comparing overlapping features of the microbiome's of the respective products. In some instances, the authenticity of an unknown product 20 is established by determining a value of microbiome identity of 50-100%, 60-100%, 70-100%, 80-100%, 90-100%, or 100% of the microbiome of the known product 10. In some instances, the counterfeit status of an unknown product 20 is established by determining a value of microbiome identity of 0-80%, 0-70%, 0-60%, 0-50%, 0-40%, 0-30%, 0-20%, 5-10%, 5%, or 0% of the microbiome of the known product 10.

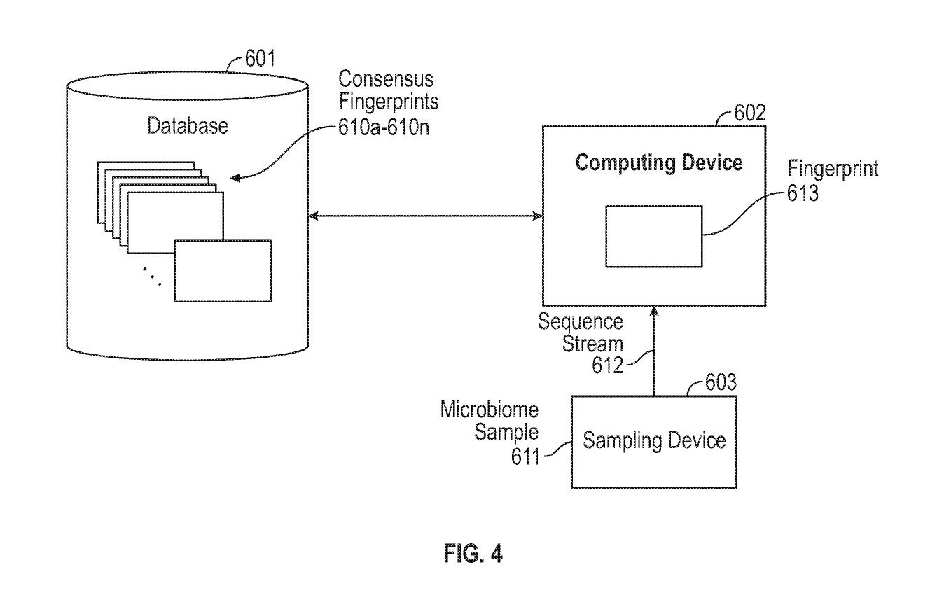

Product Profiling—Illustrative Computing System. FIG. 4 illustrates an example of how some embodiments of the present invention can be implemented using a computing system 600. Computing system 600 generally comprises a computing device 602 that includes or is otherwise in communication with a database 601. Database 601 stores one or more consensus fingerprints 610a-610n. As described above, each of consensus fingerprints 610a-610n can be specific to a geographic location, transit history, handling history, authentic manufacturing location or process, or any other reference type. In other words, each authentic consensus fingerprint can represent a microbiome that is found in a particular geographic location or represents the fingerprint of goods manufactured through a particular process in a particular factory using a particular set of raw materials, and is known to have been manufactured by the brand owner. In a particular non-limiting example, database 601 may store one or more authentic consensus fingerprints for each of a number of maritime ports.

Computing system 600 also includes a sampling device 603 that is in communication with or may be incorporated into computing device 602. Sampling device 603 can be any device capable of receiving a microbiome sample 611 and generating a sequence stream 612 from that sample. For example, sampling device 603 can be an ion channel sequencing device.

An important characteristic of an ion channel sequencing device is that it generates a stream of sequences that can be consumed in realtime. Generating a stream of sequences refers to the fact that the ion channel sequencing device outputs sequences as soon as the sequences are determined (i.e., as a stream) as opposed to outputting a fingerprint after all sequences have been determined. Prior art systems exist that can generate a fingerprint (consisting of a number of sequences) that could then be consumed by computing device 602. These prior art systems are not ideal because they do not generate fingerprints quickly enough (i.e., computing device 602 would have to wait until the full fingerprint containing all determined sequences has been generated) and such fingerprints typically contain more information than is necessary to perform a comparison to consensus fingerprints 610a-610n.

Accordingly, sampling device 603 can produce a stream of sequences that can be consumed by computing device 602 to perform a realtime (i.e., ongoing) comparison of the received sequences to the consensus fingerprints 610a-610n. In FIG. 4, computing device 602 is shown as generating/storing a fingerprint 613 representing microbiome sample 611. Computing system 602 can incrementally generate fingerprint 613 as it receives sequence stream 612. In other words, as computing device 602 receives each sequence from sampling device 603, computing device 602 can add the sequence to fingerprint 613.

Additionally, as fingerprint 613 is incrementally generated, computing device 602 can compare the current version of fingerprint 613 to consensus fingerprints 610a-610n to determine whether fingerprint 613 matches any of the consensus fingerprints. This comparison can be performed in a repetitive, ongoing manner as the number of sequences in fingerprint 613 is incremented. By performing this type of continuous comparison, computing device 602 can typically determine a match using many fewer sequences from microbiome sample 611. For example, computing device 602 can generate a correlation coefficient between fingerprint 613 and consensus fingerprints 610a-610n. Once this correlation coefficient exceeds a predetermined threshold (e.g., greater than 90%), computing device 602 can determine that a match has been found and terminate the sampling process. In some embodiments, to minimize the number of sequences that will yield a correlation coefficient exceeding the threshold, computing device 602 can prioritize particular sequences that may serve as key indicators of a sample, such as it's geographic origin, authentic/counterfeit status, transit history, and handling history (ie: which person or people have touched the object).

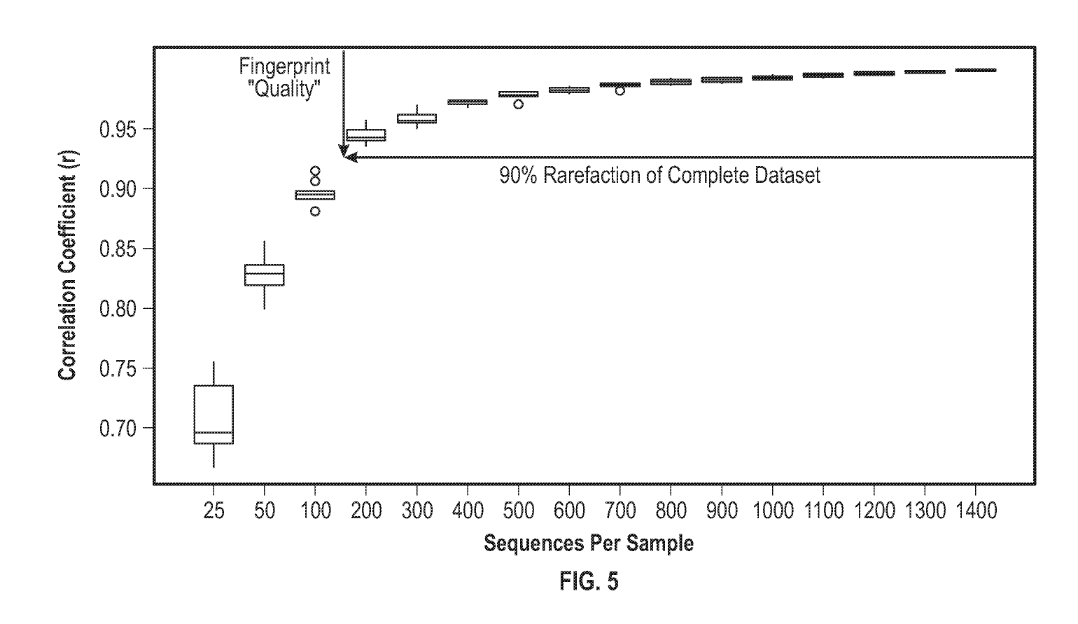

Based on testing, it appears that a match can be determined with sufficient confidence using this technique when as little as 10% of the total number of sequences that would ultimately be produced have been aggregated into fingerprint 613. In other words, by performing an ongoing comparison with consensus fingerprints 610a-610n using the incrementally aggregated sequences in fingerprint 613, computing device 602 can terminate the sampling process after sampling device 603 has produced only 10% of the samples that it would otherwise produce. Testing has shown that this discarding or exclusion of 90% of the sequence data may reduce the quality of fingerprint 613 by less than 10% as represented in FIG. 5. In this manner, determining that a new fingerprint 613 (from a microbiome sample 611) is a match or is not a match with consensus fingerprints 610a-610n can be determined much more quickly and efficiently.

Product Profiling—Fingerprint Construction and Data Analysis. Fingerprint construction to provide geographic differentiation and temporal stability is achieved first by identifying a candidate subset of taxa, wherein the taxa, in concert, provide consistent universal coverage and geographic differentiation by population variation, based on the 16S target gene, using ordination, clustering, and classification (i.e. ecological distance-based identification). In one instance, the subset of taxa is identified using constrained ordination techniques and various algorithms to efficiently extract indicator taxa from one or more datasets obtained for forensic applications. Example taxonomic metrics to quantify variation may include Bray-Curtis or Canberra dissimilarity. Phylogenetic metrics may include UniFrac. In one instance, a phylogeny-based approach is followed to exploit rich patterns embedded in evolutionary history that conventional taxonomic metrics are incapable of detecting. Phylogenetic metrics may include UniFrac.

The selected metrics are used to identify genes and genome regions that may be targeted for deeper sampling via PCR. If bacteria and/or archaea data do not provide sufficient geographic differentiation or temporal stability, the data may be further analyzed for ITS data. To quantify the probability that distinct samples originate from difference sources, the samples may further be tested with machine learning techniques and supervised classifiers, such as Bayesian neural networks, k-nearest neighbors, Parzen windows, or support vector machines.

In some embodiments, the scope of data is expanded through a more comprehensive metagenomics approach, wherein the 16S/ITS amplicon data is augmented with WMS data. The metagenomics codes are constructed using a framework of algorithms for defining a compact subset of genomic features that efficiently distinguishes samples of differing origins and (wherein the microbiomes of the samples are different) assigns a unique code to all samples. In one instance, this approach is optimized by prioritizing biogeographic reproducibility and differentiation for each sample.

Phylogenetic metrics are added to the analysis utilizing analytical tools, such as PhyloSift and MetaPhlAn, to identify geographically distinguishing features that emerge from population genetics, including species- or strain-specific marker genes that are capable of being explicitly targeted within the WMS data. Eukaryotic microbes may further be used to add geographic variation if their biology limits the rate of genetic dispersal.

Where greater stability, robustness or uniqueness is desired, the methodology is further extended to incorporate single nucleotide polymorphisms and copy number variants, such as by using PhyloCNV. Functional variations may further be added, for example by identifying protein families that differentiate metagenomes (e.g. using ShotMAP). In one embodiment, kilobase-windows are incorporated into the analysis to capture variability not present in any of the metrics.

Product Profiling—Real-Time Fingerprint Generation and Analysis. A fingerprint from a microbiome sample is generated and analyzed in real-time, wherein the fingerprint is continually updated, or updated in real-time. The sequence data is quantitatively assessed to provide real-time confidence of inferring the geographic origin of the microbiome sample. When the real-time confidence achieves a specified value or percentage, the real-time generation and analysis of the microbiome sample fingerprint is terminated.

These methods are illustrated in the Examples below, and while the methods are suitable for generating profiles of authentic products, as will be appreciated by the reader, in other embodiments, the method is used for generating a genetic or microbial profile of a suspect product, or a product having an unknown provenance. Generally, the profile of the suspect product is procured through following the same procedure used to generate the genetic or microbial profile for an authentic product against which the suspect product is compared, but this is not necessary in some applications, i.e., where the presence of only one or a few microbes is sufficient to distinguish the products, for example.

The Examples are organized so that methods for authenticating products are exemplified first (Example 1). Then, the methods are exemplified to illustrate how one can use them to determine whether products reached a destination by the same or different routes by generating microbiome profiles from the packaging of those products (Example 2). Use of these methods in combination to identify illegal networks for shipping counterfeit or other mislabeled products (and so to verify legal networks or authentic products) is then exemplified (Example 3). A final example shows how a database of information can be assembled and used to facilitate tracking and authentication of product movement and products worldwide, including by transoceanic shipping.

### Example 1 Authentication of Products

The first step in comparing the product profiles of the two brands is the generation of product reference profiles, which entails procuring the necessary products, sampling the microbes from the products, extracting the DNA from each microbial sample, and sequencing the DNA in each sample, and processing the raw sequence data to generate a microbial profile containing features (e.g., OTUs) present in each sample. In these examples, features are defined as operational taxonomic units [OTUs], but can be any representation of a biological entity obtained through nucleic acid analysis.

### Procurement and Sampling of Products

Consumer products were procured for testing to demonstrate that nearly identical products from different manufacturing facilities, transit routes, and manufacturers contain verifiably different genetic profiles. Goods were analyzed to establish (1) different microbiome profiles between different authentic brands of the same type of products; (2) different microbiome profiles between counterfeit and authentic versions of corresponding products (authentic profiles in this case are also defined as reference profiles); and (3) consistent microbiome signatures between individual SKUs of an authentic or counterfeit product. This testing thus illustrates how to generate product profiles with features sufficient to distinguish one brand of product from another brand or counterfeit version of the same type of product as well as how to do so with different lots or batches of the same branded (or counterfeit) product. This testing was done for illustrative purposes only and with limited resources and time. For application in actual test conditions, product profiling and feature selection can be a continuous process of refinement, giving the practitioner, as more data is collected from products of interest, the ability to make ever more informed distinctions between two products that would otherwise appear identical or very similar to one another.

The following products (goods) were procured and tested: cigarettes (Marlboro® and American Spirit®), printer cartridges (known counterfeit and authentic Hewlett-Packard®), earphones (known counterfeit and authentic Apple® EarPods™), surge protector plugs (known counterfeit and authentic Sollatek®), and drugs (suspected counterfeit and authentic Panadol® tablets). In addition, two highly counterfeited products were analyzed to demonstrate signature consistency between individual units of authentic goods (Claritin® tablets and Toyota® auto parts).

Microbiome samples were taken using different methods depending on the product type. All sampling activity was performed in a sterile laminar flow hood to avoid contamination. The following paragraphs describe the sampling methods used for the various products examined.

Cigarettes: six packs of Marlboro® “Reds” and six packs of American Spirit® regular filter cigarettes were sampled. Three packs of Marlboros and three packs of American Spirits were purchased at one store one month before the other three packs of Marlboros and three packs of American Spirits were purchased at a different store. Manufacturing codes on the Marlboros indicated the first three purchased were manufactured in a first factory on the 78th day of 2015 (“R078 Y58B3”) and the second three purchased were manufactured in a second factory on the 244th day of 2015 (“V244 Y51B3”). Manufacturing codes on the American Spirits also indicated manufacturing in different lots (“229156 02:09” and “183156 00:54”). For this product example, product profiles were generated from samples of the packaging as well as the tobacco inside each product sample. To sample the inside of cigarette packaging, packs were opened and interior foil wrappers containing the product were opened. Swabs (Copan Diagnostics Nylon-Flocked Dry Swabs) were dipped in sterile buffer (TekNova, 150 mM sodium chloride with 0.1% Tween-20) and rubbed inside the packaging for approximately 20 seconds before being placed back into sterile swab holders. To collect microbial samples of the tobacco inside each pack of cigarettes, tobacco was extracted from a single cigarette from each pack using forceps. Tobacco at the end of the cigarette was discarded. About 0.25 grams of tobacco from the interior of the cigarette was removed and placed into an Eppendorf tube with approximately 2 mL of buffer. Tubes were briefly vortexed and approximately 1.5 mL of supernatant was removed and placed into a clean Eppendorf tube with no solid debris.

Printer Cartridges: three authentic Hewlett-Packard® Laserjet 85A CE285A) and three counterfeit printer cartridges were procured through a supply chain investigation. The packaging was nearly indistinguishable but showed subtle differences that indicated counterfeit status. The printer cartridges were visually indistinguishable except for wear on the counterfeit cartridges that indicated unauthorized recycling of previously authentic cartridges. For this product example, product profiles were generated from samples of the packaging, the cartridges, and the ink inside the cartridges. To collect microbial samples of the interior of the product packaging, the interior of the product packaging was swabbed as described above. To collect microbial samples of the printer cartridges, the surface of the revolving drum was swabbed as described above. To collect microbial samples of the ink inside each cartridge, the ink from each cartridge was sampled by dipping a swab into the ink.

Earphones: Three authentic Apple® EarPods™ and three counterfeit EarPods earphones were procured through a supply chain investigation and sampled. The authentic and counterfeit EarPods™ were visually indistinguishable. For this product example, product profiles were generated from samples of the plastic product housing, or packaging, and the speakers inside the earphones. To collect microbial samples of the plastic product housing, the interior of the plastic product housing was swabbed as described above. To collect microbial samples of the speakers inside the earpieces, the earpieces were broken open, removing the speakers with forceps, cutting the wires, and placing the speakers in 5 mL of buffer in 50 mL conical vials and vortexing for 30 seconds. Approximately 2 mL of supernatant was removed and placed into a clean eppendorf tube with no solid debris.

Surge Protectors: Three authentic Sollatek® Voltshield™ Fridgeguard and three counterfeit surge protectors were procured through a supply chain investigation and sampled. The counterfeits were similar in appearance and packaging, but were visually distinguishable as counterfeits. For this product example, the product profiles were generated from samples of the surge protector circuit boards. To collect microbial samples of the circuit boards, the surge protector housing was opened by removing screws and the top cover. The front and back of the circuit boards were swabbed for sampling as described above.

Drugs: three packages of known authentic Panadol® tablets and three packages of suspected counterfeit Panadol® tablets were procured through a supply chain investigation. The suspect drug was not visually distinct from authentic drug but instead purchased from a known counterfeit distributor. For this product example, product profiles from the known authentic tablets were compared to microbial profiles of the suspected counterfeit tablets. To collect microbial samples from each product, One tablet from each of 6 packages of drug was quickly rinsed in approximately 500 μL of TE buffer (TekNova, 0.1 mM EDTA), and 2 μL of the rinse liquid was used as PCR template.

In addition, to demonstrate that multiple utilizable product signatures can be associated with a single product, product profiles were generated from both the pills and the packing cotton from three bottles of authentic Claritin® tablets. To collect the microbial samples from the pills. Approximately 5 mL of buffer were pipetted into the bottle, saturating and rinsing the pills. Approximately 2 mL of supernatant were removed and placed into a clean Eppendorf tube, with some dissolved pill debris. To collect the microbial samples from the packing cotton, Approximately 0.25 g of cotton from inside the bottle was placed inside a 5 mL Falcon™ tube with approximately 3.5 mL of buffer and rinsed. Approximately 2 mL of supernatant were removed and placed into a clean Eppendorf™ tube with no solid debris.

Auto Parts: The auto parts were Toyota® gaskets (part 90430-12031). Product profiles were generated for one set of three gaskets to demonstrate that auto parts carry a consistent and utilizable product profile. To collect microbial samples from gaskets, approximately 3 mL of buffer were pipetted into the previously sealed package and used to rinse the gaskets. Approximately 2 mL of supernatant were removed and placed into a clean Eppendorf tube.

All samples requiring DNA extraction were frozen on dry ice until extraction in order to preserve the microbial samples.

### DNA Extraction

Frozen samples were thawed at room temperature in a sterile laminar flow hood. DNA extraction was accomplished using the MoBio PowerSoil® DNA Isolation Kit, following manufacturer's instructions. The thawed samples were vortexed, and 1 ml of the sample was added to the PowerSoil Bead Tube, a microcentrifuge tube containing solid beads used to rupture cells. The MoBio Solution C1 (60 μl) was then added to lyse cells and stabilize DNA, and the tubes were shaken on a bead-beating machine for 10 minutes.

Tubes containing cell contents were then spun on a centrifuge at 10,000×g for 30 seconds at room temperature. This step moves solid, non-DNA materials to the bottom of the tube, while DNA stays suspended in the supernatant (liquid). The supernatant was then transferred to a clean 2 ml collection tube.

MoBio Solution C2 (250 μl) was then added to the collection tube. The tube was vortexed for an additional 5 seconds to resuspend any settled material remaining after the first steps, and the tube was incubated at 4° C. for 5 minutes. The tubes were then spun down at 10,000×g for 1 minute. 600 μg of the supernatant was then transferred to a new 2 ml collection tube, and then 200 μl of MoBio Solution C3 was added. The tube was incubated for an additional 5 minutes at 4° C., vortexed briefly, and then spun down again at 10,000×g for 1 minute. The supernatant (750 μl) was then pipetted into a clean collection tube and combined with 1200 μl of MoBio Solution C4 and vortexed for 5 seconds.

Approximately 675 μl of the vortexed supernatant was added to a MoBio Spin Filter and centrifuged at 10,000×g for 1 minute at room temperature. This was repeated in the same Spin Filter until the supernatant had all passed through the Spin Filter. 500 μl of MoBio Solution C5 was added and centrifuged at room temperature at 10,000×g for 30 seconds. The throughflow was discarded and the Spin Filter was spun again at 10,000×g for 1 minute.

The Spin Filter was then placed into a clean collection tube, and 100 μl of sterile DNA-free PCR-grade water was added to the center of the Spin Filter. The tube and Spin Filter were spun down at 10.000×g for 30 seconds. The Spin Filter was discarded, and the DNA suspended in the tube was used for PCR/amplicon sequencing.

### DNA Sequencing

For this illustrative demonstration, it was determined that the product profiles would be microbial profiles generated using amplicon sequencing of the Internal Transcribed Spacer 2 (ITS2) region and the 16S rDNA V4 region to generate the OTUs to be analyzed for selection of the features (the specific OTUs in) the product profile of the product for this illustrative test system. Other methods (e.g. metagenomics), other genetic regions, and other OTUs can be employed for these or other products in accordance with the general methods of the invention.

The ITS2 region (of the ribosomal RNA operon) of any fungal nucleic acid in any microbiome sample containing such nucleic acid can be amplified by PCR and sequenced following a protocol adapted from published methods (see Caporaso et al., Ultra-high-throughput microbial community analysis on the Illumina HiSeq and MiSeq Platforms, ISME Journal 2012; 6(8): 1621-4; and Human Microbiome Project, C. (2012), Structure, Function and Diversity of the Healthy Human Microbiome, Nature 486(7402): 207-214; and Human Microbiome Project, C. (2012). A Framework for Human Microbiome Research, Nature 486(7402): 215-221). The sequencing of the microbiome can be readily accomplished on the MiSeq platform (Illumina) using the 2×300 bp paired-end protocol (300 PE; see Caporaso et al., supra). Primers used for amplification and library preparation included the gene primers ITS3F (SEQ ID NO: 5) and ITS4R (SEQ ID NO: 6) (see White et al, Amplification and Direct Sequencing of Fungal Ribosomal RNA Genes for Phylogenetics, PCR Protocols: A Guide to Methods and Applications. Edited by Innis et al., NY: Academic Press Inc; 1990:315-322), adapters for MiSeq sequencing, and 12mer molecular barcodes used for amplification so that the PCR products can be pooled and sequenced directly.

The ITS2 region (of the ribosomal RNA operon) of any pollen nucleic acid in any microbiome sample containing such nucleic acid can be amplified by PCR and sequenced following a protocol adapted from published methods (see Chen S., Yao H., Han J., Liu C., Song J., Shi L., Zhu Y., Ma X., Gao T., Pang X. (2010) Validation of the ITS2 region as a novel DNA barcode for identifying medicinal plant species. PLoS ONE, 5, e8613). The sequencing of the microbiome can be readily accomplished on the MiSeq platform using the 300 PE protocol. Primers used for amplification and library preparation included the gene primers S2F (SEQ ID NO: 7) and ITS4R (SEQ ID NO: 6), adapters for MiSeq sequencing, and 12mer molecular barcodes used for amplification so that the PCR product can be pooled and sequenced directly.

Embodiments of the present invention further include concurrent PCR amplification of ITS fungal and pollen markers using three primers, namely ITS3F (SEQ ID NO: 5), ITS4R (SEQ ID NO: 6, and S2F (SEQ ID NO: 7). The sequencing of the microbiome can be readily accomplished on the MiSeq platform using one or more of the protocols described here. It is also possible to amplify three markers (bacterial 16S, fungal ITS and pollen ITS) in the same PCR reaction, yielding 3 distinct amplicon types that can be sequenced and analyzed simultaneously. The combination of these three markers, whether compiled into OTUs or some other form or simply used in the form of raw sequence data, creates unique features that result in highly informative product profiles, reference profiles and test profiles.

The 16S rDNA V4 region was also amplified by PCR and sequenced on the MiSeq platform, but a 2×250 bp paired-end protocol (250 PE) was used, yielding pair-end reads intended to overlap almost completely. The primers used for amplification were the gene primers (515F (SEQ ID NO: 8) and 806R (SEQ ID NO: 9)), adapters for MiSeq sequencing, and 12mer molecular barcodes. The final 16S and ITS libraries were sequenced on the Illumina MiSeq platform (250 PE and 300 PE, respectively).

### Raw Data Processing to Generate a Microbial Profile

Processing of raw sequence data to generate OTUs was done using standard methods which can include quality filtering (removing low-quality DNA sequences based on quality scores associated with each sequence), library splitting (assigning DNA sequences to specific samples using sample specific barcodes associated with each sequence), and clustering of sequences into operational taxonomic units. Any variety of data transformation and filtering steps may be used to curate the microbial profiles following these standard steps listed above. For example, when laboratory contamination is present and represented by OTUs, contaminant OTUs can be detected and removed before further analysis. The following steps describe the raw data processing that was done to generate microbial profiles for each product in the examples.

Raw DNA sequences were quality filtered, split into libraries, and clustered into OTUs using the QIIME version 1.9 pipeline (Nature Methods 7, 335-336 (1 May 2010), http://qiime.org/index.html). DNA sequences were assigned to microbial profiles using the sample-specific barcode associated with each DNA sequence. Sequences with a phred quality score less than 20 were discarded. A phred score is a standard measure of the quality of the identification of nucleotides within each DNA sequence.

An operational taxonomic unit (OTU) is a commonly used concept in genetic analysis, and it refers to a grouping of highly similar DNA sequences OTUs were clustered from quality-filtered reads using the open-reference OTU picking method (see Rideout et al. 2014, Subsampled open-reference clustering creates consistent, comprehensive OTU definitions and scales to billions of sequences. PeerJ 2:e545) to delineate 97% similarity. 97% is a very commonly used threshold for bacterial and fungal rRNA sequence similarity that, for some organisms within each group, approximately equates to the species or genus taxonomic level. The OTUs were clustered against the GreenGenes bacterial database or the UNITE fungal database (for 16S and ITS sequences, respectively), and taxonomic assignments were also derived from these databases. The result of OTU picking is a data matrix of samples (i.e., microbial profiles) x OTUs, with sequence abundance for each OTU. A single microbial profile can contain from 1 to an infinite number of OTUs, and each OTU within a microbial profile can contain from 1 to an infinite number of occurrences (each occurrence denotes the presence of a single DNA sequence within the OTU). All subsequent analysis and visualization is conducted in R, which is an open-source statistical computing environment that is commonly used for complex statistical analyses.

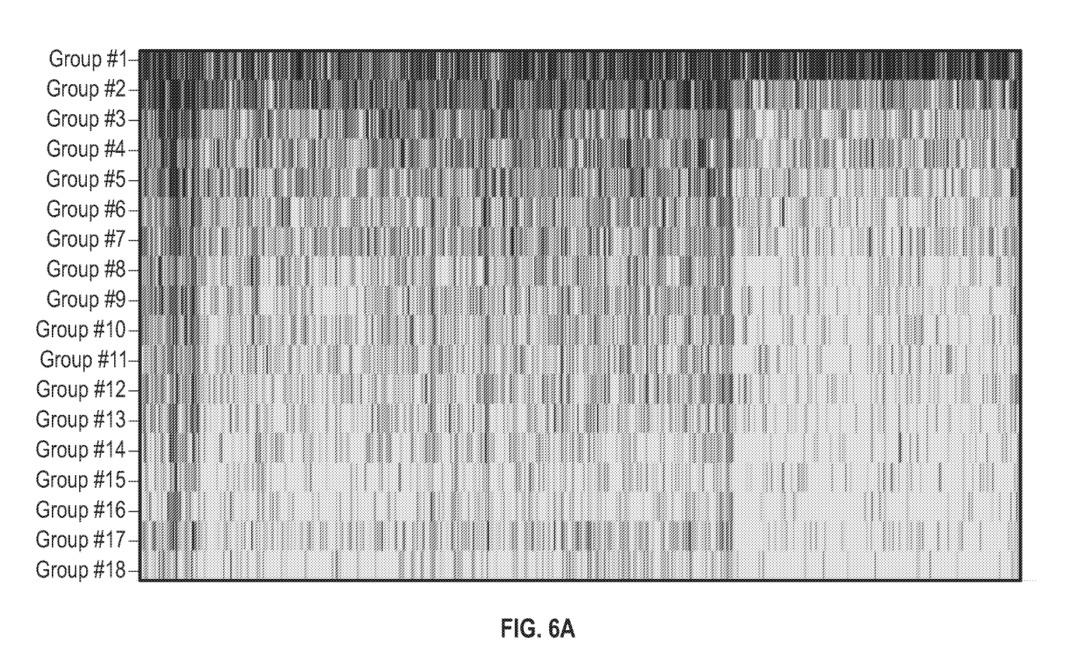

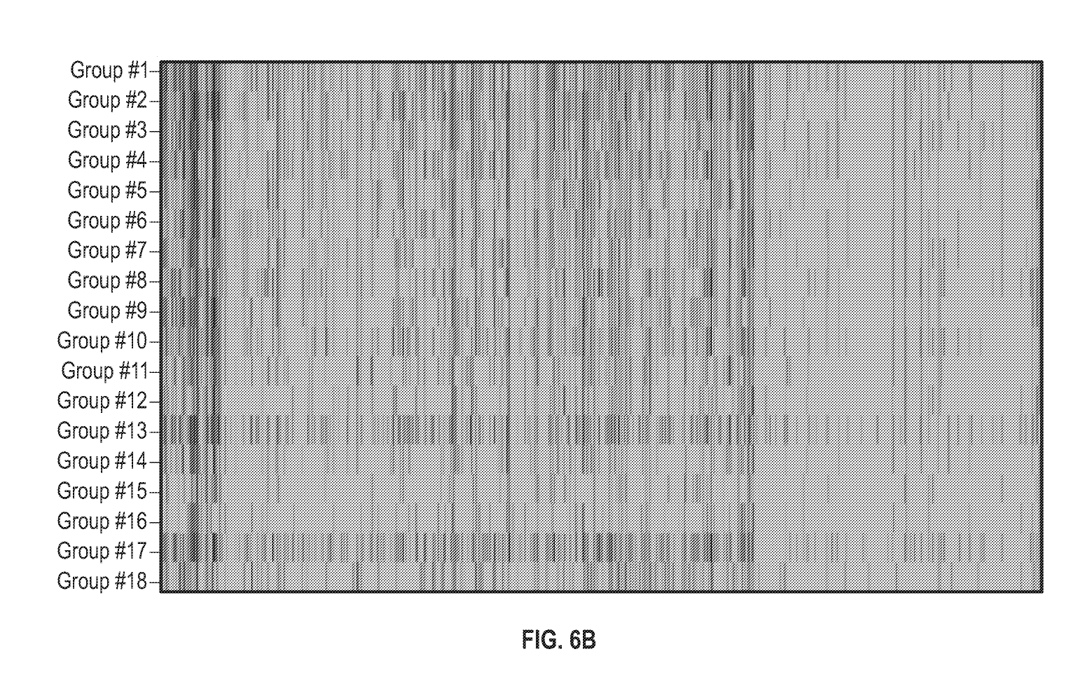

In accordance with the invention, data analysis can include a step to remove OTUs resulting from contamination, and in this illustrative test system, OTUs that were found in laboratory reagent blank samples were removed from all of the microbial profiles under consideration, including both counterfeit and authentic products. As an illustrative example, FIGS. 6A and 6B show contamination in an example set of microbial profiles (each profile is a numbered “Group” along the y-axis and the same 18 microbial profiles are shown in FIG. 6A and again in FIG. 6B. Each column is a single OTU, and the presence of a single thin vertical black line in a column in the matrix denotes the presence of a single OTU in a microbial profile. The absence of a thin vertical black line at any position in the matrix denotes that the particular OTU at that position was absent in the microbial profile. FIG. 6A shows all OTUs present for each of the groups prior to contamination detection. The last three microbial profiles in each figure (Groups #16-18) were blank laboratory controls without DNA template added, and thus the presence of an OTU in each of these 3 samples reveals the presence of at least 1 contaminant DNA sequence. Note that the microbial profiles are arranged so that the total number of OTUs present is the highest for the top microbial profile (Group #1) and declines down the y-axis. FIG. 6B shows the same layout of microbial profiles and OTUs, but the OTUs that were not present in the blank laboratory control samples have been removed, leaving only the OTUs that did occur in the blank laboratory control samples. This illustrates that laboratory contamination might be present in any microbial profile in a given set of microbial profiles, and can have variable importance in the downstream analysis. For example, the microbial profile on the very top of both figures (Group #1) contains many OTUs that were not detected as contaminants, while Group #13 is primarily composed of contaminant OTUs. Those of skill in the art will appreciate, upon contemplation of this disclosure, that the removal of contaminant OTUs is a crucial step in some cases, including for the example microbial profiles shown in FIGS. 6A and 6B, while it may not be necessary to remove contamination from other microbial profiles if contamination is not present or present at a very low level.

Assessment of Variability within and Across Groups of Product Profiles

As with any data analysis undertaking, intermediate steps are required to assess the level of variability within a group of product profiles, as well as assess the variability between separate groups of product profiles. This can include, but is not limited to the following: construct a matrix of pairwise similarities for product profiles, cluster analysis, significance testing, and visualization. These steps were taken in the illustrative examples as follows.

Pairwise similarity: A pairwise similarity matrix was constructed from all samples being compared to one another. In doing so, each individual microbial profile is compared to every other microbial profile to assess relative numbers of OTUs shared among microbial profiles as well as the differences in abundance of OTUs among all microbial profiles. The result is a triangular data matrix of pairwise similarity values, which can then be used for further assessment and visualization steps. In the current illustrative example, this was done using the Steinhaus similarity metric, which is one of the many applicable metrics for comparing microbiome communities. The Steinhaus metric calculates the number of shared OTUs between samples. The similarity matrix was used in the subsequent clustering and visualization steps to further assess variability.

Clustering and significance: A cluster dendrogram of microbial profiles is a tool to visualize the relationships among a group of microbial profiles. In this illustrative example, cluster dendrograms were constructed for each set of products listed above to assess whether, for example, two brands of cigarettes cluster into separate groups prior to feature selection and further analysis. This “unsupervised” discrimination method helps the operator gauge the extent of further analysis required to curate a final, usable product profile. Some products with drastically different microbial profiles will naturally cluster into separate groups, while other products with microbial profiles that differ only slightly will require extensive feature selection for a usable product profile to emerge. In some cases, where reference (or authentic) products were manufactured in different facilities, or with different manufacturing methods, or with different raw materials, this clustering step will reveal that the multiple distinct groups of reference samples carry multiple distinct microbial profiles related to their provenance. In such cases, the clustering dendrogram can allow the operator to carry out specialized feature selection steps to generate a product profile that comprehensively captures the variability embodied in the different groups of reference products. Cluster analysis is not required in the present invention, but can be a useful tool to help the operator carry out feature selection and authentication. In this illustrative example, the similarity matrix created above was used to derive a cluster dendrogram, using Ward's hierarchical clustering method. Ward's hierarchical clustering method is one of many appropriate methods for constructing a cluster dendrogram. Those of skill in the art will appreciate, upon contemplation of this disclosure that the method chosen for cluster analysis will vary depending on the microbial profiles being considered.

When clustering patterns emerge in the cluster dendrogram, an operator may choose to carry out a significance test to determine whether the pattern is reliable. Significance testing is not required in the present invention, but can be a useful tool to help the operator carry out feature selection and authentication. Many potential standard significance tests are available for this process. The significance of the clustering solution was then tested with Permutational Multivariate Analysis of Variance (PERMANOVA). Those of skill in the art will appreciate, upon contemplation of this disclosure, that the method chosen for significance testing will vary depending on the microbial profiles being considered.

Visualization: In addition to cluster analysis, any of a variety of multivariate visualization tools can be used to assess emergent patterns within and among the microbial profiles being compared. One such useful tool is ordination. Ordination is a visualization of the pairwise relationships among microbial profiles, or among any group samples containing multivariate data. Any variety of ordination techniques can be applied to microbial profiles to assess their variability. Those with skill in the art will appreciate, upon contemplation of this disclosure that the method chosen for ordination will vary depending on the microbial profiles being considered. In the illustrative examples, Non-metric Multi-Dimensional Scaling was used to visualize the relationships among microbial profiles as a way to assess the variability within groups of reference product samples.

### Selection of Features (Also Referred to as Fingerprinting) and Comparison of Microbial Profiles:

After microbial profiles are generated for each individual sample within a group (for example a replicate set of reference samples), the statistically characteristic authenticating features are selected using a feature selection process. The feature selection process within the present invention can be compared to indicator analysis, from the field of ecology, where an individual species or other taxon ranked for statistical affinity to a given habitat or other sample group by deriving an indicator value for each taxon (Dufrêne and Legendre 1997, Ecological Monographs 67 (3), 345-366). The feature selection process in the present invention extends the utility of this method for better applicability to nucleotide-derived biological data, and adds a comparison step to determine whether test samples conclusively match reference genetic profiles.

This flexible feature selection process ranks and categorizes each individual feature (or OTU in these illustrative examples) present in the group of microbial profiles based on a series of predetermined cutoff criteria, including, but not limited to, the number of occurrences of the OTU within a set of samples, the number of nucleotide sequences representing the OTU in each of the reference samples (also known as OTU abundance), and the relative abundance of the OTU compared to all other OTUs combined within each reference sample. This feature selection process is explained in Equation 1. Those with skill in the art will appreciate, upon contemplation of this disclosure that either one or any number of these predetermined cutoff criteria will be used to select the features appropriate for a given set of reference samples. The following paragraphs detail the feature selection process as it was applied in the illustrative examples.

The group of microbial profiles within each illustrative example was tested OTU table was tested for the existence of statistically characteristic authenticating features by applying a set of predetermined cutoff criteria. Those OTUs that met the cutoff criteria were included in an OTU subset, which can be viewed as a collection of potential features for the product profile, and the clustering and significance was tested again on the microbial profiles containing the selected features as an additional quality control and variability assessment measure. Examples of cutoff criteria include, but are not limited to, the following: 1) an OTU must be represented by at least 10 or some greater number of DNA (nucleic acid) sequence reads across the microbial profile; 2) the reads representing an OTU must comprise at least 0.001% or some higher percentage of the entire microbial profile when it does occur; 3) the OTU must occur in at least 50% of the samples within the reference set; and 4) in cases where the reference set is being compared to one or more opposing reference set of known counterfeit products in order to improve the specificity of the feature selection process, for example, the OTU must be, on average, 10 (or some other number) times more abundant in the reference set of samples compared to one or more of the other opposing sets, although again, the percentages can vary and don't have to be the same for the different sets, which can be more than 2 as well. In these example cutoff criteria, a set of reference samples can be known authentic samples, suspect counterfeit samples, known counterfeit samples, or replicates of unknown samples from the same source. The above cutoff criteria are listed to exemplify a range of cutoff criteria that can be used in the feature selection process in the present invention. Those of skill in the art will appreciate, upon contemplation of this disclosure, that the specific predetermined cutoff criteria used when employing the present invention will vary based on the type of product being tested, the variability among microbial profiles from reference samples, and the specific test (authenticity or transit history inference, as two examples of tests) being conducted. The cutoff criteria used in the test systems described here are described in the following results section on a product-by-product basis.

Prior to the feature selection process, the complete set of features in a given sample (OTUs in these illustrative examples) are collectively referred to as the microbial profile for each sample. However, after the feature selection process, the complete set of statistically characteristic authenticating features that were selected using the process above are now referred to as a reference microbial signature. The reference microbial signature is used as a product profile for comparison against other sets of test samples (for example, to authenticate test products, or to determine the transit history of a test product).

### Comparing Reference and Test Signatures

After the most statistically characteristic authenticating features are selected using a feature selection process, the reference microbial signatures can be used to authenticate or infer other information about a test sample or group of test samples. In the illustrative examples below, the reference signatures are compared to a group of test samples.

The comparison follows a series of tests detailed in Equations 2, 3, & 4. A new set of predetermined cutoff criteria are selected, and the microbial profiles of test samples are passed through these cutoff criteria in order to either authenticate or infer any other information about the test samples as compared to the reference product profiles. In some criteria, the cumulative collection of OTUs is considered, while in other criteria, each OTU is considered individually. Examples of predetermined cutoff criteria that could be used to determine, for example, that a test sample was authentic, include, but are not limited to, the following: 1) an OTU must be present (i.e., is in the sample and detected, e.g. by a sequence read) in more than 50% of the set of test profiles, although again, the percentages can vary; 2) the cumulative abundance of the set of statistically characteristic OTUs present in each test sample must exceed 90% of the total abundance (or some other percentage). The above cutoff criteria are listed to exemplify a range of cutoff criteria that can be used in the comparison process in the present invention. Those of skill in the art will appreciate, upon contemplation of this disclosure, that the specific predetermined cutoff criteria used when employing the present invention will vary based on the type of product being tested, the variability among microbial profiles from reference and test samples, and the specific test (authenticity or transit history inference, as two examples of tests) being conducted. The cutoff criteria used in the test systems described here are described in the following results section on a product-by-product basis.

### Results—Compilation and Comparison of Product Profiles

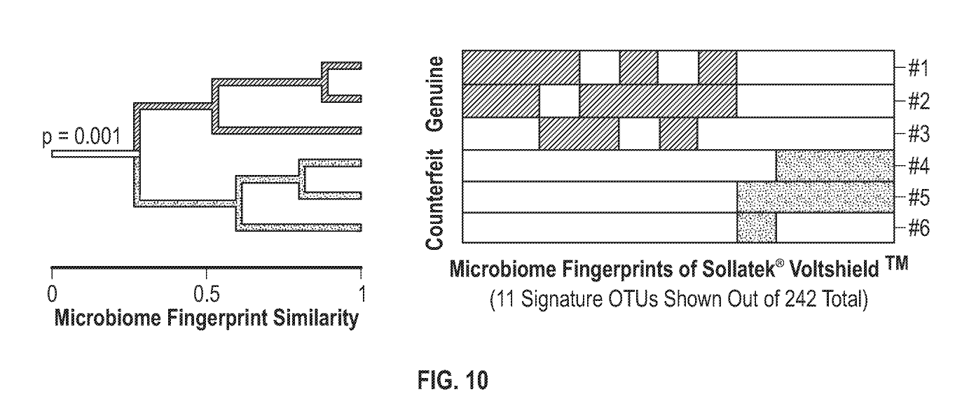

Cigarettes. In this simple illustration, the power of the present methodology is apparent. Product profiles could be generated from the signatures derived from both the packaging and tobacco itself, as these were significantly different between brands, and were highly consistent within brands. As shown in FIGS. 7(a) and 10, the signatures within a brand were highly consistent when analyzed using both bacterial 16S and fungal ITS derived OTUs, indicating that the products can be profiled in and analyzed in accordance with the invention using either target region. As shown in FIG. 7(b), all six Marlboro® packages and all six American Spirit® packages showed high similarity within their respective brands, even when samples were purchased in two different stores one month apart and from different manufacturing lots.

Authentic reference profiles were derived for both brands of cigarettes (Marlboro® and American Spirit®) using two predetermined cutoff thresholds: 1) OTUs in the reference profiles occurred in more than 50% of reference samples (occurrence ranged from 50% to 100% for both Marlboro® and American Spirit® brands); and 2) each reference OTU was represented by more than a single sequence read (which can be either identical or different) in at least one of the reference product samples (sequence read abundance for each OTU ranged from 1 to more than 1000 for both Marlboro® and American Spirit® brands). When these reference profiles were used to authenticate suspect cigarette samples, two predetermined matching criteria were applied: 1) more than 50% of OTUs in the reference profiles had to occur in the suspect product sample (the percent of reference profile OTUs present in authentic cigarette samples ranged from 63% to 81% for Marlboro® and 63% to 88% for American Spirit®); and 2) the cumulative relative abundance of all reference OTUs occurring in a suspect profile had to exceed 3% of the total relative abundance of all OTUs (cumulative relative abundance ranged from 5.6% to 22% for Marlboro® and 4% to 8.4% for American Spirit®).

FIG. 7(a) shows a hierarchical clustering dendrogram that clearly distinguishes among samples of the two cigarette brands (Marlboro® Red, Brand 2=American Spirit® Regular, p=0.0013, PERMONOVA on the pairwise Steinhaus similarity matrix). The x-axis (Microbiome Fingerprint Similarity) is a measure of the relatedness of each sample or group of samples. The more deeply diverged each sample is from another on the dendrogram, the greater the difference between their microbiome fingerprints. The heatmap on the right shows the presence/absence of 508 OTUs most indicative of either brand using bacterial 16S rRNA sequences. Each OTU is represented by a single thin vertical line. For example, an OTU that is present in a Marlboro sample is represented by a single thin gray vertical line, while an OTU that is absent in a Marlboro sample is represented by a single thin vertical white space. Note that approximately the leftmost ⅓ of the 508 OTUs are generally present in Marlboro samples but generally absent in American Spirit samples, while the rightmost ⅔ of the 508 OTUs are generally present in American Spirit samples, but generally absent in Marlboro samples. The total number of OTUs in the dataset (2352) was reduced to the most statistically indicative OTUs (508) using two predetermined cutoff thresholds: 1) OTUs in the reference profiles occurred in at least 2 of the 3 samples in one brand, while occurring in less than 2 of the 3 samples in the other brand; and 2) each OTU was represented by more than a single sequence in at least one of the product samples. The ability to distinguish between two goods of the same type, including counterfeit vs authentic and one brand vs a different brand is a representative embodiment of the present invention. FIG. 7(b) shows a hierarchical clustering dendrogram that clearly distinguishes among 12 packs of cigarettes purchased in different stores and manufactured in different factories on different dates (p=0.0013, PERMONOVA on the pairwise Steinhaus similarity matrix; see Example 4 for more details). The heatmap shows the presence/absence of 190 OTUs most indicative of each brand using bacterial 16S rRNA sequences. Manufacturing codes for the two brands are shown at the tips of the clustering dendrogram. The Marlboro manufacturing codes indicate that the first three purchased were manufactured in a first factory on the 78th day of 2015 (“R078 Y58B3”) and the second three purchased were manufactured in a second factory on the 244th day of 2015 (“V244 Y51B3”). Manufacturing codes on the American Spirits also indicated manufacturing in different lots (“229156 02:09” and “183156 00:54”). FIG. 7(c) shows a hierarchical clustering dendrogram that clearly distinguishes among samples of the two cigarette brands using fungal DNA signatures (p=0.001, PERMONOVA on the pairwise Steinhaus similarity matrix). The heatmap shows the presence/absence of 153 OTUs most indicative of each brand using fungal ITS sequences. The ability to distinguish between two goods of the same type, including counterfeit vs authentic and one brand vs a different brand is a representative embodiment of the present invention.

Representative 16S PCR products mapping to OTUs that were found in Marlboro® but not American Spirit® were from Oceanobacillus sp. (possibly Oceanobacillus profundus, SEQ ID NO: 10), Staphylococcus sp. (possibly Staphylococcus equorum, SEQ ID NO: 11), Paenochrobactrum sp. (possibly Paenochrobactrum glaciei, SEQ ID NO: 12), Pseudomonas sp. (possibly Pseudomonas fragi. SEQ ID NO: 13), and Lactobacillus sp. (possibly Lactobacillus acidipiscis, SEQ ID NO: 14). Representative 16S PCR products indicating OTUs that were found in American Spirit® but not Marlboro® were from Acinetobacter sp. (possibly Acinetobacter guillouiae. SEQ ID NO: 15), Caulobacter sp. (possibly Caulobacter crescentus, SEQ ID NO: 16), Sphingomonas sp. (possibly Sphingomonas taxi, SEQ ID NO: 17), Achromobacter sp. (possibly Achromobacter xylosoxidans, SEQ ID NO: 18), and Methylobacterium sp. (possibly Methylobacterium radiotolerans, SEQ ID NO: 19).

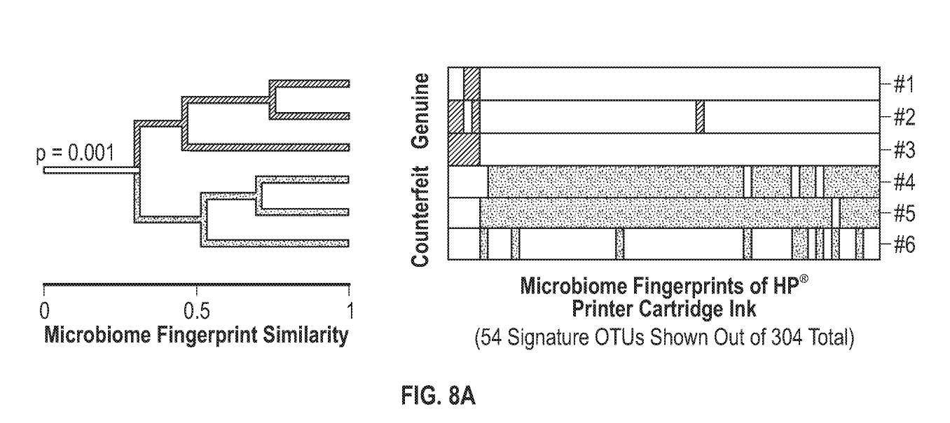

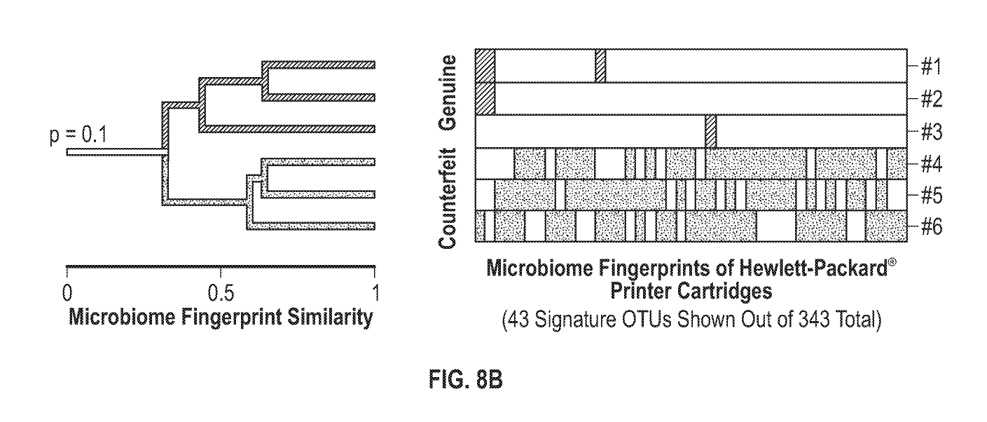

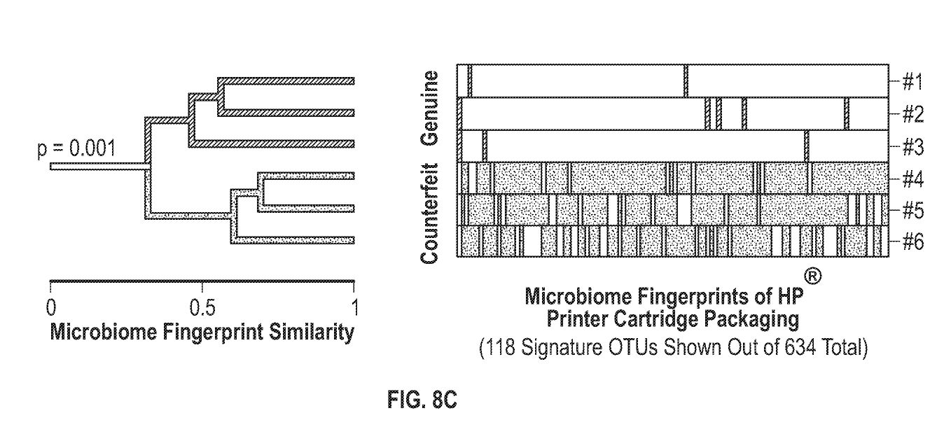

HP printer cartridges. Signatures derivable from the packaging, revolving drum, and ink were highly similar among authentic products and among counterfeit products, and were significantly different between the authentic and counterfeit products (FIG. 8(a-c)). Thus, using the present invention, the nearly identical counterfeit printer cartridges were successfully detected.

FIG. 8(a) shows a hierarchical clustering dendrogram that clearly distinguishes between ink from authentic and counterfeit Hewlett-Packard® printer cartridges (p=0.001, PERMONOVA on the pairwise Steinhaus similarity matrix). The heatmap shows the presence/absence of 54 OTUs most indicative of each group using bacterial 16S rRNA sequences. FIG. 8(b) shows a hierarchical clustering dendrogram that clearly distinguishes between revolving drums from authentic and counterfeit Hewlett-Packard® printer cartridges [samples of revolving drums from both authentic and counterfeit printer cartridges (p=0.1. PERMONOVA on the pairwise Steinhaus similarity matrix). The heatmap shows the presence/absence of 43 OTUs most indicative of each group using bacterial 16S rRNA sequences. FIG. 8(c) shows a hierarchical clustering dendrogram that clearly distinguishes between interior packaging from authentic and counterfeit Hewlett-Packard® printer cartridges [samples of the packaging from both authentic and counterfeit printer cartridges (p=0.001, PERMONOVA on the pairwise Steinhaus similarity matrix). The heatmap shows the presence/absence of 118 OTUs most indicative of each group using bacterial 16S rRNA sequences. It is an object of the invention to provide methods of tracking and authentication methods that do not require changes to manufacturing processes, are applicable to all manufactured goods, and are extremely difficult or impossible for counterfeiters to copy.

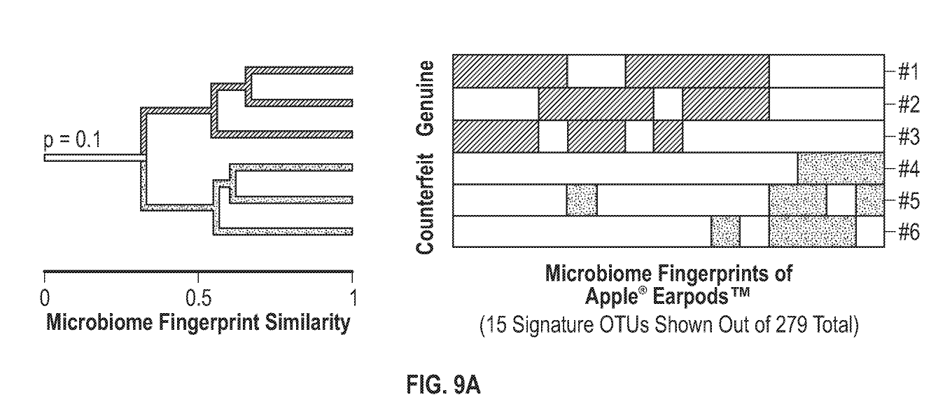

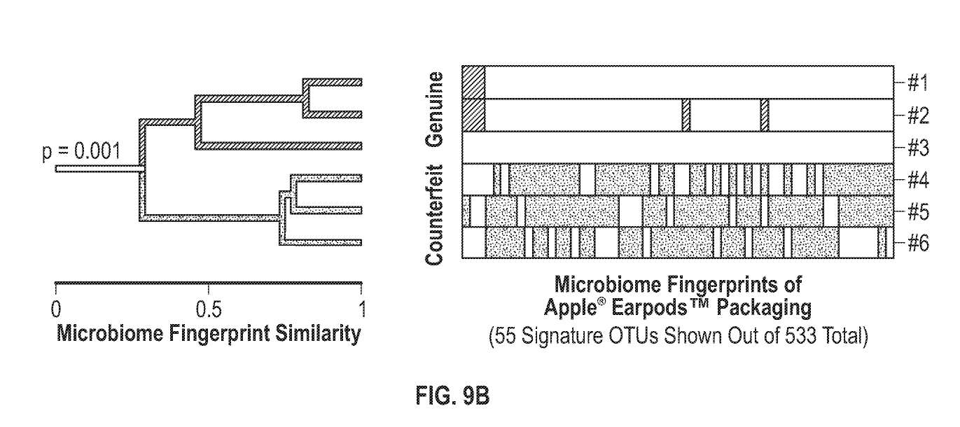

Earpods™. Signatures from the plastic housing and internal electronics were highly similar among authentic products and among counterfeit products, and were significantly different between the authentic and counterfeit products (FIG. 9(a-b)). Thus, using the present invention, the nearly identical counterfeit earphones were successfully detected.

FIG. 9(a) shows a hierarchical clustering dendrogram that clearly distinguishes between interior electronic components of authentic and counterfeit Apple® EarPods™ (p=0.1, PERMONOVA on the pairwise Steinhaus similarity matrix). The heatmap shows the presence/absence of 15 OTUs most indicative of each group using bacterial 16S rRNA sequences. FIG. 9(b) shows a hierarchical clustering dendrogram that clearly distinguishes between plastic packaging housing for authentic and counterfeit Apple® EarPods™ (p=0.001, PERMONOVA on the pairwise Steinhaus similarity matrix). The heatmap shows the presence/absence of 55 OTUs most indicative of each group using bacterial 16S rRNA sequences.

Surge protectors. Signatures from the circuit boards were highly similar among authentic products and among counterfeit products, and were significantly different between the authentic and counterfeit products (FIG. 10). Thus, using the present invention, the nearly identical counterfeit surge protectors were successfully detected.

FIG. 10 shows a hierarchical clustering dendrogram that clearly distinguishes between circuit boards of authentic and counterfeit Sollatek® Voltshield™ surge protectors (p=0.001, PERMONOVA on the pairwise Steinhaus similarity matrix). The heatmap shows the presence/absence of 11 OTUs most indicative of each group using bacterial 16S rRNA sequences.

Representative 16S PCR products indicating OTUs that were found in authentic surge protectors but not counterfeit were from Luteimonas sp. (possibly Luteimonas huabeiensis, SEQ ID NO: 20), Lactobacillus sp. (possibly Lactobacillus animalis, SEQ ID NO: 21), Sphingomonas sp. (possibly Sphingomonas echinoides, SEQ ID NO: 22), Streptococcus sp. (possibly Streptococcus mitis, SEQ ID NO: 23), and Paracoccus sp. (possibly Paracoccus denitrificans, SEQ ID NO: 24).

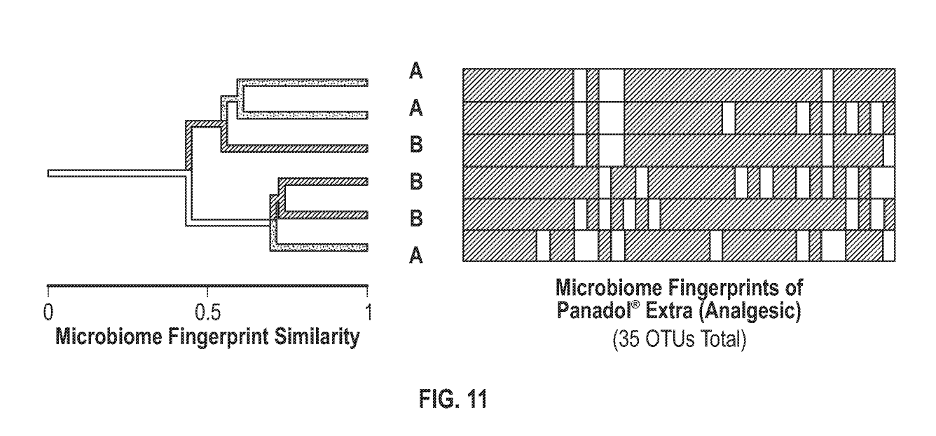

Panadol® Tablets. Authentic profiles were derived for the known authentic Panadol® tablets using two predetermined cutoff thresholds: 1) OTUs in reference profiles occurred in more than 50% of representative samples (occurrence ranged from 67% to 100%); and 2) each reference OTU was represented by more than a single sequence in at least one of the reference product samples (sequence representation ranged from 1 to more than 600). When these reference profiles were used to authenticate suspect Panadol® samples, two predetermined matching criteria were applied: 1) more than 50% of the OTUs in the reference profiles had to occur in the suspect product sample (the percent of reference profile OTUs present in suspect Panadol® samples ranged from 53% to 71%); and 2) the cumulative relative abundance of all reference OTUs occurring in a suspect profile had to exceed 60% of the total relative abundance of all OTUs (cumulative relative abundance ranged from 67% to 96% for suspect Panadol® samples). Signatures from the two sets of samples (known authentic and suspected counterfeit) were statistically indistinguishable. As shown in FIG. 11, the signatures of known authentic Panadol® samples (marked “A” in FIG. 11), and of suspected counterfeit samples (marked “B”) were highly consistent across the two sets. The heatmap shown in FIG. 11 shows consistency in the presence/absence of the 35 most abundant OTUs across all samples, thus, using the present invention, demonstrating the suspected counterfeit samples to in fact be authentic.

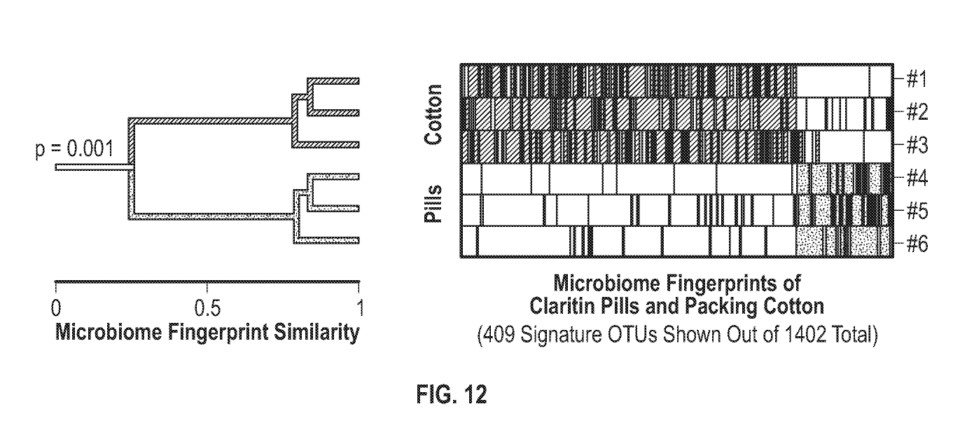

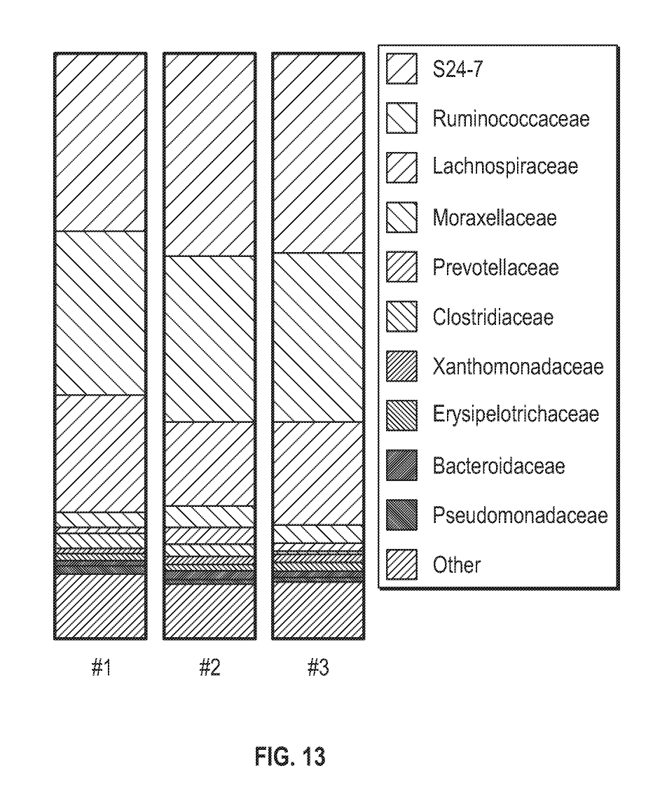

Claritin® tablets. Signatures from both the cotton packaging and tablets were highly consistent within each sample type and were significantly different between each other (FIG. 12). Authentic reference profiles were derived for both Claritin tablets and cotton using two predetermined cutoff thresholds: 1) OTUs in the reference profiles occurred in more than 50% of representative samples (occurrence ranged from 66% to 100% for both pills and cotton); and 2) each reference OTU was represented by more than a single sequence in at least one of the reference product samples (sequence representation ranged from 1 to more than 20,000 for both pills and cotton). These reference profiles can both be used to authenticate suspect Claritin products using two predetermined matching criteria: 1) more than 60% of OTUs in the reference profiles must occur in the suspect product sample (the percent of reference profile OTUs present in reference samples ranged from 79% to 89% for pills and 69% to 87% for cotton); and 2) the cumulative relative abundance of all reference OTUs occurring in a suspect profile had to exceed 40% of the total relative abundance of all OTUs (cumulative relative abundance ranged from 82% to 88% for pills and 40% to 89% for cotton).

FIG. 12 shows consistent signatures among replicates of authentic Claritin® and among replicates of packing cotton, and distinguishes between cotton and pills to demonstrate that we can distinguish between different parts of the same product.

Thus this example demonstrates that a single bottle of pills contains multiple separate microbial profiles (e.g., tablets and packing cotton) that can be utilized, using the present invention, to detect counterfeit pharmaceuticals.

Representative 16S PCR products indicating OTUs that were found in Claritin tablets but not cotton packaging were from Enterococcus sp. (possibly Enterococcus cecorum (SEQ ID NO: 25)), Meiothermus sp. (possibly Meiothermus silvanus (SEQ ID NO: 26)), Anoxybacillus sp. (possibly Anoxybacillus tepidamans (SEQ ID NO: 27)), Bacillus sp. (possibly Bacillus pumilus (SEQ ID NO: 28)), and Klebsiella sp. (possibly Klebsiella quasipneumoniae (SEQ ID NO: 29)). Representative 16S PCR products indicating OTUs that were found in cotton but not pills were from Corynebacterium sp. (possibly Corynebacterium halotolerans (SEQ ID NO: 30)), Lactobacillus sp. (possibly Lactobacillus hominus (SEQ ID NO: 31)), Comamonas sp. (possibly Comamonas testosterone (SEQ ID NO: 32)), Lactobacillus sp. (possibly Lactobacillus rogasae (SEQ ID NO: 33)), and Corynebacterium sp. (possibly Corynebacterium tuberculostearicum (SEQ ID NO: 34)).

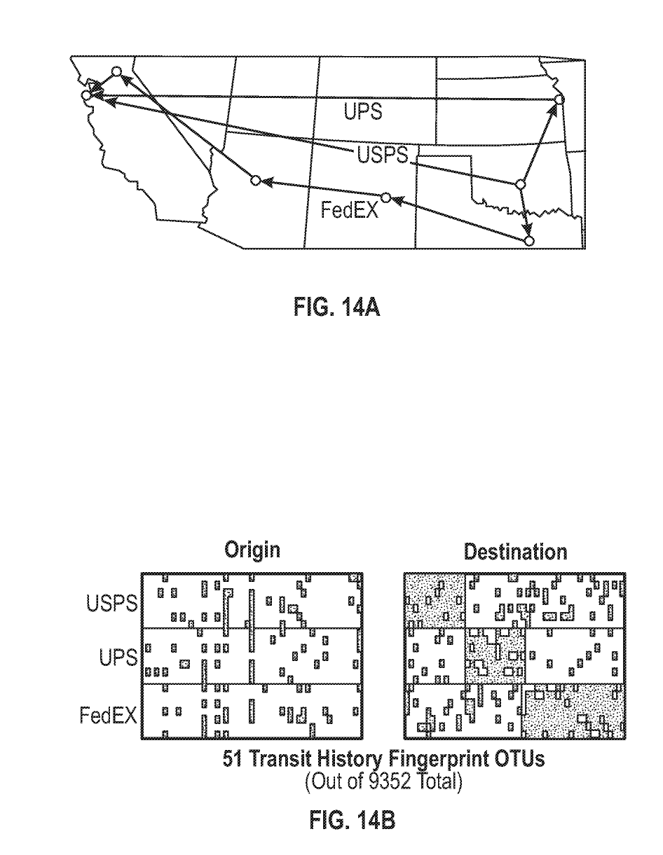

Gaskets. Signatures from gaskets were highly consistent across the three replicate samples (FIG. 13). Authentic reference profiles were derived for Toyota gaskets using two predetermined cutoff thresholds: 1) OTUs in reference profiles occurred in 100% of representative samples; and 2) each reference OTU was represented by more than 1000 sequences in at least one of the reference samples.

FIG. 13 shows consistent signatures between replicates of authentic Toyota® gaskets. Each vertical bar chart shows the 10 most abundant bacterial OTU families found in each sample, and all 10 were consistently found in every replicate sample. Additionally, all of the top 16 most abundant bacterial families were found in all three replicates, and 29 out of the 30 most abundant bacterial families were found in at least ⅔ samples.

Representative 16S PCR products indicating OTUs that were found in gaskets were from Barnseliella sp. (possibly Barnesiella intestinihominis (SEQ ID NO: 31)), Robinsoniella sp. (possibly Robinsoniella peoriensis (SEQ ID NO: 32)), Parasporobacterium sp. (possibly Parasporobacterium paucivorans (SEQ ID NO: 33)), Oscillibacter sp. (possibly Oscillibacter ruminantium (SEQ ID NO: 34)), and Clostridium sp. (possibly Clostridium oroticum (SEQ ID NO: 35)).

### Example 2 Tracking Product Movement Via Packaging Profiles

In this example, we demonstrate the use of the inventive technology to distinguish among identical packages (in this model test system, boxes) shipped through different transit networks. This example demonstrates how the methods of the invention can be used to infer information regarding transit networks. In a broad overview, boxes were prepared and shipped along different routes and reference profiles were established using the methods of the invention for the unshipped boxes (these can be viewed as product profiles of the box as a product or as a packaging profile of an unshipped product, were there actually a product in the box in this model system) and for boxes shipped on each different shipping rout (these can be viewed as packaging profiles of goods in or post-transit). These profiles or genetic signatures are then compared and contrasted to illuminate advantages of the invention in inferring whether a product in commerce has been shipped along a particular network, or not.

Twenty-one identical cardboard boxes (9″×9″×9″) were purchased together from an office supply store in Norman, Okla., and assembled the same day using 2 strips of tape for each box from a single, new roll of packing tape. The assembler wore sterile nitrile gloves throughout the assembly process.

Nucleic acid samples were collected from the exterior of the assembled boxes as a “pre-transit” control for each box. The entire exterior surface of each box was sampled using a dry swab (Copan Diagnostics Nylon-Flocked Dry Swabs). One swab was used for each box. All used swabs were returned to their original sterile packaging and frozen at −20 degrees C. until processing.

Three different shipping carriers (United Parcel Service [UPS], Federal Express [FedEx], and the United States Postal Service [USPS]) were engaged to send boxes to an address in San Francisco, Calif. Sets of seven of the 21 boxes were randomly selected and shipped via each carrier. All boxes were shipped within three hours of purchase.

Shipping routes for all 21 boxes were monitored using individual tracking numbers. Tracking data indicated that the three carriers were routed through three geographically and temporally distinct routes, and that all 7 boxes within each carrier were handled simultaneously and shipped through the same 3 routes.

The shipping route for all 7 boxes handled by UPS was as follows: 1) ground transport from Norman, Okla., to Oklahoma City, Okla.; 2) ground transport to Lenexa, Kans.; 3) ground transport to San Pablo, Calif.; 4) ground transport to San Francisco, Calif.; and 5) ground transport to destination in San Francisco, Calif. All 7 boxes were delivered 7 days after they were shipped.

The shipping route for all 7 boxes handled by USPS was as follows: 1) ground transport from Norman, Okla., to Oklahoma City, Okla.; 2) air transport to San Francisco, Calif.; 3) ground transport to destination in San Francisco, Calif. All 7 boxes were delivered 3 days after they were shipped.

The shipping route for all 7 boxes handled by FedEx was as follows: 1) ground transport to Oklahoma City, Okla.: 2) ground transport to Hutchins, Tex.; 3) ground transport to Santa Rosa, N. Mex.; 4) ground transport to Paulden, Ariz.; 5) air transport to Sacramento, Calif.; 6) ground transport to San Francisco, Calif.; 7) ground transport to destination in San Francisco, Calif. All 7 boxes were delivered 5 days after they were shipped.

All boxes were resampled immediately upon arrival at the San Francisco destination. The entire exterior surface of each box was sampled using a dry swab (Copan Diagnostics Nylon-Flocked Dry Swabs); one swab was used for each box. All used swabs were returned to their original packaging and frozen at −20 degrees C. until processing.

For DNA extraction, samples were thawed at room temperature in a sterile laminar flow hood. Each swab was added to 200 μl of NaCl/Tween-20 solution, vortexed for 10 seconds, and centrifuged at 12,000 rpm (13.8 g) for 30 seconds. Two μl of supernatant were used for PCR amplification/amplicon sequencing to generate the OTUs to be screened and selected as features for the product profiles (in this case, packaging profiles).

The 16S rDNA V4 region was selected for use in generating the microbial profile of the boxes by PCR and amplicon sequencing to generate the OTUs from among which the features (specific OTUSs) of the microbial profile would be used for the product profile for each set of boxes. The amplicons generated by PCR were sequenced on the MiSeq platform, but a 2×250 bp paired-end protocol (250 PE) was used, yielding pair-end reads intended to overlap almost completely. The primers used for amplification contained sequences of the gene primers (515F (SEQ ID NO: 8) and 806R (SEQ ID NO: 9)), adapters for MiSeq sequencing, and 12mer molecular barcodes. The PCR mixture had the following components (20 μl total volume): 5.6 μl water; 10 μl Thermo Fisher Phire 2× buffer; 0.4 μl Phire Polymerase; 1 μl forward primer; 1 μl reverse primer; and 2 μl template. The PCR was run with the following settings: 5 minute initial step at 98 degrees C.; 35 cycles of 10 seconds denaturation at 98 degrees C., 30 seconds annealing at 50 degrees C., 30 seconds extension at 72 degrees C.; and a final 1 minute extension at 72 degrees C. The resulting 16S and ITS libraries were sequenced on the Illumina MiSeq platform (250 PE and 300 PE, respectively).

Operational Taxonomic Units (OTUs) were then clustered from quality-filtered reads using standard methods. In this example, OTUs were clustered using the open-reference OTU picking method, whereby 97% similarity OTUs are delineated (see Rideout et al. 2014, Subsampled open-reference clustering creates consistent, comprehensive OTU definitions and scales to billions of sequences. PeerJ 2:e545). The OTUs were clustered against the GreenGenes bacterial database or the UNITE fungal database (for 16S and ITS sequences, respectively), and taxonomic assignments were also assigned using these databases. The result of OTU picking is a data matrix of samples (i.e., microbial profiles) x OTUs, with sequence abundance for each OTU. A single microbial profile can contain from 1 to an infinite number of OTUs, and each OTU within a microbial profile can contain from 1 to an infinite number of occurrences (each occurrence denotes the presence of a single DNA sequence within the OTU). All subsequent analysis and visualization is conducted in R, which is an open source statistical computing environment commonly used for complex statistical analyses. OTUs that were found in laboratory reagent blank samples were removed from the all of the microbial profiles, including both counterfeit and authentic products.

### Data Analysis

As explained in Example 1, multiple steps of variance assessment and quality control visualization can be undertaken to calibrate the feature selection and comparison process. In this example, a pairwise similarity matrix was constructed and the relationships within and among replicate microbial profiles was visualized using ordination. These steps are not always necessary, and those skilled in the art, upon contemplation of this disclosure, will appreciate that these are just two of many potential variance assessment and quality control measures that can be utilized during the data analysis process to help the operator determine parameters for feature selection and comparison of microbial profiles.

Pairwise similarity: In this example, a pairwise similarity matrix was constructed from all samples being tested. This was done using the Steinhaus similarity metric, which is one of the many applicable metrics for comparing microbiome communities.

Ordination: Non-metric Multidimensional Scaling (NMDS) was used to array the 21 microbial profiles (boxes in the present example) corresponding to their microbiome similarity. NMDS plots were produced for both the origin (before shipping) and destination (after shipping) sample sets.

“Fingerprinting”—Selection of Features: A fingerprinting algorithm and computer analytics were used to determine the most statistically indicative OTUs present from each of the three shipping routes, using methodology generally as described above in Example 1. Those OTUs then served as the features of the reference signatures for the three shipping carrier routes using two predetermined cutoff thresholds: 1) OTUs in the reference profiles occurred in >70% of the representative samples; and 2) each reference OTU occurred in no more than 20% of the samples in either of the other two non-reference sets.

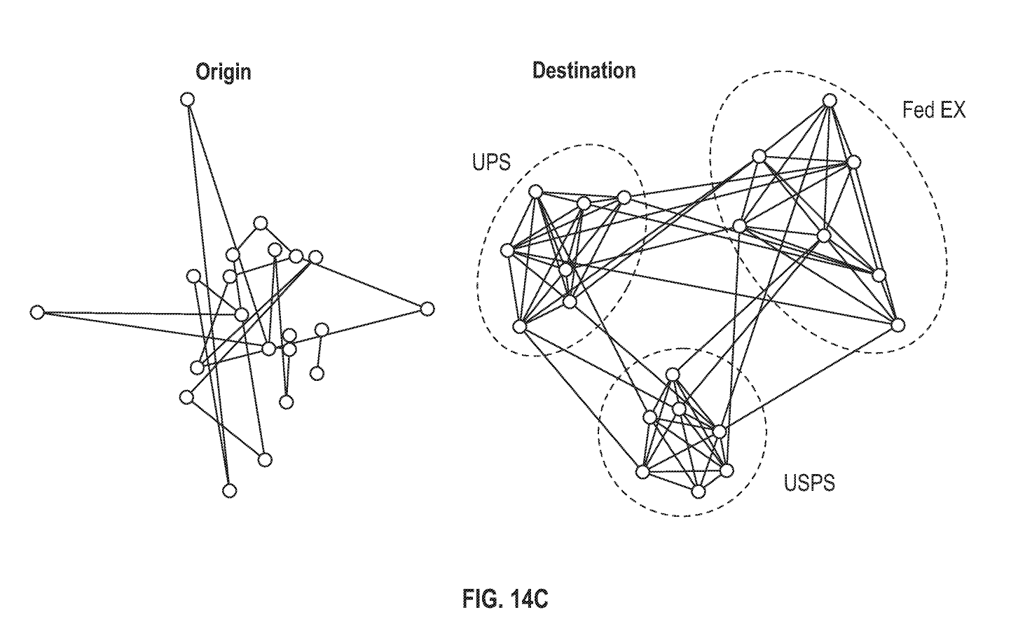

The reference profiles established, e.g., the genetic signatures derived, from pre-shipped boxes were statistically indistinguishable among the three sets (p=0.351), while the reference profiles/signatures from post-shipped boxes were statistically distinct (p=0.002) from one another in the three sets, and all 21 samples clustered into 3 groups of 7 exactly by shipping carrier. FIG. 14A shows the shipping routes used to send the 3 groups of 7 boxes through each carrier. Fifty-one signature OTUs (features) were used to distinguish among shipping routes (FIG. 14B). The same 51 OTUs are shown for both origin and destination sample sets. Origin signatures were statistically indistinguishable prior to shipping, while destination signatures are statistically distinguishable by carrier. Ordination diagrams (FIG. 14C) show that origin signatures were statistically indistinguishable prior to shipping, while samples were statistically clustered into three distinct groups, perfectly defined by carrier, after shipping. Each point in FIG. 14C is a single box's microbiome sample, and the distance between any two points represents the microbiome similarity between the two samples; similar samples are closer together, and dissimilar samples are farther apart.

### Example 3 Analysis of Shipping Networks

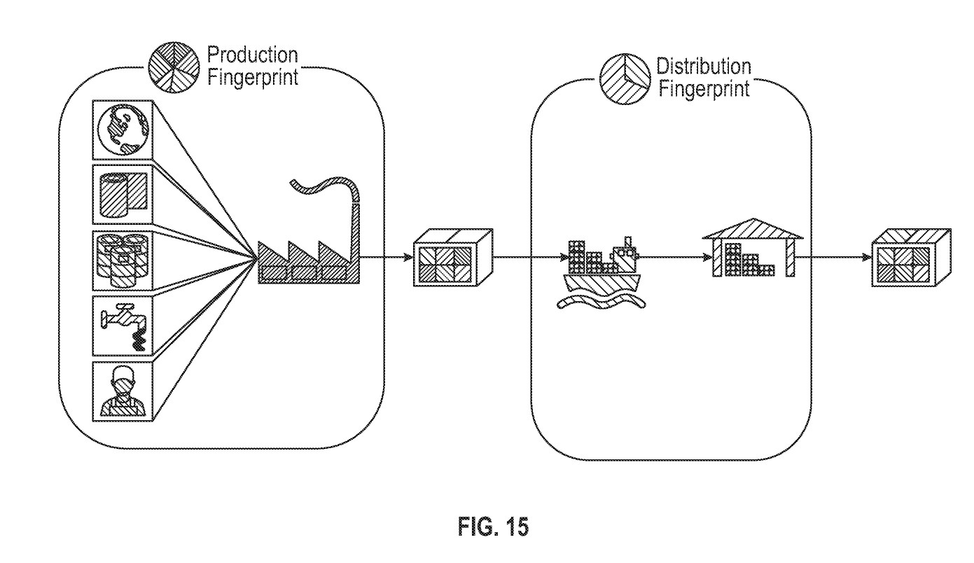

The methods of the invention enable one to infer the structure of a distribution network (e.g. for products, goods, or even humans). This is done by sampling multiple (typically but not exclusively or necessarily concentric) layers of product and/or packaging, as each of these layers can give a more complete picture of where products originated or have traveled. The data collected enables algorithms designed to implement the methods of the invention via computer assistance to infer a distribution network using layered microbiome signals (the genetic signatures—both reference and test—of the packaging and packaged goods and optionally components of each—likewise produced in accordance with the methods of the invention). FIG. 15 illustrates how a microbiome can become associated with a product and its packaging. In the figure, the packaging is simplified; were multiple layers of packaging, shipping containers, etc., available for data collection and analysis, that additional complexity simply increases the amount of information and the sophistication of the analyses that can be gleaned and performed in accordance with the methods of the invention.

The applications of this aspect of the invention are many and diverse. Illustrative applications include the following.

Counterfeit Goods: Specific Example—Shoes. To illustrate how the methods of the invention can be applied in the effort to stop counterfeiters from profiting from their illegal activity, one can pick any packaged product, such as shoes. Microbiome samples (e.g. 2 or more) from a packaged pair of counterfeit shoes confiscated from a distribution center are obtained. The microbiome on the product (shoes) itself can provide information about the manufacturing facility/factory and origin of the material used to form the product. If one has sampled other products, which ideally are the same or similar products but can be other products, from that factory, the methods of the invention enable one can to link a product to the factory (or a source of the material from which the product is made) and so to prove it was or was not made (or more likely to have been made or not been made) there, which can be dispositive in determining if the shoes are authentic or counterfeit, depending on the nature and purpose of the determination (different standards of proof may be required under different circumstances, e.g., as in determining whether goods should be held for further inspection and testing or can continue in transit to an intended final destination). In the network analysis applications of the invention, however, the packaging of the goods provides additional useful information.

In the specific example of shoes, the packaging might include a carton, and a packaging carton might contain 12 pairs of shoes and have been sealed at the factory. Such a carton might be stored in a distribution center collecting dust for a period of time. In accordance with the methods of the invention, a genetic profile of the carton can be generated and compared to the genetic profile of the shoes themselves. These profiles can be microbial profiles, and one can generate a genetic signature for the shoes versus the outside of the packaging carton. Subtracting out any factory (or other shoe-specific) microbiome-specific features (the subtraction can be done at any stage) from the carton-specific features provides features specific to the distribution center (this is not to imply that all common features between a product and packaging are excluded; in many applications, even such “overlapping” features can be informative), the collection of which (or subsets thereof) serves as a reference profile for products that have transited through that distribution center One of skill only begins to appreciate the power of this technology upon realizing that multiple shipments across many manufacturing facilities can be linked to the same distribution center or centers.

In a model system where one has a reference profile for a product and its associated packaging in transit and one desires to know if another product in commerce was shipped through that or another distribution center, there is 1 unknown node (what is the distribution center associated with the product), and the data obtained, depending on the number of samples tested and their origin, can not only answer the question but also potentially enable the practitioner to derive the number of unknown distribution centers (number of clustered unique internal nodes) associated with the set of products tested.

Gray Market Goods: Authentic printer cartridges are made in different parts of the world. They are shipped to retail destinations through legal tax/tariff channels. In an illustrative case, when a shipment bound for Germany ends up in the US, it may be because a distributor is attempting to evade taxes and/or otherwise unfairly increase profit margin, e.g., by violating a license agreement that is territorially delineated, undercutting local certified/authorized sellers. The present invention has application in identifying and so disrupting such illegal and/or illicit activity. In various embodiments, one can practice this aspect of the invention using genetic profiles that are microbial profiles used to generate product profiles of authentic products to serve as the reference profiles and then compare those reference profiles to product profiles derived from nucleic acid samples taken from confiscated goods. A discussion of this aspect of the invention with reference to particular products often subject to counterfeiting or unauthorized diversion in commerce follows.

Printer cartridge/ink. In accordance with the invention, the genetic profile of the ink, the cartridge containing the ink, and any associated packaging can be used to generate product and packaging specific reference profiles that can then be used to determine if goods seized or otherwise obtained in commerce are genuine or counterfeit. In many instances, microbial profiles will be used to generate the reference profiles, as the microbiome in the actual product (be it ink, cartridge, or packaging) certifies that it is a “genuine” (has a matching profile to the reference profile) product (be it ink, cartridge, or packaging) because it matches a fingerprint (product profile or genetic signature), which may optionally be provided in a database provided by the manufacturer. As discussed, any outer packaging, including shipping cartons and containers can be used to generate a packaging profile than can in turn be used to infer distribution network information. The packaging sample acquired for generation of the genetic profile of the packaging may comprise dust from a distribution facility, and thus can allow the practitioner to aggregate information from multiple seizures and/or assign seized goods to a known gray market distributor.

Other Counterfeiting Disruption Applications The present invention provides branded manufacturers more rapid and less expensive ways to detect and so stop illegal counterfeiting than currently available. With the instant technology, a manufacturer or seller merely has to acquire goods from suspect retailers and test them as described against authentic product/packaging reference profiles to investigate and infer whether the product is genuine and/or was shipped via a known supply chain. The present invention enables one to infer network topology/size of such distribution/supply chains. For example, with genetic profiles of goods or products seized in one area, e.g. a country or countries in Africa, the methods of the invention enable one to identify from where those goods originated, including the ports from which the entered or exited the area of interest. Moreover, the microbial or genetic profile information can be combined with other molecular and macromolecular information (including pollen—see, e.g., U.S. Pat. No. 8,852,892, incorporated herein by reference).

Law enforcement can be trained to practice the invention using handheld automated equipment provided by the invention and pre-programmed with matching profile information. In many embodiments, geolocation markers will be included in one or more of the profiles (product component or surface and packaging) to aid in network elucidation and disruption.

With the methods of the invention, one can infer not only the distribution network of a single products (e.g. shampoo) but also different products (e.g. shampoo and lotion) shipped or otherwise transported together. This enables one to expand network identification and disruption beyond a single product line.

While there are numerous applications, applications of particular interest include the illicit drug market and the gray market in integrated circuits.

Drugs: Microbiome samples are obtained from the inside and outside of seized contraband (e.g., cocaine kilo/bricks) and genetic profiles generated.

Inside: This microbiome allows one to aggregate multiple seizures to a manufacturing facility or site.

Outside: The packaging or packing material (e.g. include thin layers of coffee, grease, tape, plastic wrap, etc.) provides information that the actual drug microbiome does not. For instance, grease is commonly used to mask scent, but multiple shipments can be linked based on the grease alone. In a manner proportional to the amount of handling during transit, the external packaging can provide information linking multiple shipments that came from separate or the same manufacturing facilities.

Cars/Trucks/Compartments: Sampling the hidden smuggling compartments of seized vehicles can give information linking multiple shipments that utilized a single vehicle. This can add to our understanding of network topology and size. Thus, the methods of the invention enable one to infer one or multiple unknown internal nodes.

Integrated Circuits: All electronics, including those used in mission-critical military functions, rely on dependable electronic components such as integrated circuits (ICs). A recent US senate report detailed the extent of the counterfeit problem in the acquisition of military-grade ICs. Current technologies might be able to tests and identify counterfeit/substandard/recycled ICs, but none can link them together through a distribution network except microbiome forensics.

IC: The microbiome signal (genetic profile) on the circuit itself can link common manufacturers, infer counterfeit, and identify recycled parts.

Packaging: The genetic profile of the microbiome on the packaging can help identify distribution networks regardless of whether recycled parts, or parts made in different factories/conditions, were used.

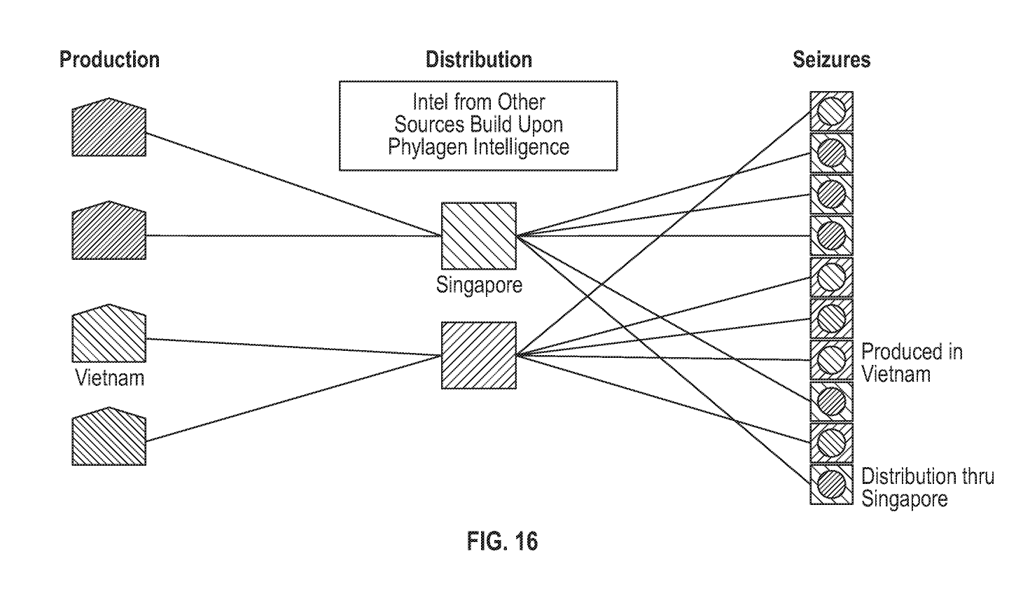

In a very general embodiment, one can envision practice of the invention would result in the outcome schematically shown in FIG. 16. In this hypothetical simplified network, there were presumed to be microbiome samples from seizures only (far right side); the seizures had a product microbiome genetic profile (circles) and a distribution microbiome genetic profile (squares). Multiple products were aggregated to a single manufacturer (red circles and inferred red manufacturer), and multiple manufacturers were aggregate into a single distribution network (gray boxes in the center) by combining the product microbiome and the distribution microbiome analyses as shown. Additional independent intelligence can be layered upon the inferences drawn as schematically shown to assign actual locations and actors to the inferred network.

DNA from microorganisms within microbiome sample is isolated and sequences to construct a molecular fingerprint for the microbiome of the surface, surfaces, substances, or materials tested. In one instance, the bacteria and archaea microorganisms in the microbiome sample are grouped into OTUs that may represent individual species or groups of species that share common evolutionary variations in the 16S ribosomal RNA (rRNA) common to all species in these two groups. Current amplifying and sequencing technologies permit these OTUs to be readily delineated.

For fungi, internal transcribed spacers (ITS) sequences may also be used. While the phylogenetics of ITS variations are not as well cataloged as the 16S data, genetic variability in eukaryotes, such as fungi and algae, may disperse less quickly than in bacteria, and in this case variable features are likely to remain more localized. Some embodiments of the present invention provide a suitable fingerprinting methodology relying solely on 16S and ITS data.

In some embodiments, a suitable fingerprinting methodology is provided based on whole metagenome shotgun (WMS) or metatranscriptomic data, which includes a cross-section of all DNA and RNA in a microbiome sample. Metagenomics captures a tremendous amount of information that 16S data misses, including: species specific marker genes, strain level variations in protein coding and non-coding regions, sequence data that cannot be readily amplified by PCR, and information about microbial eukaryotes that may exhibit greater localization of variations.

In some instances, taxonomic variations based on 16S/ITS data may not be sufficient. For these instances, further differentiation may be achieved through population genetics metrics, which may identify sequences that could be targeted for deeper sampling via PCR. Examples of such approaches include a phylogenetic approach to metagenome analysis (e.g. PhyloSift). In some instances, these additional approaches exploit rich patterns embedded in evolutionary history that conventional taxonomic metrics may be incapable of detecting. However, for some instances these additional approaches must be applied carefully to avoid masking subtle differences among rare species.

Some embodiments of the invention further incorporate functional difference into the analysis. For example, well-known variations in phosphorus scavenging genes and arsenic resistance genes (such as in the Prochlorococcus and Synechococcus organisms) may be differentiated based upon phosphorus content in a given body of water.

Some embodiments further include searches for suitable markers based on “kilobase windows”—a large set of kilobase-long sequence reads that are generally extracted from genome reference databases. While not typically considered as markers, these kilobase windows are known to effectively capture considerable further strain-level variations of unknown significance.

The molecular fingerprint is subsequently compared to one or more microbiome databases to determine the geographic source and/or transit history of the item or surface from which the microbiome sample is collected. In one embodiment, the microbiome database is derived from a microbiome sample collected from a controlled surface, such as a consumer item from a known source or origin. In one embodiment, the microbiome database is derived from one or more microbiome samples collected from authentic products to generate an authentic consensus fingerprint, while the molecular fingerprint is derived from a microbiome sample collected from an unauthenticated product. A comparison between the molecular fingerprint and the authentic consensus fingerprint may then be used to determine the authenticity of the unauthenticated product, as well as brand or quality differences, as shown in FIG. 7(b).

In one instance, a protocol for determining the origin or source of a transportation vessel or cargo includes a systematic pipeline for drilling down through variations and indicators to identify the best taxa, populations, and genes for forensic use, and further includes geographic data that may be used to further differentiate, or correlate the source of the microbiome sample.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1.-12. (canceled)

13. A method for determining whether a shipped product of interest, composed of an item or material and transit packaging, originated from a particular location or environment and passed through a different location or environment in a known or unknown distribution network, said method comprising the steps of:
(i) preparing two or more molecular profiles, at least one consisting of one or more identified features and/or feature values derived from samples taken from one or more locations, environments, materials, items, and/or persons indicative of locations or environments of origin of said product, and at least one consisting of one or more identified features and/or feature values derived from samples taken from one or more locations, environments, materials, items, and/or persons indicative of distribution location or environment and/or transit packaging associated with a product of similar type to said shipped product or to a known location or environment in a distribution network;
(ii) selecting one or more of said features and/or feature values to form the reference profiles for each such location and/or environment and/or transit packaging;
(iii) screening a sample taken from a part of said product or consumer packaging expected to have had little or no exposure to microbiomes during shipping to determine which, if any, of the features and/or feature values of said one or more reference profiles are present;
(iv) screening a sample taken from transit packaging of said shipped item or material to determine which, if any, features and/or feature values of said one or more reference profiles are present; and
(iv) determining that said shipped item of interest:
originated from a location only if one or more features and/or feature values of said one or more reference profiles of locations or environments of origin are detected in sample(s) taken from said product or consumer packaging not expected to have exposure to microbiomes during shipping; and
transited a location or environment during distribution only one or more features and/or feature values of said one or more reference profiles of locations or environments of distribution are detected from sample(s) taken from said transit packaging of said item or material.

14. The method of claim 13, wherein the shipped product is obtained as a result of an investigation of counterfeit, grey market, recycled, illicit, illegal, or otherwise mislabeled or misbranded goods.

15. The method of claim 13, wherein the one or more locations, environments, materials, items, or persons used to generate at least one of the reference profiles was a component of or associated with:
a known branded and/or properly labeled product identical or similar to the product of interest;
a known mislabeled or misbranded product;
illicit or illegal goods of known source; and/or
packaging or a component thereof used in transporting any of the foregoing; and/or
a contaminant or other material associated with any of the foregoing as a result of its manufacture, or location of origin, and/or shipment.

16.-17. (canceled)

18. The method of claim 13, wherein a reference profile is obtained from samples taken from either:
locations or environments of; or
materials, equipment, or people engaged in manufacturing a product of known origin and composition.

19. (canceled)

20. The method of claim 13, wherein one or more of the reference profiles is from a branded item or material or consumer packaging used in association therewith.

21. The method of claim 13, wherein the item or material of interest is suspected to be counterfeit, recycled or grey market product, or was manufactured or assembled by an unauthorized subcontractor.

22.-23. (canceled)

24. The method of claim 13, wherein the features include one or more of features selected from the list consisting of one or more OTUs, SNPs, CNVs, protein families, genome windows, genes, proteins, taxa, families, genera, species, strains and metabolic pathways.

25.-42. (canceled)

43. A method for determining if a material, item or person of interest originated from a particular location or environment or, for a material or item, was made from materials or components originating from a particular location or environment, said method comprising the steps of:
generating a genetic profile of a sample taken from said item, material or person;
identifying features to form the test profile;
comparing the test profile to a database of known reference profiles or other information that includes one or more profiles and/or features and/or feature values from known locations or environments or people; and
determining that said item, material, or person of interest originated from such location or environment or said item or material was made from materials or components originating from a particular location or environment only if one or more features and/or feature values of one or more reference profiles match the test profile.

44. The method of claim 43, wherein the shipped product is obtained as a result of an investigation of counterfeit, grey market, recycled, illicit, illegal, or otherwise mislabeled or misbranded goods.

45. The method of claim 43, wherein the one or more locations, environments, materials, items, or persons used to generate at least one of the reference profiles was a component of or associated with:
a known branded and/or properly labeled product identical or similar to the product of interest;
a known mislabeled or misbranded product;
illicit or illegal goods of known source; and/or
packaging or a component thereof used in transporting any of the foregoing; and/or
a contaminant or other material associated with any of the foregoing as a result of its manufacture, or location of origin, and/or shipment.

46.-47. (canceled)

48. The method of claim 43, wherein a reference profile is obtained from samples taken from either:
locations or environments of; or
materials, equipment, or people engaged in manufacturing a product of known origin and composition.

49. (canceled)

50. The method of claim 43, wherein one or more of the reference profiles is from a branded item or material or packaging used in association therewith.

51. The method of claim 50, wherein the item or material of interest is suspected to be counterfeit, recycled or grey market product, or was manufactured or assembled by an unauthorized subcontractor.

52.-53. (canceled)

54. The method of claim 43, wherein the features include one or more of features selected from the list consisting of one or more OTUs, SNPs, CNVs, protein families, genome windows, genes, proteins, taxa, families, genera, species, strains and metabolic pathways.

55. The method of claim 43, wherein one or more reference profiles comprise features generated from sequencing at least two of bacterial, fungal, cyanobacterial, algal, archaebacterial, viral, multicellular higher plant, pollen, animal and humanmarkers or genes.

56.-87. (canceled)

88. A method for determining if a set of at least two or more products of interest share a common location or environment of origin, said method comprising the steps of:
preparing a first genetic profile consisting of one or more identified features and/or feature values from a first material or item;
preparing a second genetic profile consisting of one or more identified features and/or feature values from a second material or item; and
determining that said materials or items of interest share a common location or environment of origin if the first and second profiles share one or more features and/or feature values.

89. The method of claim 88, wherein the products of interest are obtained as a result of an investigation of counterfeit, grey market, recycled, illicit, illegal, or otherwise mislabeled or misbranded goods.

90. The method of claim 88, wherein the products of interest used to generate at the genetic profiles were:
known mislabeled or misbranded products;
illicit or illegal goods; or
known or suspected counterfeit products.

91. The method of claim 90, wherein the products of interest are suspected to be counterfeit, recycled, grey market, or manufactured or assembled by an unauthorized subcontractor.

92. (canceled)

93. The method of claim 88, wherein the features include one or more of features selected from the list consisting of one or more OTUs, SNPs, CNVs, protein families, genome windows, genes, proteins, taxa, families, genera, species, strains and metabolic pathways.

94. The method of claim 88, wherein one or more reference profiles comprise features generated from sequencing at least two of bacterial, fungal, cyanobacterial, algal, archaebacterial, viral, multicellular higher plant, pollen, animal and human markers or genes.

95. The method of claim 94, wherein one or more reference profiles comprise features generated from sequencing bacterial, fungal and pollen markers or genes.

96. The method of claim 94, wherein the marker or gene is a 16S or ITS marker or gene

97.-140. (canceled)


SEQUENCE LISTING (39 sequences)

SEQ ID NO: 1 - DNA, 209 bp, Lactobacillus johnsonii
ggggcgtgtctcagtcccaatgtggccgatcagtctcttaactcggctatgcatcattgccttggtaagccgttaccttaccaactagctaatgcaccgcaggtccatccaagagtgatagcagaaccatctttcaaactctagacatgcgtctagtgttgttatccggtattagcatctgtttccaggtgttatcccagtctcttggg

SEQ ID NO: 2 - DNA, 209 bp, Artificial Sequence
  Description of Artificial Sequence Synthetic polynucleotide
  Synthetically modified Lactobacillus johnsonii sequence
cccccgtgtctcagtcccaatgtggccgatcagtctcttaactcggctatgcatcattgccttggtaagccgttaccttaccaactagctaatgcaccgcaggtccatccaagagtgatagcagaaccatctttcaaactctagacatgcgtctagtgttgttatccggtattagcatctgtttccaggtgttatcccagtctcttggg

SEQ ID NO: 3 - DNA, 209 bp, Artificial Sequence
  Description of Artificial Sequence Synthetic polynucleotide
  Synthetically modified Lactobacillus johnsonii sequence
aaaacgtgtctcagtcccaatgtggccgatcagtctcttaactcggctatgcatcattgccttggtaagccgttaccttaccaactagctaatgcaccgcaggtccatccaagagtgatagcagaaccatctttcaaactctagacatgcgtctagtgttgttatccggtattagcatctgtttccaggtgttatcccagtctcttggg

SEQ ID NO: 4 - DNA, 209 bp, Artificial Sequence
  Description of Artificial Sequence Synthetic polynucleotide
  Synthetically modified Lactobacillus johnsonii sequence
ttttcgtgtctcagtcccaatgtggccgatcagtctcttaactcggctatgcatcattgccttggtaagccgttaccttaccaactagctaatgcaccgcaggtccatccaagagtgatagcagaaccatctttcaaactctagacatgcgtctagtgttgttatccggtattagcatctgtttccaggtgttatcccagtctcttggg

SEQ ID NO: 5 - DNA, 20 bp, Artificial Sequence
  Description of Artificial Sequence Synthetic primer
  DNA 5′-3′ Primer
gcatcgatgaagaacgcagc

SEQ ID NO: 6 - DNA, 20 bp, Artificial Sequence
  Description of Artificial Sequence Synthetic primer
  DNA 5′-3′ Primer
tcctccgcttattgatatgc

SEQ ID NO: 7 - DNA, 20 bp, Artificial Sequence
  Description of Artificial Sequence Synthetic primer
  DNA 5′-3′ Primer
atgcgatacttggtgtgaat

SEQ ID NO: 8 - DNA, 19 bp, Artificial Sequence
  Description of Artificial Sequence Synthetic primer
  DNA 5′-3′ Primer
gtgccagcmgccgcggtaa

SEQ ID NO: 9 - DNA, 20 bp, Artificial Sequence
  Description of Artificial Sequence Synthetic primer
  DNA 5′-3′ Primer
ggactachvgggtwtctaat

SEQ ID NO: 10 - DNA, 253 bp, Oceanobacillus profundus
tacgtaggtggcaagcgttgtccggaattattgggcgtaaagcgctcgcaggcggtcttttaagtctgatgtgaaagcccacggcttaaccgtggagggtcattggaaactggaggacttgagtacagaagaggagagtggaattccacgtgtagcggtgaaatgcgtagagatgtggaggaacaccagtggcgtaggcgactctctggtctgtaactgacgctgaggagcgaaagcgtgggtagcgaacagt

SEQ ID NO: 11 - DNA, 253 bp, Staphylococcus equorum
tgcgtaggtggcaagcgttatccggaattattgggcgtaaagcgcgcgtaggcggtttcttaagtctgatgtgaaagcccacggctcaaccgtggagggtcattggaaactgggaaacttgagtacagaagaggaaagtggaattccatgtgtagcggtgaaatgcgcagagatatggaggaacaccagtggcgaaggcgactttctggtctgtaactgacgctgatgtgcgaaagcgtggggatcaaacagg

SEQ ID NO: 12 - DNA, 253 bp, Paenochrobactrum glaciei
tacgaagggggctagcgttgttcggatttactgggcgtaaagcgcacgtaggcggattggtcagttaggggtgaaatcccagggcttaaccctggaactgcctttaatactgccagtcttgagtatggaagaggtgagtggaattgcgagtgtagaggtgaaattcgtagatattcgcaggaacaccagtggcgaaggcggctcactggtccattactgacgctgaggtgcgaaagcgtggggagcaaacagg

SEQ ID NO: 13 - DNA, 253 bp, Pseudomonas fragi
tacagagggtgcaagcgttaatcggaattactgggcgtaaagcgcgcgtaggtggtttgttaagttgaatgtgaaatccccgggctcaacctgggaactgcacccaaaactggcaagctagagtatggtagagggtagtggaatttcctgtgtagcggtgaaatgcgtagatataggaaggaacaccagtggcgaaggcgactacctggactgatactgacactgaggtgcgaaagcgtggggagcgaacagg

SEQ ID NO: 14 - DNA, 253 bp, Lactobacillus acidipiscis
tacgtaggtggcaagcgttgtccggatttattgggcgtaaagggaacgcaggcggtcttttaagtctgatgtgaaagccttcggcttaaccggagaagtgcattggaaactgggagacttgagtgcagaagaggagagtggaactccatgtgtagcggtgaaatgcttagatatatggaagaacaccagtggcgaaagcggctctctggtctgtaactgacgctgaggttcgaaagcgtggggagcgaacagg

SEQ ID NO: 15 - DNA, 253 bp, Acinetobacter guillouiae
tacggagggggctagcgttgttcggaattactgggcgtaaagcgtgcgtaggcggcttattaagtcggatgtgaaatccccgagcttaacttgggaattgcattcgatactggtgagctagagtatgggagaggatggtagaattccaggtgtagcggtgaaatgcgtagagatctggaggaataccgatggcgaaggcagccatctggcctaatactgacgctgaggtacgaaagcatggggagcaaacagg

SEQ ID NO: 16 - DNA, 253 bp, Caulobacter crescentus
tacgaagggggctagcgttgctcggaattactgggcgtaaagggcgcgtaggcggactgtttagtcagaggtgaaagcccagggctcaaccttggaattgcctttgatactggcagtcttgagtacggaagaggtatgtggaactccgagtgtagaggtgaaattcgtagatattcggaagaacaccagtggcgaaggcgacatactggtccgttactgacgctgaggctcgaaagcgtggggagcaaacagg

SEQ ID NO: 17 - DNA, 253 bp, Sphingomonas taxi
tacggagggcgctagcgttgttcggaattactgggcgtaaagcgcacgtaggcggctttgtaagttagaggtgaaagcctggagctcaactccagaattgcctttaagactgcatcgctcgaatccgggagaggtgagtggaattccgagtgtagaggtgaaattcgtagatattcggaagaacaccagtggcgaaggcggctcactggaccggtattgacgctgaggtgcgaaagcgtggggagcaaacagg

SEQ ID NO: 18 - DNA, 253 bp, Achromobacter xylosoxidans
tacgtagggtgcaagcgttaatcggaattactgggcgtaaagcgtgcgcaggcggttcggaaagaaagatgtgaaatcccagagcttaactttggaactgcatttttaactaccgggctagagtgtgtcagagggaggtggaattccgcgtgtagcagtgaaatgcgtagagatgcggaggaacaccgatggcgaaggcagcctcctgggataacactgacgctcatgcacgaaagcgtggggagcaaacagg

SEQ ID NO: 19 - DNA, 253 bp, Methylobacterium radiotolerans
tacgaagggggctagcgttgctcagaatcactgggcgtaaagggcgcgtaggcggcgttttaagtcgggggtgaaagcctgtggctcaaccacagaatggccttcgatactgggacgcttgagtctggtagaggttggtggaactgcgagtgtagaggtgaaattcgtagatattcggaagaacaccagtggcgaaggcggctcactggaccggtattgacgctgaggtgcgaaagcgtggggagcaaacagg

SEQ ID NO: 20 - DNA, 253 bp, Luteimonas huabeiensis
tacgaagggtgcaagcgttactcggaattactgggcgtaaagcgtgcgtaggtggttcgttaagtctgatgtgaaagccctgggctcaacctgggaattgcattggatactggcgggctagagtgcggtagaggatggcggaattcccggtgtagcagtgaaatgcgtagagatcgggaggaacatccgtggcgaaggcggccatctggaccagcactgacactgaggcacgaaagcgtggggagcaaacagg

SEQ ID NO: 21 - DNA, 253 bp, Lactobacillus animalis
tacgtaggtggcaagcgttatccggatttattgggcgtaaagggaacgcaggcggtcttttaagtctgatgtgaaagccttcggcttaaccggagtagtgcattggaaactgggagacttgagtgcagaagaggagagtggaactccatgtgtagcggtgaaatgcgtagatatatggaagaacaccagtggcgaaagcggctctctggtctgtaactgacgctgaggttcgaaagcgtgggtagcaaacagg

SEQ ID NO: 22 - DNA, 253 bp, Sphingomonas echinoides
tacggagggagctagcgttgttcggaattactgggcgtaaagcgcacgtaggcggctttgtaagttagaggtgaaagcctggagctcaactccagaattgcctttaagactgcatcgctcgaatccgggagaggtgagtggaattccgagtgtagaggtgaaattcgtagatattcggaagaacaccagtggcgaaggcggctcactggaccggtattgacgctgaggtgcgaaagcgtggggagcaaacagg

SEQ ID NO: 23 - DNA, 252 bp, Streptococcus mitis
tacgtaggtcccgagcgttgtccggatttattgggcgtaaagcgagcgcaggcggttagataagtctgaagttaaaggctgtggcttaaccatagtacgctttggaaactgtttaacttgagtgcaagaggggagagtggaatttcatgtgtagcggtgaaatgcgtagatatatggaggaacaccggtggcgaaagcggctctctggcttgtaactgacgctgaggctcgaaagcgtggggagcaaacagg

SEQ ID NO: 24 - DNA, 253 bp, Paracoccus denitrificans
tacggagggggctagcgttgttcggaattactgggcgtaaagcgcacgtaggcggaccggaaagttgggggtgaaatcccggggctcaacctcggaactgccttcaaaactatcggtctggagttcgagagaggtgagtggaattccgagtgtagaggtgaaattcgtagatattcggaggaacaccagtggcgaaggcggctcactggctcgatactgacgctgaggtgcgaaagcgtggggagcaaacagg

SEQ ID NO: 25 - DNA, 253 bp, Enterococcus cecorum
tacgtaggtggcaagcgttgtccggatttattaggcgtaaagcgagcgcaggcggtcttttaagtctgatgtgaaagccctcggcttaaccggggagggtcattggaaactgggagacttgagtgcagaagaggaaagcggaattccatgtgtagcggtgaaatgcgtagatatatggaggaacaccagtggcgaaggcggctttctggtctgtaactgacactgaggctcgaaagcgtggggagcaaacagg

SEQ ID NO: 26 - DNA, 253 bp, Meiothermus silvanus
tacggagggtgcgagcgttacccggatttactgggcgtaaagggcgtgtaggcggttttctaagtccggggctaaagaccagggctcaaccctgggtttgccttggatactggaaagctcgacggctggagggggcagcggaatttccggagtagcggtgaaatgcgcagataccggaaggaacgccaatagcgaaggcagctgcctggacagtacgtgacgctgaggcgcgaaagcgtggggagcaaacagg

SEQ ID NO: 27 - DNA, 253 bp, Anoxybacillus tepidamans
tacgtaggtggcaagcgttgtccggaattattgggcgtaaagcgcgcgcaggcggtcctttaagtctgatgtgaaagcccacggctcaaccgtggagggtcattggaaactgggggacttgagtgcagaagaggggagcggaattccacgtgtagcggtgaaatgcgtagagatgtggaggaacaccagtggcgaaggcggctctctggtctgtaactgacgctgaggcgcgaaagcgtggggagcaaacagg

SEQ ID NO: 28 - DNA, 253 bp, Bacillus pumilus
tacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacagg

SEQ ID NO: 29 - DNA, 253 bp, Klebsiella quasipneumoniae
tacggagggtgcaagcgttaatcggaattactgggcgtaaagcgcacgcaggcggtctgtcaagtcggatgtgaaatccccgggctcaacctgggaactgcattcgaaactggcaggctagagtcttgtagaggggggtagaattccaggtgtagcggtgaaatgcgtagagatctggaggaataccggtggcggaggcggccccctggacaaagactgacgctcaggtgcgaaagcgtggggagcaaacagg

SEQ ID NO: 30 - DNA, 254 bp, Corynebacterium halotolerans
tacgtagggtgcgagcgttgtccggaattactgggcgtaaagagctcgtaggtggtttgtcgcgtcgtctgtgaaattccggggctcaactccgggcgtgcaggcgatacgggcataacttgagtgctgtaggggagactggaattcctggtgtagcggtgaaatgcgcagatatcaggaggaacaccgatggcgaaggcaggtctctgggcagtaactgacgctgaggagcgaaagcatgggtagcgaacagg

SEQ ID NO: 31 - DNA, 253 bp, Lactobacillus hominis
tacgtaggtggcaagcgttgtccggatttattgggcgtaaagcgagtgcaggcggttcaataagtctgatgtgaaagccttcggctcaaccggagaattgcatcagaaactgttgaacttgagcgcagaagaggagagtggaactccatgtgtagcggtggaatgcgtagatatatggaagaacaccagtggcgaaggcggctctctggtctgcaactgacgctgaggctcgaaagcatgggtagcgaacagg

SEQ ID NO: 32 - DNA, 253 bp, Comamonas testosteroni
tacgtagggtgcaagcgttaatcggaattactgggcgtaaagcgtgcgcaggcggttttgtaagacagtggtgaaatccccgggctcaacctgggaactgccattgtgactgcaaggctagagtgcggcagagggggatggaattccgcgtgtagcagtgaaatgcgtagatatgcggaggaacaccgatggcgaaggcaatcccctgggcctgcactgacgctcatgcacgaaagcgtggggagcaaacagg

SEQ ID NO: 33 - DNA, 253 bp, Lactobacillus rogosae
tacgtatggagcaagcgttatccggatttactgggtgtaaagggagtgtaggtggccaggcaagtcagaagtgaaagcccggggctcaaccccgggactgcttttgaaactgcagggctagagtgcaggaggggcaagtggaattcctagtgtagcggtgaaatgcgtagatattaggaggaacaccagtggcgaaggcggcttgctggactgtaactgacactgaggctcgaaagcgtggggagcaaacagg

SEQ ID NO: 34 - DNA, 254 bp, Corynebacterium tuberculostearicum
tacgtagggtgcgagcgttgtccggaattactgggcgtaaagggctcgtaggcggtttgtcgcgtcgtctgtgaaattccggggcttaactccgggcgtgcaggcgatacgggcataacttgagtactgtaggggtaactggaattcctggtgtagcggtgaaatgcgcagatatcaggaggaacaccgatggcgaaggcaggttactgggcagttactgacgctgaggagcgaaagcatgggtagcgaacagg

SEQ ID NO: 35 - DNA, 252 bp, Barnesiella intestinihominis
tacggaggatgcgagcgttatccggatttattgggtttaaagggtgcgtaggcggtccgttaagtcagcggtaaaattgcggggctcaaccccgtcgagccgttgaaactggcagacttgagttggcgagaagtacgcggaatgcgcggtgtagcggtgaaatgcatagatatcgcgcagaactccgattgcgaaggcagcgtaccggcgccagactgacgctgaggcacgaaagcgtggggatcgaacagg

SEQ ID NO: 36 - DNA, 253 bp, Robinsoniella peoriensis
tacgtagggggcaagcgttatccggatttactgggtgtaaagggagcgtagacggcagggcaagtctgatgtgaaaggtcggggcccaaccccgggactgcattggaaactgtccggctggagtacaggagaggtaagtggaattcctagtgtagcggtgaaatgcgtagatattaggaggaacaccagtggcgaaggcggcttactggactgtaactgacgttgaggctcgaaagcgtggggagcaaacagg

SEQ ID NO: 37 - DNA, 253 bp, Parasporobacterium paucivorans
tacgtagggggcgagcgttatccggatttactgggtgtaaagggagcgcaggcggcgtggcaagtcagatgtgaaaacccggggcccaaccccgggactgcatttgaaactgccatgctggagtgccggagaggtaagtggaattcctagtgtagcggtgaaatgcgtagatattaggaggaacaccagtggcgaaggcggcttactggacggtaactgacgctgaggctcgaaagcgtggggagcaaacagg

SEQ ID NO: 38 - DNA, 253 bp, Oscillibacter ruminantium
tacgtaggtggcaagcgttgtccggatttactgggtgtaaagggcgtgcagccggagagacaagtcagatgtgaaatccacgggctcaacccgtgaactgcatttgaaactgtttcccttgagtgtcggagaggtaatcggaattccttgtgtagcggtgaaatgcgtagatataaggaagaacaccagtggcgaaggcggattactggacgataactgacggtgaggcgcgaaagcgtggggagcaaacagg

SEQ ID NO: 39 - DNA, 253 bp, Clostridium oroticum
tacgtagggggcaagcgttatccggatttactgggtgtaaagggagcgtagacggacttgcaagtctgatgtgaaaatccggggcccaaccccggaactgcattggaaactgtatatctagagtgtcggagaggcaagtggaattcctggtgtagcggtgaaatgcgtagatatcaggaggaacaccagtggcgaaggcggcttgctggacgatgactgacgttgaggctcgaaagcgtggggagcaaacagg